(19) United States
(12) Patent Application Publication
(10) Pub. No.: US 2017/0066967 A1
(43) Pub. Date: Mar. 9, 2017

(54) POLYMERIZABLE COMPOSITION COMPRISING COMPOUND HAVING MESOGENIC GROUP, AND POLYMER THEREOF

(71) Applicant: DIC Corporation, Tokyo (JP)

(72) Inventors: Mika Yamamoto, Kita-adachi-gun (JP); Masahiro Horiguchi, Kita-adachi-gun (JP); Yasuhiro Kuwana, Kita-adachi-gun (JP)

(73) Assignee: DIC Corporation, Tokyo (JP)

(21) Appl. No.: 15/123,384

(22) PCT Filed: Feb. 24, 2015
(86) PCT No.: PCT/JP2015/055182

§ 371 Date: Sep. 2, 2016

(30) Foreign Application Priority Data
Mar. 4, 2014 (JP) 2014-041836

(51) Int. Cl. C09K 19/20; C09K 19/38

(52) U.S. Cl. CPC C09K 19/2014; C09K 19/3804; C09K 2019/0448

(57) ABSTRACT

The invention provides a polymerizable composition including a compound that has a mesogenic group and satisfying an expression represented by Expression (1): 1.0≦YI/Δn≦50.0, wherein YI represents a yellowness index of a material including only a compound having a mesogenic group in the polymerizable composition, and Δn represents a refractive index anisotropy of a material including only a compound having a mesogenic group in the polymerizable composition, with the proviso that a chiral compound having a mesogenic group is excluded in the material including only the compound having the mesogenic group. The polymerizable composition has high storage stability and is unlikely to cause an increase of the content of a polymer component when being added to a polymerizable liquid crystal composition, and is excellent in adhesiveness, is not unlikely to cause discoloration, and exhibits good coating properties and good alignment properties in preparing an optical anisotropic body.

### TECHNICAL FIELD

The present invention relates to a polymerizable composition which exhibits a value of YI/Δn falling within a specific range, a polymer, an optical anisotropic body, and a retardation film obtained by polymerizing the polymerizable composition. Further, the present invention relates to a film, a display device, optical elements, light-emitting devices, printed material, an optical information recording apparatus, and the like, which have a polymer, an optical anisotropic body, and a retardation film.

### BACKGROUND ART

A polymerizable liquid crystal composition is useful as a constituent member of the optical anisotropic body, and the optical anisotropic body has been, for example, applied to a variety of display devices and optical elements, and the like as a polarizing film and a retardation film. A polarizing film and a retardation film can be obtained by applying a polymerizable liquid crystal composition on the substrate and heating the polymerizable liquid crystal composition or irradiating the polymerizable liquid crystal composition with an active energy beam in a state where the polymerizable liquid crystal composition is aligned with an alignment film or the like to thereby cure the polymerizable liquid crystal composition. It has been reported that the obtained optical anisotropic body has adhesiveness as one of the important characteristics in using the display device and the optical element, for example, when using the polymerizable liquid crystal composition to which the lower alkyl acrylate (HEA) is added as adhesiveness promoters, the optical anisotropic body having excellent adhesiveness to the substrate is obtained. However, alignment properties are insufficient depending on the types of the polymerizable compound used (PTL 1).

Further, in a case where an optical anisotropic body which is used in the display device and the optical element, or the like is used for a long period of time, it is preferable that the discoloration of the optical anisotropic body (film) hardly occurs from the viewpoint of reliability. The optical anisotropic body is deteriorated by exposure to the ultraviolet-visible light from various light sources such as backlight, indoor light, or sunlight, and various heat sources as the cause of discoloration. Further, discoloration may occur by the heating or ultraviolet irradiation or the like which is performed to complete the polymerization in a case where the polymer is insufficient (PTL 2 and PTL 3). In a case where the optical anisotropic body in which discoloration occurs or the optical anisotropic body in which discoloration easily occurs is used, for example, in the viewing angle enlargement and the polarization conversion applications such as a liquid crystal display, there are problems that the brightness and/or contrast of the display is lowered, the color of an image will change in accordance with the time of the display used, and the quality of display products is significantly reduced.

Furthermore, various polymerizable compounds have been reported in the related field, and the optical anisotropic body is prepared using the composition containing the polymerizable compound, but there are problems that in the composition containing the polymerizable compound, the high molecular (polymer) component is easily generated during storage, and storage stability is insufficient. In a case where the composition in which the high molecular (polymer) component is easily formed is used, there is a high possibility that the content of the high molecular (polymer) component increases during storage or transportation up to the step of producing the polymer after the composition is prepared. In this case, there are problems that the viscosity and the like of the composition will change, and that affects optical properties such as transmittance and discoloration of the polymer obtained by using the composition.

Accordingly, there has been a demand for a liquid crystal composition which hardly causes a high molecular (polymer) component to be generated when the liquid crystal composition is added to a polymerizable liquid crystal composition, which has high storage stability, and exhibits excellent adhesiveness to the substrate, is unlikely to cause discoloration, and exhibits good alignment properties in a case of preparing an optical anisotropic body.

### CITATION LIST

### Patent Literature

[PTL 1] WO2005/005573

[PTL 2] JP-A-2003-313252

[PTL 3] U.S. Pat. No. 6,514,578B1

### SUMMARY OF INVENTION

### Technical Problem

An object of the present invention is to provide a polymerizable composition which has high storage stability, and which exhibits excellent adhesiveness to the substrate, is unlikely to cause discoloration, and exhibits good coating properties and good alignment properties, in a case of preparing an optical anisotropic body, and also to provide an optical anisotropic body using the polymerizable composition.

### Solution to Problem

The present invention provides a polymerizable composition including: a compound that has a mesogenic group and satisfying the expression represented by the following Expression (1):

1.0≦YI/Δn≦50.0 Expression (1)

wherein YI represents a yellowness index of a material including only a compound having a mesogenic group in the polymerizable composition, and Δn represents a refractive index anisotropy of a material including only a compound having a mesogenic group in the polymerizable composition, and

provides also a polymer, an optical anisotropic body, and a retardation film, which are obtained by polymerizing the polymerizable composition.

### Advantageous Effects of Invention

The polymerizable composition of the present invention has high storage stability, and thus an increase of the content of a polymer component hardly occurs. Further, an optical anisotropic body using the polymerizable liquid crystal composition of the present invention has excellent adhesiveness, coating properties, and alignment properties, and the discoloration hardly occurs, and thus the composition is useful in applications of an optical material such as a retardation film.

Hereinafter, a preferred embodiment of the present invention will be described. In addition, a polymerizable composition may be referred to as the polymerizable liquid crystal composition in the following, but the “liquid crystal” is intended to exhibit liquid crystal properties when applying, printing, or dropping the polymerizable composition onto a substrate, or injecting the polymerizable composition into the cell. The liquid crystal does not necessarily show liquid crystal properties as a composition.

The polymerizable composition of the present invention may include one or more compounds containing a mesogenic group, and further, if necessary, may include compounds which do not contain a mesogenic group, stabilizers, organic solvents, polymerization inhibitors, antioxidants, photopolymerization initiators, thermal polymerization initiators, surfactants, an alignment control agent, chain transfer agents, infrared ray absorbers, thixotropic agents, antistatic agents, dyes, fillers, and ultraviolet ray absorbers, and the like.

In the polymerizable composition, it is important for the selection of compounds containing a mesogenic group as a constituent material, a combination thereof, setting the mixing ratio or the like to satisfy the various properties such as optical characteristics, polymerization rate, solubility, melting point, glass transition temperature, transparency of the polymer, mechanical strength, surface hardness, heat resistance and light resistance required in a case of using the optical anisotropic body. In order to meet the optical properties required in a case of using the optical anisotropic body, for example, the magnitude of the refractive index anisotropy of the composition is adjusted.

Meanwhile, a polymerizable composition used as a material of the optical anisotropic body is generally purified and used as compounds having all of the mesogenic groups. The compounds having the mesogenic groups are purified in the manufacturing step and have less than the impurity content, but since it is difficult to completely reduce the impurities to zero even after the purification step, in fact, the compounds contains a lot of impurities due to the degree or purification. If the yellowness index of the compounds having one or more mesogenic groups is measured, there is a tendency that the more purified the compound is, the smaller the yellowness index value is.

The present inventors have conducted intensive studies on the constituent of the polymerizable composition satisfying various characteristics required in a case of using the optical anisotropic body, and have found that the value of yellowness index (YI) and the refractive index anisotropy (Δn) of all the compounds having mesogenic groups in the polymerizable composition affect the properties of the polymerizable composition. That is, was found that it is possible to prepare a liquid crystal composition satisfying various characteristics required as the material of the optical anisotropic body by adjusting the value of yellowness index (YI) and the refractive index anisotropy (Δn) to optimum values in the polymerizable composition.

The polymerizable composition of the present invention is a polymerizable composition satisfying the expression represented by Expression (1): 1.0≦YI/Δn≦50.0.

In the expression, YI represents a yellowness index of a material including only a compound having a mesogenic group in the polymerizable composition, and Δn represents a refractive index anisotropy of a material including only a compound having a mesogenic group in the polymerizable composition.

However, the chiral compound having the mesogenic group is excluded in the material including only the compound having a mesogenic group.

In order to obtain the material in which the polymer increasing amount and the viscosity increase rate of the polymerizable composition are suppressed and which has good adhesiveness, repellence, and alignment properties, the value of YI/Δn of the mixture is preferably 1.0 or more, preferably 1.5 or more, and preferably 2.0 or more, and preferably 50.0 or less, and preferably 45.0 or less.

The yellowness index (YI) is measured as follows. First, a material is prepared by only containing all the compounds having a mesogenic group in the polymerizable composition of the present invention in the same content ratio as % by mass in the composition. The tetrahydrofuran solution containing the obtained material in a proportion of 20% by mass as a measurement object is measured using a spectrophotometer by putting the measurement object in a transparent cell having an optical path length of 1 cm. Further, a solvent other than tetrahydrofuran may be used as long as the solution obtains a sufficient solubility of the compound having a mesogenic group. For example, cyclopentanone, chloroform, and the like may be used. The yellowness index (YI) of the material having only the compounds having a mesogenic group in the polymerizable composition is calculated by converting the obtained measurement values into the value of the case measured by using a cell where the material solution concentration of measurement object is 20% by mass and the optical path length is 1 cm.

Also, when preparing a measuring target, in a case of not obtaining a uniform solution of 20% by mass in tetrahydrofuran or a solvent other than tetrahydrofuran, a solution containing the material in a proportion of 4% by mass is measured as a measuring object by putting the measuring object in a transparent cell having an optical path length of 5 cm using a spectrophotometer. The yellowness index (YI) of the material in which all the compounds having mesogenic groups in the polymerizable composition are combined is calculated by converting the obtained measurement values into the value of the case measured by using a cell where the material solution concentration of measurement object is 20% and the optical path length is 5 cm.

The refractive index anisotropy of the material including only a compound having a mesogenic group in the polymerizable composition of the present invention is measured as follows. First, a material is prepared by only containing all the compounds having a mesogenic group in the polymerizable composition of the present invention in the same content ratio as % by mass in the composition. The obtained material is added to the host liquid crystal, and this resultant is referred to as the liquid crystal composition. A glass cell is generated by using glass substrates in which a polyimide alignment film is attached, by combining the two glass substrates such that the substrates are parallel to the rubbing direction of the polyimide alignment film. The film is obtained by being peeled off from the glass cell after injecting the liquid crystal composition to the glass cell and curing by irradiation with ultraviolet rays (illuminance of 800 mJ/cm²). Then, the refractive index anisotropy (An) is calculated by measuring the ne and no of the film using Abbe's refractometer and extrapolating the measured values such that the material including only a compound having a mesogenic group in the polymerizable composition of the present invention is 100% by mass.

Then, the value of YI/Δn is obtained by dividing the YI obtained by the above by the Δn obtained by the above.

(Compound Having Mesogenic Group)

As the compound having a mesogenic group in the art, as long as it is confirmed that the compound exhibits a liquid crystal phase in a case of a composition in which a plurality of compounds are mixed, a compound having one or more polymerizable functional groups in a molecule or a compound having no polymerizable functional group in a molecule may be used without particular limitation. Further, the compound alone having a mesogenic group may not exhibit liquid crystallinity. The mesogenic group is a group composed of two or more ring structures and a linking group which links these ring structures or a single bond, and means a portion constituted such that two or more ring structures are linked by a linking group having 2 or less atoms having a bond site connecting the ring structure and the ring structure in the shortest path or a single bond. However, chiral compounds are excluded.

Among the compounds containing a mesogenic group, in a case of preparing a mixture using the compound having one polymerizable functional group in a molecule, it is easy to make mixtures at low temperature before and after room temperature as a liquid crystal temperature range and thus preferable. Examples of such compounds include a rod-like polymerizable liquid crystal compound having a rigid site as a mesogenic group in which a plurality of structures such as a 1,4-phenylene group, a 1,4-cyclohexylene group, and the like are connected, and having a polymerizable functional group such as a vinyl group, an acryloyl group, a (meth) acryloyl group, which is disclosed in Handbook of Liquid Crystals (edited by D. Demus, J. W. Goodby, G. W. Gray, H. W. Spiess, V. ViII, published by Wiley-VCH Verlag GmbH & Co. KGaA, 1998), Kikan kagaku sosetsu No. 22, Liquid crystal chemistry (edited by the Chemical Society of Japan, 1994), or JP-A-7-294735, JP-A-8-3111, JP-A-8-29618, JP-A-11-80090, JP-11-116538, JP-A-11-148079, and the like, a rod-like polymerizable liquid crystal compound having a maleimide group as disclosed in JP-A-2004-2373 discloses and JP-A-2004-99446, and the like.

Specifically, the liquid crystal compound having two or more of polymerizable functional groups is preferably a compound represented by the following Formula (1).

[Chem. 1]

P¹-(Sp¹)ₘ₁-MG1-R¹ (1)

In the formula, p¹ represents a polymerizable functional group, Sp¹ represents an alkylene group having to 18 carbon atoms (the alkylene group may be substituted by an alkyl group having 1 to 8 carbon atoms and having one or more halogen atoms, CN groups, polymerizable functional groups, one of the CH groups present in the group or two or more of the CH₂ groups which are not adjacent to each other may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), m1 represents 0 or 1, MG1 represents a mesogenic group or a mesogenic supporting group, R¹ represents a hydrogen atom, a halogen atom, a cyano group or an alkyl group having 1 to 18 carbon atoms, but the alkyl group may be substituted by one or more halogen atoms or CN groups, one of the CH₂ groups present in the group or two or more of the CH₂ groups which are not adjacent to each other may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom, or R¹ represents a structure represented by Formula (1-a).

[Chem. 2]

-(Sp^{1a})ₘₐ-P^{1a} (1-a)

(In the formula, P^{1a} represents a polymerizable functional group, Sp^{1a} represents the same meaning as Sp¹, and ma represents 0 or 1.) The mesogenic group or the mesogenic supporting group represented by MG1 is represented by Formula (1-b).

[Chem. 3]

—Z0-(A1-Z1)ₚ-(A2-Z2)_{q}-(A3-Z3)ᵣ-A4-Z4-A5-Z5- (1-b)

(In the formula, A1, A2, A3, A4, and A5 each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and

A1, A2, A3, A4, and A5 may have, as substituents, one or more F, Cl, CF₃, OCF₃, and CN groups, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkenyl group having 2 to 8 carbon atoms, an alkenyloxy group having 2 to 8 carbon atoms, an alkenoyl group having 2 to 8 carbon atoms, an alkenoyloxy group having 2 to 8 carbon atoms, or one or more substituent represented by Formula (1-c).

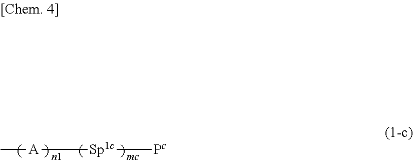

(In the formula, P^{c} represents a polymerizable functional group, A represents —O—, —COO—, —OCO—, —OCH₂—, —CH₂O—, —CH₂CH₂OCO—, —COOCH₂CH₂—, —OCOCH₂CH₂—, or a single bond, Sp^{1c} represents the same meaning as Sp¹, but Sp^{1c} and Sp¹ may be the same as or different to each other, n1 represents 0 or 1, and mc represents 0 or 1),
Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond, and

p, q, and r each independently represent 0 or 1, and satisfy 0≦p+q+r≦3.). However, in Formula (1), two or more polymerizable functional groups are present.

P¹, P^{1a}, and P^{c} preferably represent substituents selected from polymerizable groups represented by the following Formulas (P-1) to (P-20).

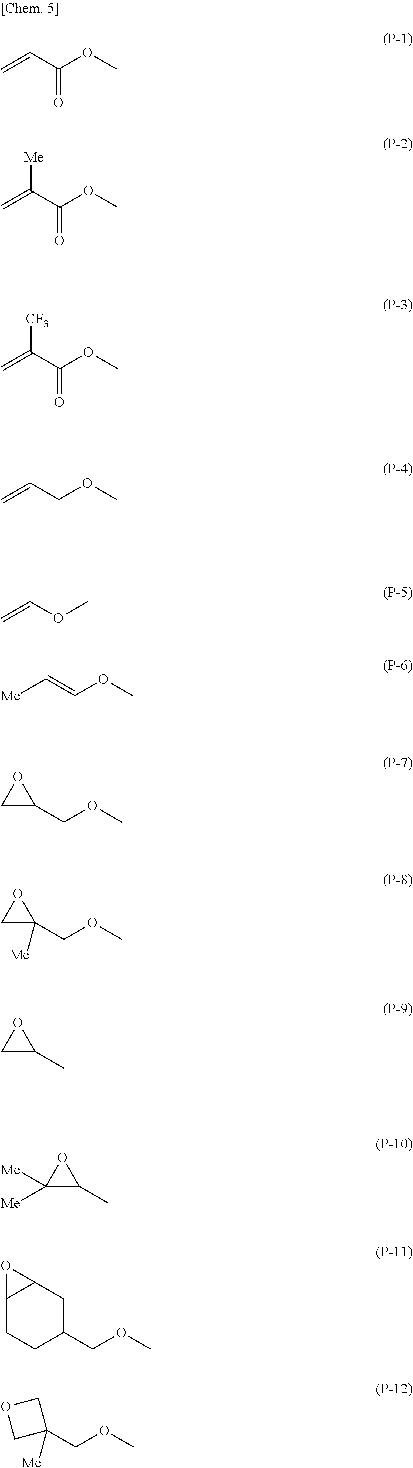

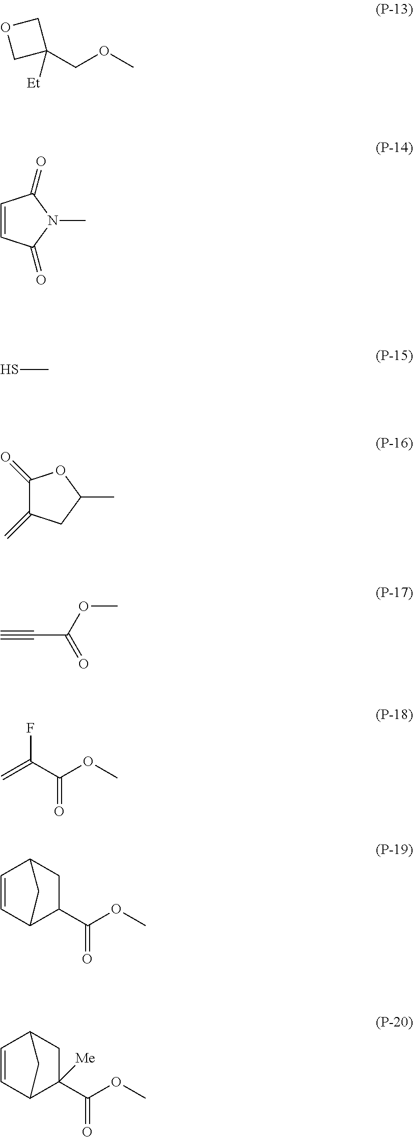

Among these polymerizable functional groups, Formula (P-1), Formula (P-2), (P-7), (P-12), or (P-13) is preferable, and Formula (P-1), (P-2), (P-7), or (P-12) is more preferable, from the viewpoint of enhancing polymerizable properties and storage stability.

One or more liquid crystal compounds having two or more polymerizable functional groups may be used, but one to six liquid crystal compounds are preferably used, and two to five liquid crystal compounds are more preferably used.

The content of the liquid crystal compound having two or more polymerizable functional groups is preferably 5% to 100% by mass, more preferably 10% to 100% by mass, and particularly preferably 15% to 100% by mass in the polymerizable liquid crystal composition. In a case of emphasizing the alignment properties of the optical anisotropic body, the lower limit value is preferably set to be 5% by mass or higher, more preferably 10% by mass or higher, and particularly preferably 15% by mass or higher, and, on the other hand, in a case of emphasizing rigidity, the upper limit value is preferably set to be 90% by mass or lower, more preferably 80% by mass or lower, and particularly preferably 70% by mass or lower.

As the liquid crystal compound having two or more polymerizable functional groups, a compound having two polymerizable functional groups is preferable, and a compound represented by the following Formula (2) is preferable.

[Chem. 6]

P^{2a}-(Sp^{2a})ₘ₂-Z0-(A^{1a}-Z1)ₚ-(A2^{a}-Z2)_{q}-(A3^{a}-z3)ᵣ-A4^{a}-z4-A5^{a}-z5-(Sp^{2b})ₙ₂-P^{2b} (2)

In the formula, A1^{a}, A2^{a}, A3^{a}, A4^{a}, and A5^{a} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and

A1^{a}, A2^{a}, A3^{a}, A4^{a}, and A5^{a} may have, as substituents, one or more F, Cl, CF₃, OCF₃, and CN groups, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, an alkenyloxy group having 2 to 8 carbon atoms, an alkenoyl group having 2 to 8 carbon atoms, and an alkenoyloxy group having 2 to 8 carbon atoms.

In addition, Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, and

p, q, and r each independently represent 0 or 1, and satisfy 0≦p+q+r≦3.

P^{2a} and P^{2b} represent a polymerizable functional group, Sp^{2a} and Sp^{2b} each independently represent an alkylene group having 0 to 18 carbon atoms (the alkylene group may be substituted by one or more halogen atoms or CN, one of the CH₂ groups present in the group or two or more of the CH₂ groups which are not adjacent to each other may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and m2 and n2 each independently represent 0 or 1.

P^{2a} and P^{2b} preferably represent substituents selected from polymerizable groups represented by the following Formula (P-1) to Formula (P-20).

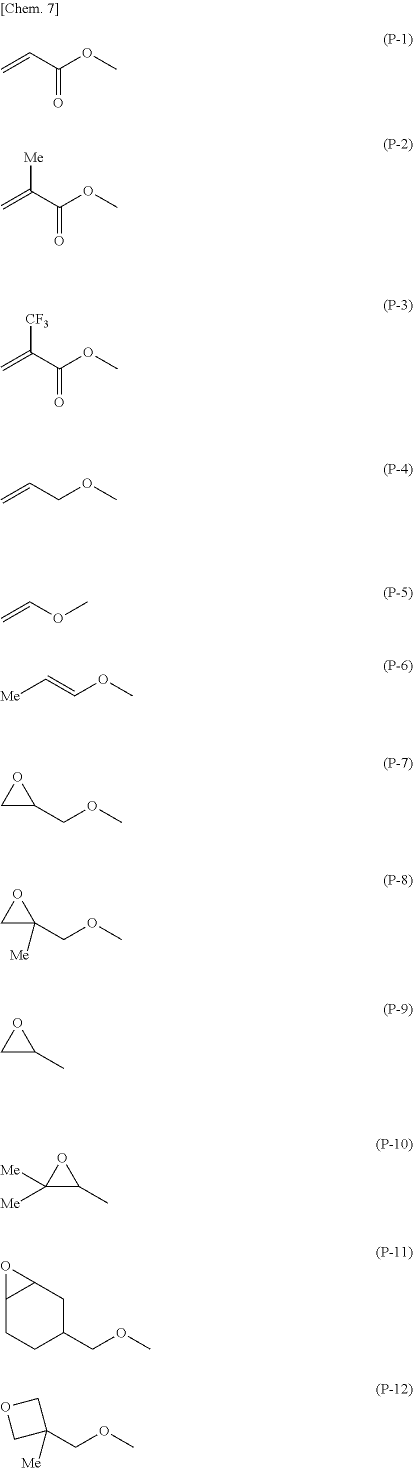

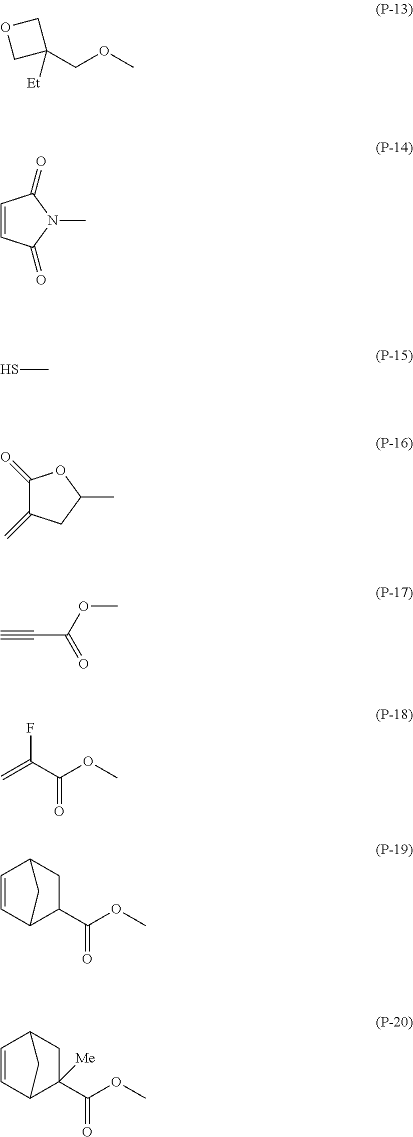

Among these polymerizable functional groups, Formula (P-1), Formula (P-2), (P-7), (P-12), or (P-13) is preferable, and Formula (P-1), Formula (P-2), (P-7), or (P-12) is more preferable, from the viewpoint of enhancing polymerizable properties and storage stability.

Furthermore, as an example of Formula (2), Formulas (2-1) to (2-4) may be exemplified, but Formula (2) is not limited to the following Formulas.

[Chem. 8]

P^{2a}-(Sp^{2a})ₘ₂-Z0-A4^{a}-Z4-A5^{a}-Z5-(Sp^{2b})ₙ₂-P^{2b} (2-1)

P^{2a}-(Sp^{2a})ₘ₂-Z0-A3^{a}-Z3-A4^{a}-Z4-A5^{a}-Z5-(Sp^{2b})ₙ₂-P^{2b} (2-2))

P^{2a}-(Sp^{2a})ₘ₂-Z0-A2^{a}-Z2-A3^{a}-Z3-A4^{a}-Z4-A5^{a}-Z5-(Sp^{2b})ₙ₂-P^{b2} (2-3)

P^{2a}-(Sp^{2a})ₘ₂-Z0-A1^{a}-Z1-A2^{a}-Z2-A3^{a}-Z3-A4^{a}-Z4-A5^{a}-Z5-(Sp^{2b})ₙ₂-P^{2b} (2-4)

Specific examples of the polymerizable liquid crystal compound having two polymerizable functional groups include compounds of Formulas (2-5) to (2-30), but the compound is not limited to the following compounds.

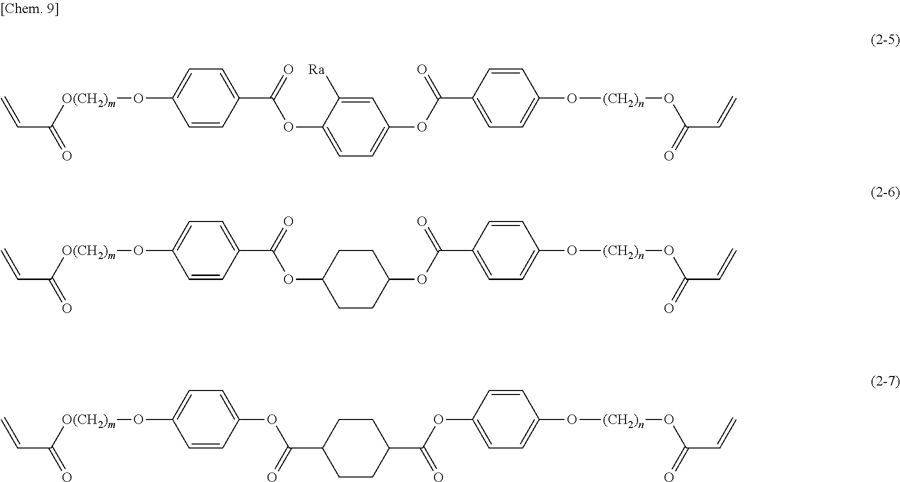

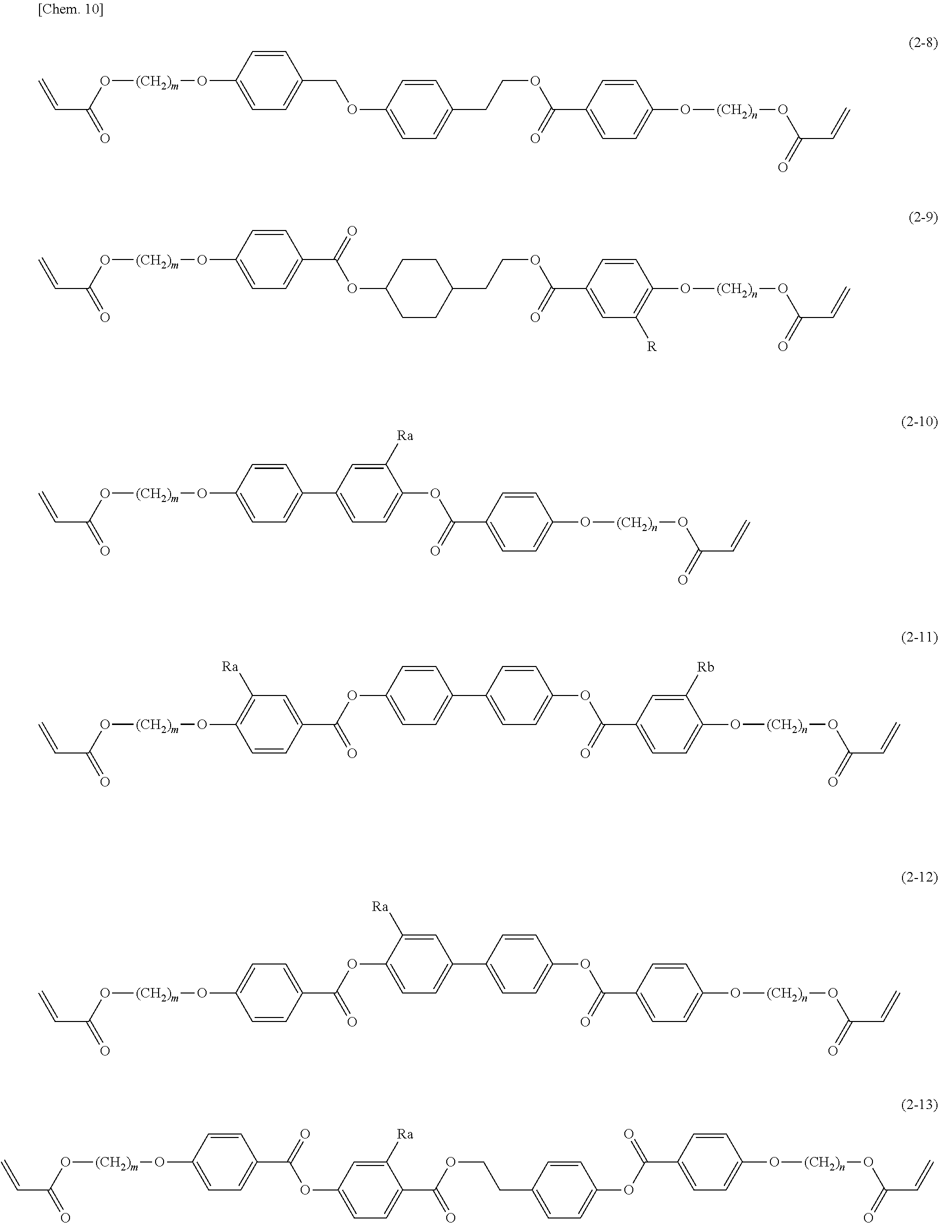

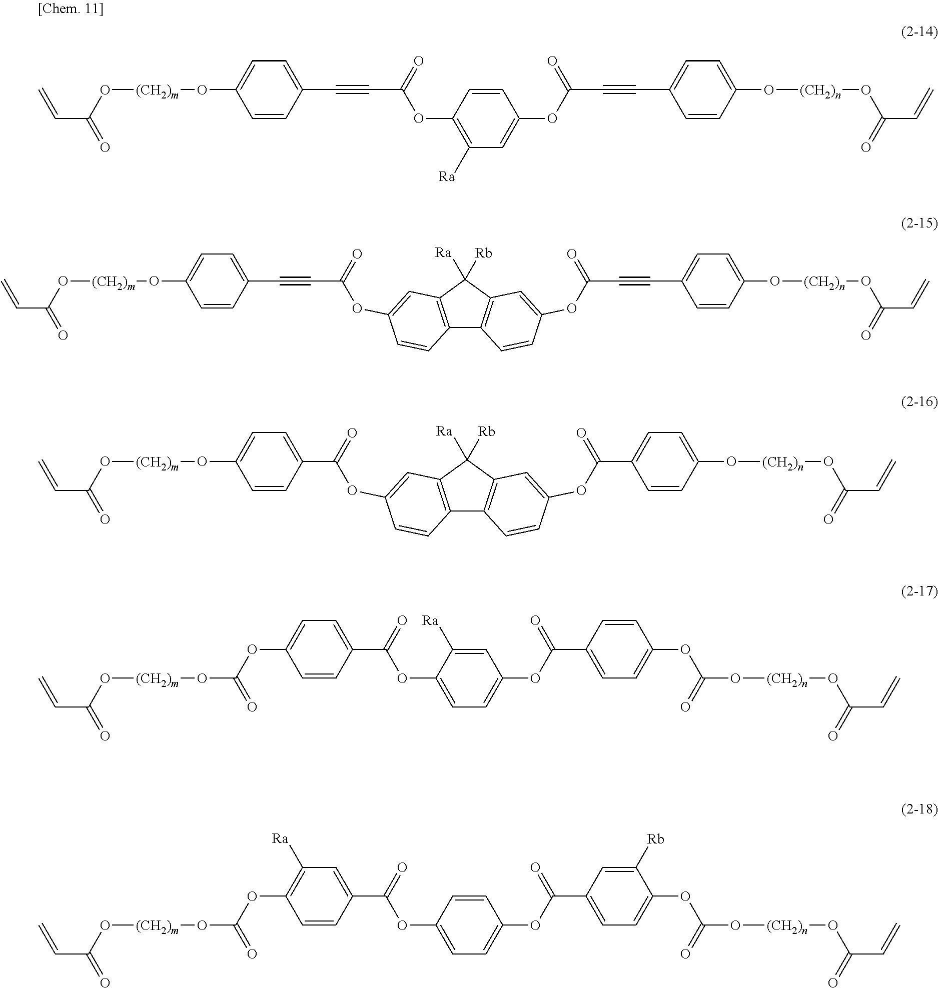

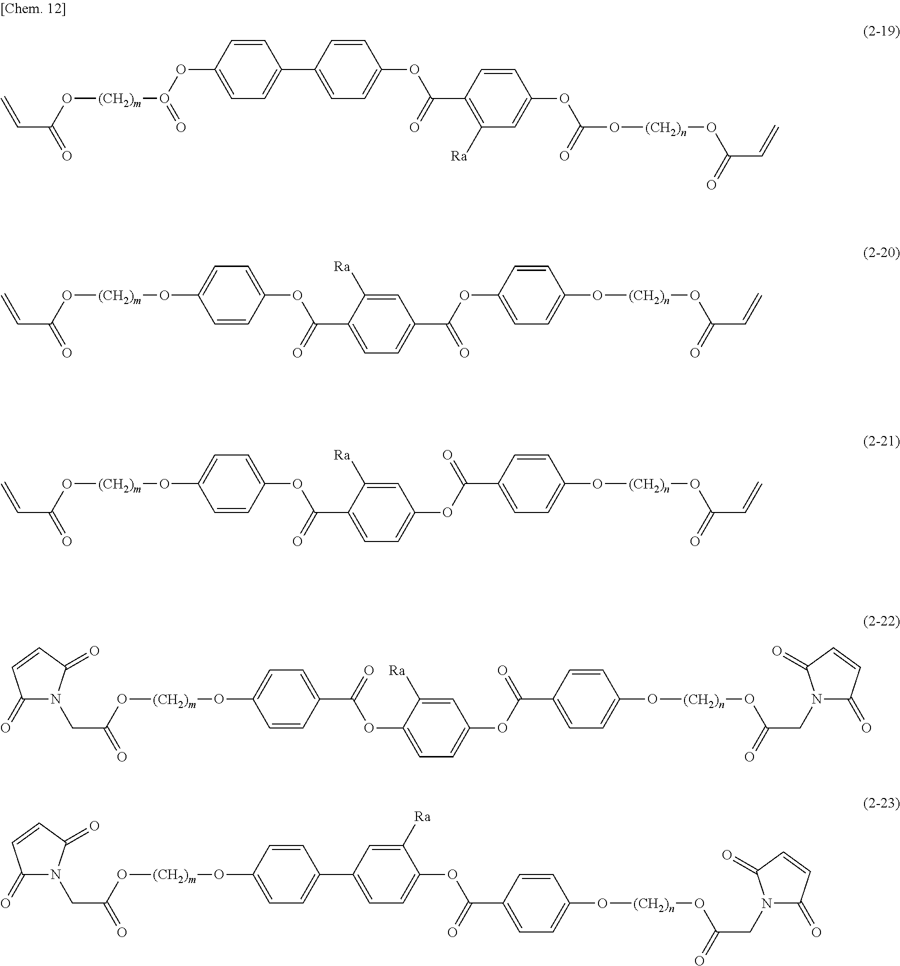

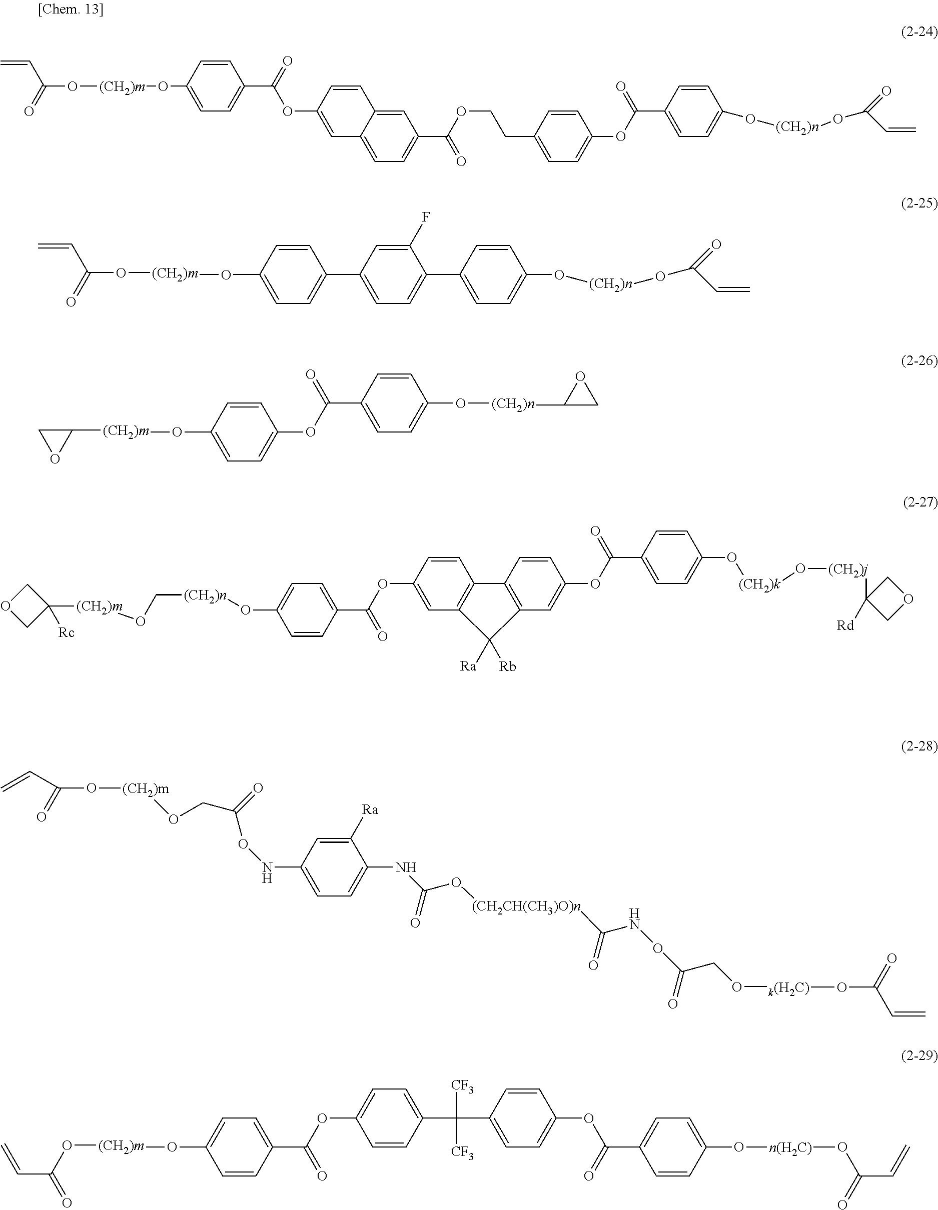

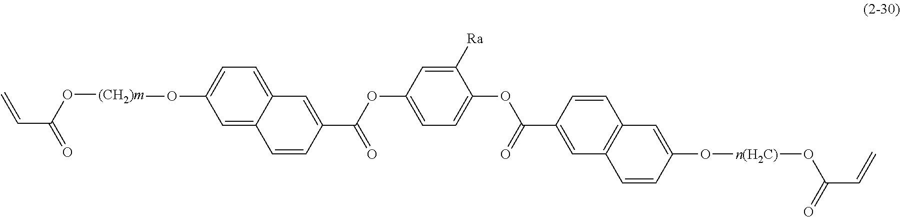

In the formulas, m, n, k, and j each independently represent an integer of 1 to 18, and Ra to Rd each independently represent a hydrogen atom, a halogen atom, an alkyl group having 1 to 6 carbon atoms, an alkoxy group having 1 to 6 carbon atoms, or a cyano group, but in a case where these groups are an alkyl group having 1 to 6 carbon atoms or an alkoxy group having 1 to 6 carbon atoms, all of the groups may be unsubstituted, or may be substituted by one or more of halogen atoms.

One or more liquid crystal compounds having two polymerizable functional groups may be used, but one to five liquid crystal compounds may be preferably used, and two to five liquid crystal compounds may be more preferably used.

The content of the liquid crystal compound having two or more polymerizable functional groups is preferably 5% to 100% by mass, more preferably 8% to 100% by mass, and particularly preferably 10% to 100% by mass in the polymerizable composition. In a case of emphasizing the rigidity of the optical anisotropic body, the lower limit value is preferably set to be 5% by mass or higher, more preferably 10% by mass or higher, and particularly preferably 20% by mass or higher, and, in a case of emphasizing low curing shrinkage, the upper limit value is preferably set to be 90% by mass or lower, and preferably 80% by mass or lower.

In addition, in recent years, in a phase difference film, wavelength dispersion properties of birefringence (Δn) is required to be small or reverse, in order to enhance a viewing angle of a liquid crystal display or reflection prevention properties of an organic EL display. A so-called reverse dispersion type polymerizable liquid crystal compound having these properties can be contained in the polymerizable composition of the present invention. Specific examples thereof include compounds represented by the following General Formula (3-1).

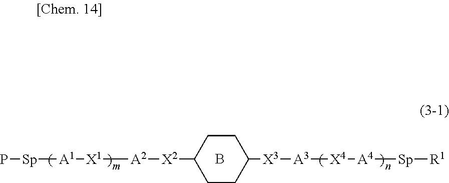

In the formula, P represents a polymerizable functional group, Sp represents a spacer group or a single bond,

A¹, A², A³, and A⁴ each independently represent a divalent alicyclic hydrocarbon group or an aromatic hydrocarbon group,

X¹, X², X³, and X⁴ each independently represent a divalent linking group or a single bond,

R¹ represents an alkyl group having 1 to 12 carbon atoms, an alkoxy group, or “*-Sp-P” represents bonding to A⁴ or A³),

m and n each independently represent an integer of 0 to 4, with the proviso that the total number of m and n is an integer of 2 or more, and

B represents a group represented by the following Formula (i) or Formula (ii).

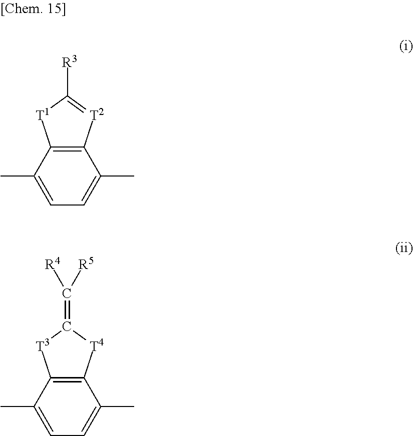

In Formula (i), T¹ represents —S—, —O—, —CH₂—, —NH—, —CO—, —SO—, or —CS—, 1² represents ═CR²— or ═N—, R² represents a hydrogen atom, a halogen atom, an alkyl group having 1 to 6 carbon atoms, an alkoxy group having 1 to 6 carbon atoms, a cyano group, a nitro group, or a hydroxyl group, and R³ represents an alkyl group having 1 to 6 carbon atoms, an alicyclic hydrocarbon group, or an aromatic hydrocarbon group. In Formula (ii), T³ and T⁴ each independently represent —S—, —O—, —NR⁶—, —CH₂—, —NH—, —CO—, —SO—, or —CS—, where, R⁶ represents a hydrogen atom, a halogen atom, an alkyl group having 1 to 6 carbon atoms, an alkoxy group having 1 to 6 carbon atoms, a cyano group, a nitro group, or a hydroxyl group, and R⁴ and R⁵ each independently represent a monovalent substituent, or form a ring via Y linking R⁴ and R⁵.

The compound represented by General Formula (3-1) preferably has crystallinity before polymerization. In other words, the compound represented by General Formula (3-1) is preferably a polymerizable liquid crystal compound.

As the polymerizable functional group represented by P in General Formula (1), the conventional group used for the polymerizable liquid crystal compound can be applied without limitation, and examples thereof include a vinyl group, a p-stilbene group, an acryl group (an acryloyl group), a methacryl group (a methacryloyl group), an acryloyloxy group, a methacryloyloxy group, a carboxyl group, a methylcarbonyl group, a hydroxyl group, an amide group, an alkylamino group having 1 to 4 carbon atoms, an amino group, an epoxy group, an oxetanyl group, an aldehyde group, an isocyanate group, or a thioisocyanate group.

Preferred examples of the polymerizable functional group P include a substituent selected from the group consisting of substituents represented by the following General Formula (II-c), General Formula (II-d), and General Formula (II-e).

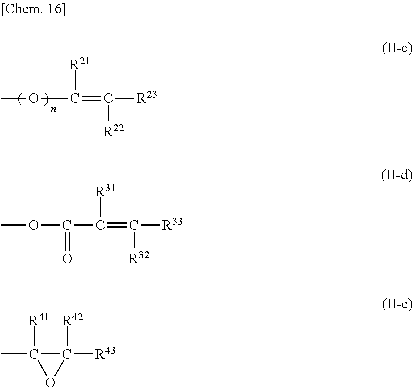

In General Formula (II-c), General Formula (II-d), and General Formula (II-e), R²¹, R²², R²³, R³², R³³, R⁴¹, R⁴², and R⁴³ each independently represent a hydrogen atom, a halogen atom, or an alkyl group having 1 to 5 carbon atoms, and n represents 0 or 1. Also, R³¹ of General Formula (II-d) represents a hydrogen atom, a halogen atom, an alkyl group having 1 to 5 carbon atoms, or a halogenated alkyl group having 1 to 5 carbon atoms.

The left terminals of the polymerizable functional groups represented by general formulas shown above each is bonded to Sp of General Formula (3-1).

The alkyl group is preferably a linear or branched alkyl group, and the linear alkyl group is more preferable. A part or all of hydrogen atoms bonded to the alkyl group may be substituted with a halogen atom.

Among the polymerizable functional groups represented by general formulas shown above, a group selected from the group consisting of the groups represented by General Formula (II-c) and General Formula (II-d) is preferable, and a group selected from the group consisting of the group represented by General Formula (II-d) is more preferable from a viewpoint of increasing polymerization performance and storage stability.

Examples of the polymerizable functional group represented by General Formula (II-c), General Formula (II-d), or General Formula (II-e) include the following reactive functional groups (P-1) to (P-8). Among these reactive functional groups, the following (P-1) or (P-2) is preferable and the following (P-1) is more preferable, from a viewpoint of increasing polymerization performance and storage stability. The right terminals of the polymerizable functional groups represented by the following (P-1) to (P-8) each is bonded to Sp of General Formula (3-1).

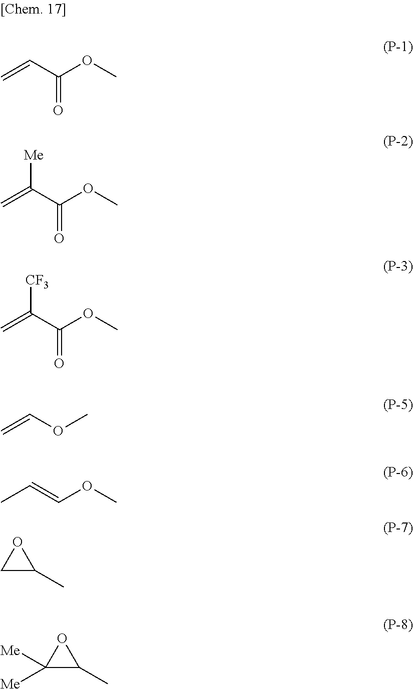

Sp in General Formula (3-1) represents a spacer group or a single bond. The spacer group represents a divalent linking group which can link the polymerizable functional group P with A¹ or A², and a linking group not impairing crystallinity of the compound represented by General Formula (3-1) is preferable.

Preferred examples of Sp include a linear alkylene group having 1 to 20 carbon atoms. One CH₂ group or two or more CH₂ groups not adjacent to each other, which are present in the alkylene group, each independently may be substituted with —O—, —S—, —NH—, —N(CH₃)—, —CO—, —COO—, —OCO—, —OCOO—, —SCO—, —COS—, —CH═CH—, or —C≡C—, as long as oxygen atoms, sulfur atoms, and an oxygen atom and a sulfur atom are not directly bonded to each other. The number of carbon atoms of the alkylene group is preferably 2 to 10, more preferably 3 to 8, and still more preferably 3 to 6, from a viewpoint of improving crystallinity.

Cyclic groups A¹, A², A³, and A⁴ of General Formula (3-1) each independently represent a divalent alicyclic hydrocarbon group or an aromatic hydrocarbon group. In addition, the aforementioned cyclic group may be an aromatic heterocyclic group.

Examples of the cyclic group include a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene 2,7-diyl group, or a fluorene 2,7-diyl group.

One or more hydrogen atoms bonded to the 1,4-phenylene group, the 1,4-cyclohexylene group, the 1,2,3,4-tetrahydronaphthalene-2,6-diyl group, the 2,6-naphthylene group, the phenanthrene-2,7-diyl group, the 9,10-dihydrophenanthrene-2,7-diyl group, the 1,2,3,4,4a,9,10a-octahydrophenanthrene 2,7-diyl group, and the fluorene 2,7-diyl group may be substituted with F, Cl, CF₃, OCF₃, a cyano group, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkenyl group having 2 to 8 carbon atoms, an alkenyloxy group having 2 to 8 carbon atoms, an alkenoyl group having 2 to 8 carbon atoms, or an alkenoyloxy group having 2 to 8 carbon atoms.

Cyclic groups A¹, A², A³, and A⁴ of General Formula (3-1) each independently are preferably a 1,4-phenylene group or a 1,4-cyclohexylene group described above. In the case of this cyclic group, crystallinity of the polymerizable compound of the present embodiment can be easily improved and aligning properties of a polymer can be easily improved.

X¹, X², X³, and X⁴ of General Formula (3-1) each independently represent a divalent linking group or a single bond.

Preferred examples of X¹, X², X³, and X⁴ each independently include —(CH₂)ᵤ—O—COO—, —(CH₂)ᵤ—OCO—, —(CH₂)ᵤ—COO—, —(CH₂)ᵤ—O—, —O—COO—(CH₂)ᵤ—, —OCO—(CH₂)ᵤ—, —COO—(CH₂)ᵤ—, —O—(CH₂)ᵤ—, —O—(CH₂)ᵥ—O—, —CH═CH—, —C≡C—, —CH═CHCOO—, —OCOCH═CH—, —N═N—, —C═N—, —N═C—, —C═N—N═C—, —CH₂CH₂—, and a single bond. Here, u represents any one of integers of 0 to 2, and v represents 1 or 2. In the case where u represents 0, —(CH₂)ᵤ—O—COO— and —O—COO—(CH₂)u- represent —O—COO—, —(CH₂)ᵤ—O— and —O—(CH₂)ᵤ— represent —O—, —(CH₂)ᵤ—COO— and —COO—(CH₂)ᵤ— represent —COO—, and —(CH₂)ᵤ—OCO—and —OCO—(CH₂)ᵤ— represent —OCO—.

m and n of General Formula (3-1) each independently represent an integer of 0 to 4, and the total number of m and n is an integer of 2 or more.

m and n each independently preferably represent 0 to 3, more preferably 0 to 2, and still more preferably 1 or 2, from a viewpoint of improving crystallinity of the polymerizable compound of the present embodiment. Also, m and n are preferably the same integer.

A terminal group R¹ of General Formula (3-1) represents an alkyl group having 1 to 12 carbon atoms, an alkoxy group having 1 to 12 carbon atoms, or “*-Sp-P”. Here, “*” represents bonding to A⁴ in the case where n is an integer of 1 or more, and represents bonding to A³ in the case where n is 0.

Sp of “*-Sp-P” and the polymerizable functional group P are the same as described above. In the case where two Sp's are present in a molecule, they may be the same as or different from each other, and preferably the same as each other. Also, in the case where two P's are present in a molecule, they may be the same as or different from each other, and preferably the same as each other.

The alkyl group may be any one of a linear, branched, and cyclic alkyl group, a linear or branched alkyl group is preferable, and a linear alkyl group is more preferable. The number of carbon atoms of the alkyl group is more preferably 2 to 10, more preferably 3 to 8, and still more preferably 3 to 6.

As an alkyl group which constitutes the alkoxy group, the same group exemplified in the alkyl group can be mentioned. The number of carbon atoms of the alkyl group which constitutes the alkoxy group is preferably 1 to 8, more preferably 1 to 6, and still more preferably 1 to 3.

The terminal group R¹ is preferably “*-Sp-P” from a viewpoint of improving crystallinity and aligning properties of the polymerizable compound of the present embodiment, and improving optical properties of an optically anisotropic body of a phase difference film using the polymerizable compound. In this preferable case, two Sp's present in a molecule may be different from each other and preferably the same as each other. Two P's present in a molecule may be the same as or different from each other, and preferably the same as each other.

A central skeleton B of General Formula (3-1) is a group represented by the following Formula (i) or Formula (ii).

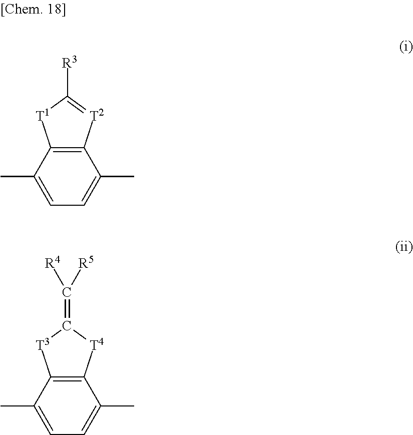

In General Formula (i), T¹ represents —S—, —O—, —CH₂—, —NH—, —CO—, —SO—, or —CS—, preferably —NH— or —S—, and more preferably —S—.

In General Formula (i), 1² represents “═CR²—” or “═N-”, and R² represents a hydrogen atom, a halogen atom, an alkyl group having 1 to 6 carbon atoms, an alkoxy group having 1 to 6 carbon atoms, a cyano group, a nitro group, or a hydroxyl group. Also, “═CR²—” represents “═C(—R²)—”, and a hydrogen atom is not bonded to the carbon atom C where R² is bonded.

In General Formula (i), 1² preferably represents ═CH—, ═C(—CH₃)—, ═C(—OCH₃)—, or ═N—, and ═N— is more preferable.

In the case where R² represents an alkyl group or an alkoxy group, examples of the alkyl group of R² and an alkyl group which constitutes the alkoxy group of R² include a methyl group, an ethyl group, a propyl group, an isopropyl group, a butyl group, an isobutyl group, a sec-butyl group, a tert-butyl group, a pentyl group, and a hexyl group. The number of carbon atoms of the alkyl group is preferably 1 to 4, more preferably 1 or 2, and still more preferably 1.

In the case where R² is a halogen atom, a fluorine atom, or a chlorine atom is preferable.

A preferable combination of T¹ and 1² is represented by the following General Formulas (i-1) to (i-5).

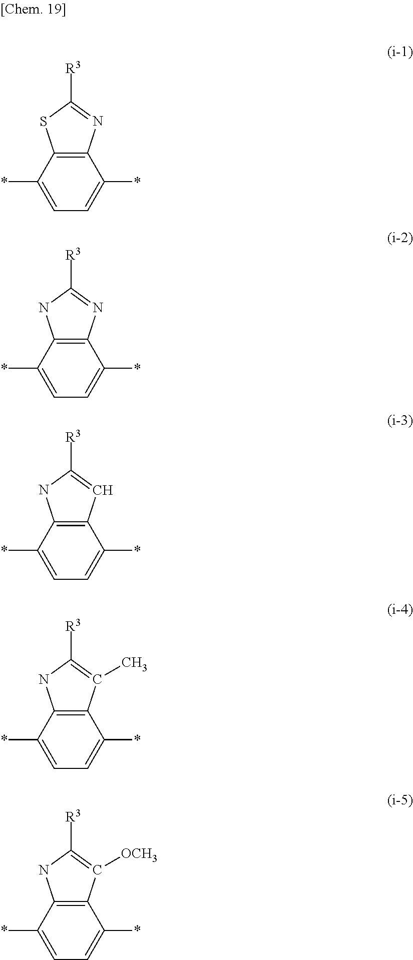

In the formulas, each “*” represents bonding to X² and X³ of General Formula (i) and R³ is the same as the R³ of General Formula (i).

In General Formula (i), R³ represents an alkyl group having 1 to 6 carbon atoms, an alicyclic hydrocarbon group, or an aromatic hydrocarbon group. Among these, R³ is preferably an alicyclic hydrocarbon group or an aromatic hydrocarbon group, and more preferably an aromatic hydrocarbon group from a viewpoint of improving crystallinity and optical properties.

A hydrogen atom included in the alicyclic hydrocarbon group and the aromatic hydrocarbon group may be substituted with an alkyl group having 1 to 6 carbon atoms, an alkoxy group having 1 to 6 carbon atoms, a halogen atom, a cyano group, a nitro group, a —C≡C—CH₃ group, or a hydroxyl group. Among the substituents exemplified herein, a nitro group, a cyano group, and a —C≡C—CH₃ group are preferable from a viewpoint of improving crystallinity and aligning properties of the polymerizable compound.

Examples of the alkyl group and an alkyl group which constitutes the alkoxy group include a methyl group, an ethyl group, a propyl group, an isopropyl group, a butyl group, an isobutyl group, a sec-butyl group, a tert-butyl group, a pentyl group, and a hexyl group. The number of carbon atoms of the alkyl group is preferably 1 to 4, more preferably 1 or 2, and still more preferably 1.

The number of carbon atoms of the alicyclic hydrocarbon group is preferably 4 to 10 and more preferably 5 to 8. Examples of the alicyclic hydrocarbon group include groups represented by the following Formulas (i-6-1) to (i-6-4). Also, a part of the carbon atom constituting this alicyclic hydrocarbon group may be substituted with a hetero atom such as a nitrogen atom, an oxygen atom, and a sulfur atom. Examples of this alicyclic group include groups represented by the following Formulas (i-6-5) to (i-6-10). In the formula, “k” represents bonding to the carbon atom where R³ of General Formula (i) is bonded.

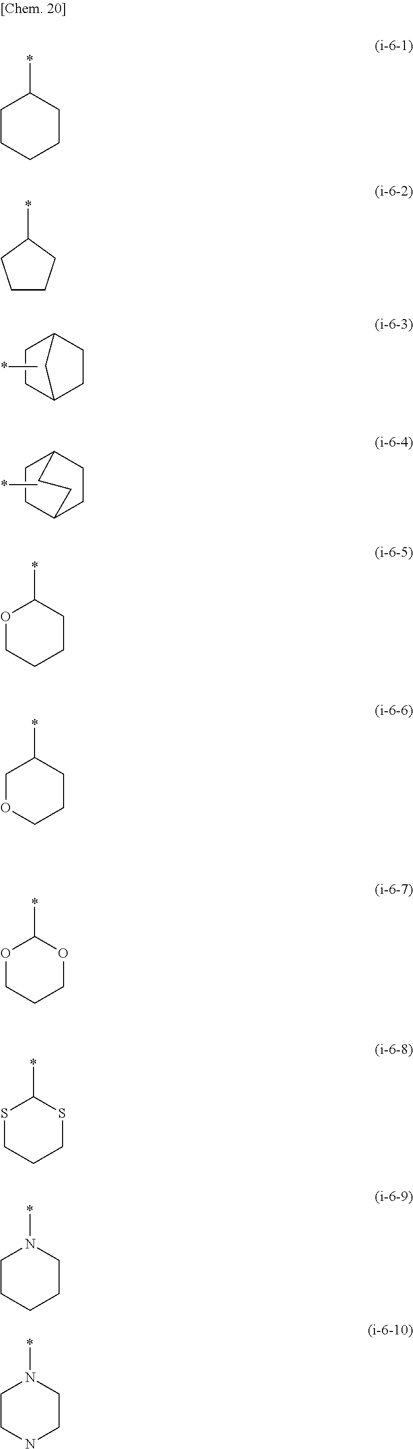

Among the aforementioned groups (i-6-1) to (i-6-10), the group (i-6-1) or (i-6-2) is preferable. The group (i-6-1) and (i-6-2) may have a substituent, and as the substituent, a nitro group, a cyano group, and a —C≡C—CH₃ group are preferable. The substituent is preferably bonded to the 4th position of the group (i-6-1) or the third position of the group (i-6-2). Here, a carbon atom bonded to the “*” among the carbon atoms constituting the ring is the first position.

The number of carbon atoms of the aromatic hydrocarbon group is preferably 6 to 20 and more preferably 6 to 14. Examples of the aromatic hydrocarbon group include groups represented by the following Formulas (i-7-1) to (i-7-13). In the formulas, “*” represents bonding to the carbon atom where R³ of General Formula (i) is bonded.

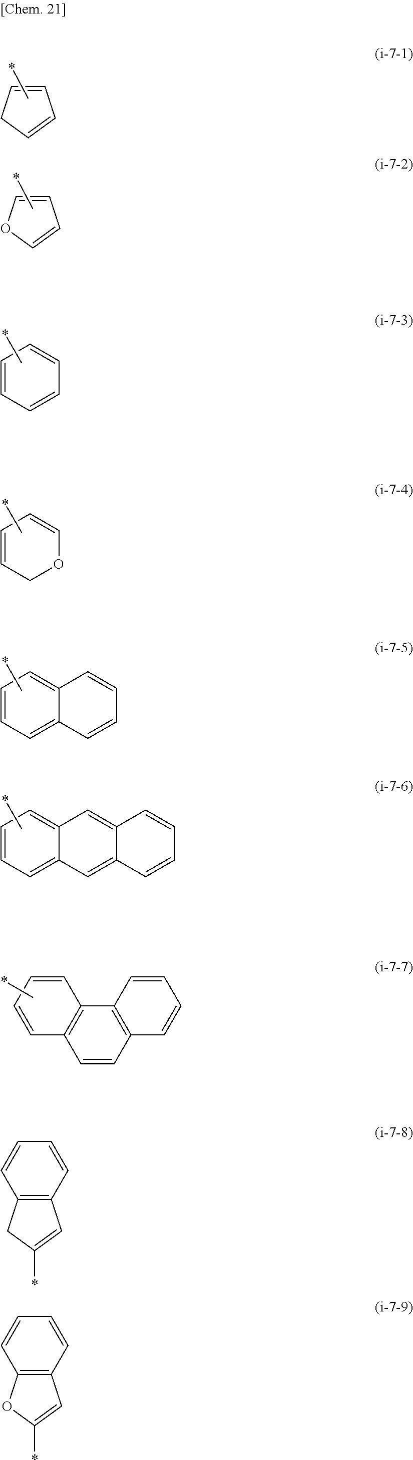

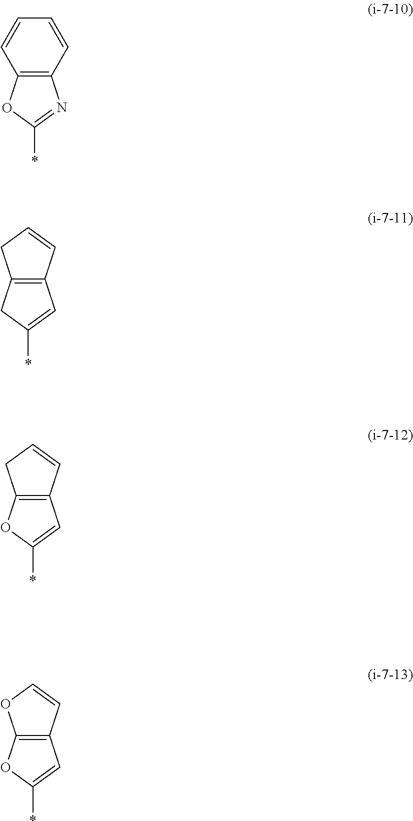

Among the aforementioned groups (i-7-1) to (i-7-13), the groups (i-7-1) to (i-7-4) and (i-7-7) to (i-7-10) are preferable. In addition, the ring structure preferably has the substituent, and as the substituent, a nitro group, a cyano group, and a —C≡C—CH₃ group are preferable.

In General Formula (ii), T³ and T⁴ each independently represent —S—, —O—, —NR²—, —CH₂—, —NH—, —CO—, —SO—, or —CS—. Here, R⁶ represents a hydrogen atom, a halogen atom, an alkyl group having 1 to 6 carbon atoms, an alkoxy group having 1 to 6 carbon atoms, a cyano group, a nitro group, or a hydroxyl group. T³ and T⁴ may be the same as or different from each other. In the case where all of the T³ and T⁴ are —NR⁶—, two R⁶'s may be the same as or different from each other.

T³ is preferably —O—, —NR⁶—, or —S—, more preferably —NR⁶— or —S—, and still more preferably —S—.

T⁴ is preferably —O—, —NR⁶—, or —S—, more preferably —NR⁶— or —S—, and still more preferably —S—.

In the case where R⁶ represents an alkyl group or an alkoxy group, examples of the alkyl group and an alkyl group constituting the alkoxy group of R⁶ include a methyl group, an ethyl group, a propyl group, an isopropyl group, a butyl group, an isobutyl group, a sec-butyl group, a tert-butyl group, a pentyl group, and a hexyl group. The number of carbon atoms of the alkyl group is preferably 1 to 4, more preferably 1 or 2, and still more preferably 1.

In the case where R⁶ represents a halogen atom, a fluorine atom or a chlorine atom is preferable.

In General Formula (ii), R⁴ and R⁵ each independently represent a monovalent substituent, or form a ring via Y linking R⁴ with R⁵.

Examples of the monovalent substituent of R⁴ and R⁵, each independently, include an alkyl group, a cycloalkyl group, a bicycloalkyl group, an alkenyl group, a cycloalkenyl group, a bicycloalkenyl group, an alkynyl group, an aryl group, a heteroring group, a cyano group, a carboxyl group, a hydroxyl group, a nitro group, a halogen atom, an alkoxy group, an aryloxy group, a silyloxy group, a heteroring oxy group, an acyloxy group, a carbamoyloxy group, an alkoxycarbonyloxy group, an aryloxycarbonyloxy group, an amino group, an acylamino group, an aminocarbonylamino group, an alkoxycarbonylamino group, an aryloxycarbonylamino group, a sulfamoylamino group, an alkyl or arylsulfonylamino group, a mercapto group, an alkylthio group, an arylthio group, a heteroring thio group, a sulfamoyl group, a sulfo group, an alkyl or arylsulfinyl group, an alkyl or arylsulfonyl group, an acyl group, an aryloxycarbonyl group, an alkoxycarbonyl group, a carbamoyl group, an aryl or heteroring azo group, an imide group, a phosphino group, a phosphinyl group, a phosphinyloxy group, a phosphinylamino group, and a silyl group.

In the case of the following General Formula (i-1) in which R⁴ and R⁵ form a ring via Y linking R⁴ with R⁵:

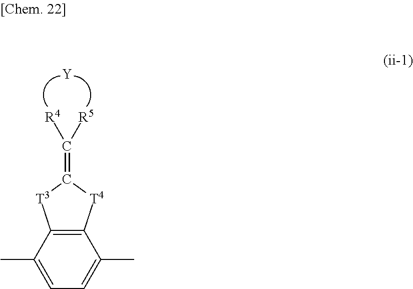

R⁴ and R⁵ each independently represent any one of the groups selected from the group consisting of —O—, —S—, —SO—, —SO₂—, —NR— (R represents a hydrogen atom or a monovalent substituent), ═N—, ═N(+)R— (where R represents a hydrogen atom or a monovalent substituent), —CO—, —CS—, and ═CR— (R represents a hydrogen atom or a monovalent substituent). Here, in the case where R is a monovalent substituent, as the monovalent substituent, the groups exemplified in the aforementioned monovalent substituent for R⁴ and R⁵ can be mentioned.

Y represents 2 to 4 atoms selected from the group consisting of a carbon atom and group 14 to 16 nonmetal atoms, and forms a 5- to 7-membered ring (hereinafter, may be referred to as ring Y) with R⁴—C—R⁵ shown in General Formula (i-1) shown above. In the case where an atom constituting the ring Y has a substitutable hydrogen atom, the hydrogen atom may be substituted with a substituent R^{Y}. As an example of R^{Y}, the groups exemplified in the aforementioned monovalent substituent for R⁴ and R⁵ can be mentioned.

Exemplary compounds represented by General Formula (3-1) are shown below, but the exemplary compounds are not limited to these.

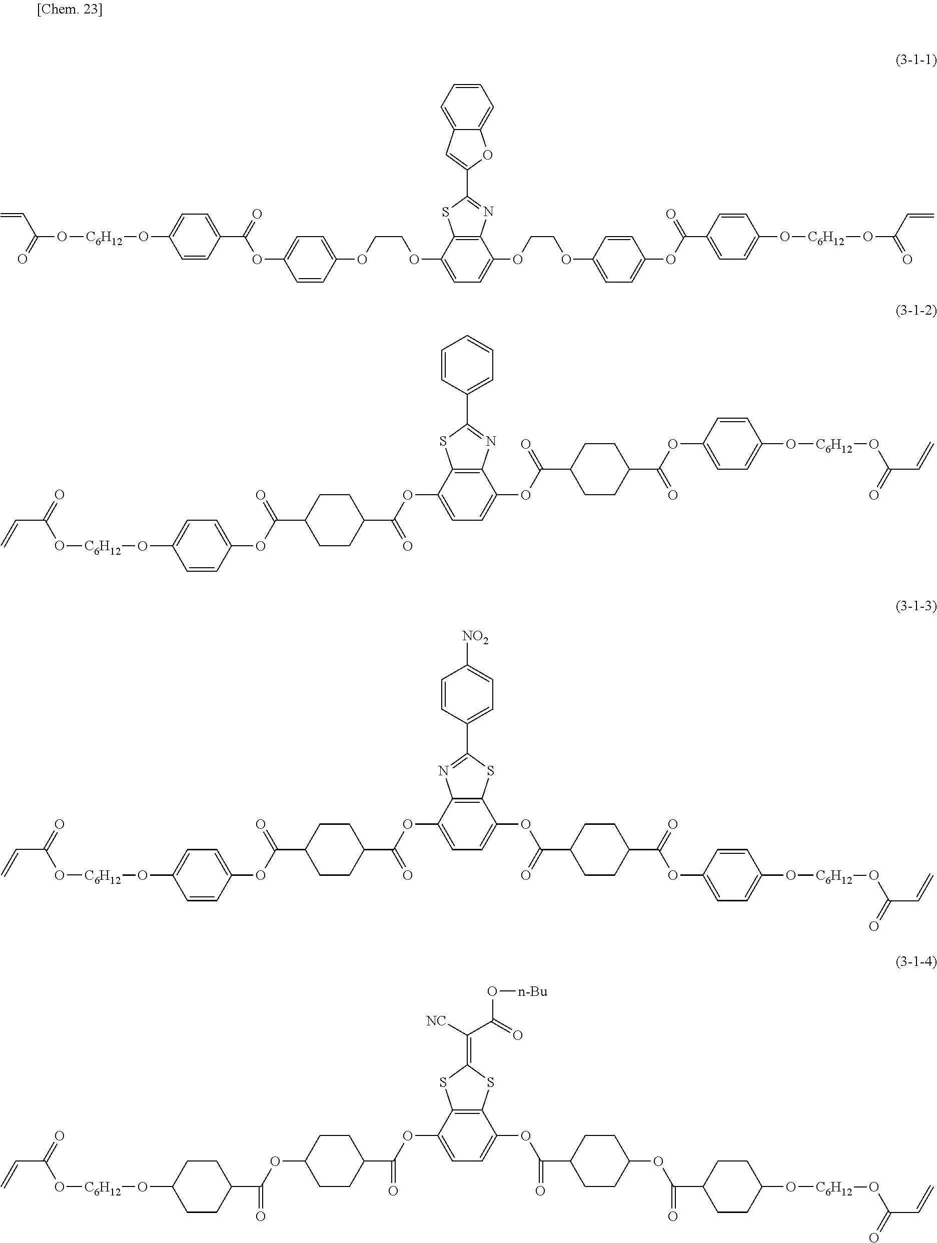

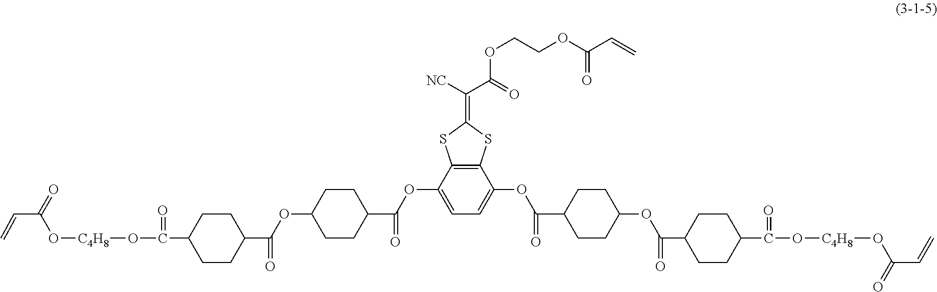

In addition, a compound represented by General Formula (3-2) other than the aforementioned compounds is exemplified.

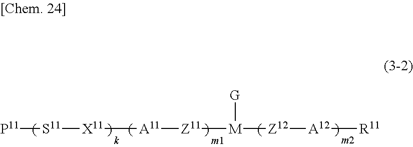

In the formula, P¹¹ represents a polymerizable group, S¹¹ represents a spacer group or a single bond, in the case where a plurality of S¹¹'s are present, they may be the same as or different from each other, X¹¹ represents —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, in the case where a plurality of X¹¹'s are present, they may be the same as or different from each other (however, P¹¹—(S¹¹—X¹¹)ₖ— does not include —O—O— bonding), A¹¹ and A¹² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, but these groups may be unsubstituted or substituted with one or more L's, in the case where a plurality of A¹¹'s and/or A¹²'s are present, they may be the same as or different from each other, Z¹¹ and Z¹² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, in the case where a plurality of Z¹¹'s and/or Z¹²'s are present, they may be the same as or different from each other, and M represents a group selected from the following Formula (M-1) to Formula (M-10).

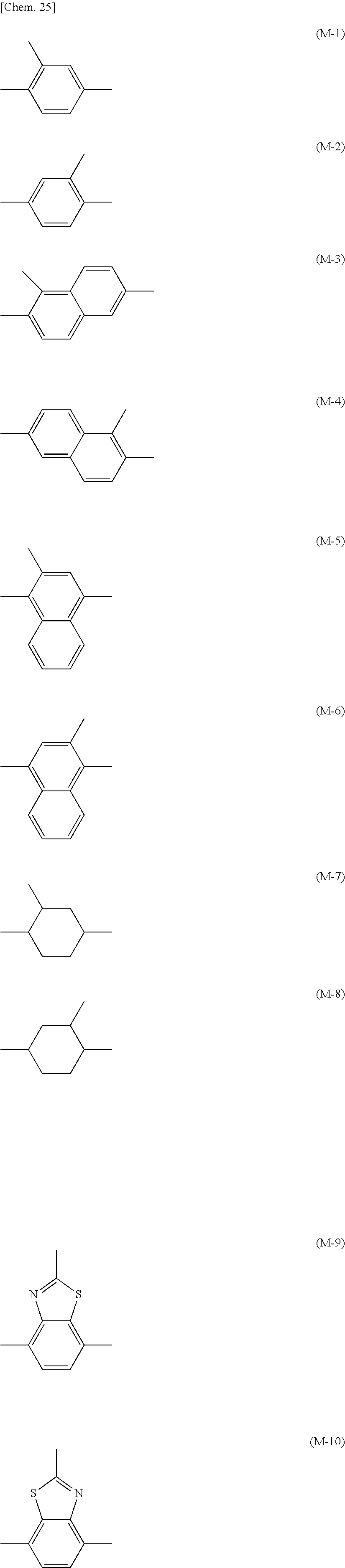

These groups may be unsubstituted or substituted with one or more L's, R¹¹ represents a hydrogen atom, a fluorine atom, a chlorine atom, a bromine atom, an iodine atom, a pentafluorosulfuranyl group, a cyano group, a nitro group, an isocyano group, a thioisocyano group, or a linear or branched alkyl group having 1 to 20 carbon atoms in which one —CH₂— or two or more —CH₂— not adjacent to each other each independently may be substituted with —O—, —S—, —CO—, —COO—, —OCO—, —CO—S—, —S—CO—, —O—CO—O—, —CO—NH—, —NH—CO—, or —C≡C—, and an arbitrary hydrogen atom in the alkyl group may be substituted with a fluorine atom,

G represents a group selected from the following Formula (G-1) or Formula (G-3):

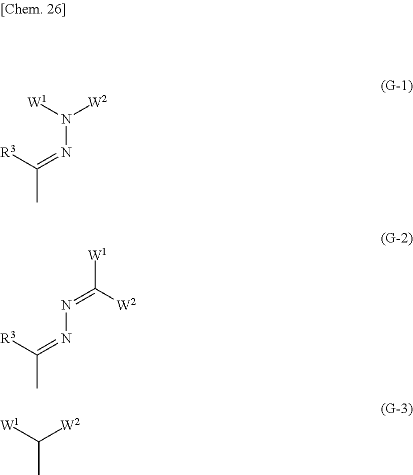

(In the formulas, R³ represents a hydrogen atom or a linear or branched alkyl group having 1 to 20 carbon atoms in which one —CH₂— or two or more —CH₂— not adjacent to each other each independently may be substituted with —O—, —S—, —CO—, —COO—, —OCO—, —CO—S—, —S—CO—, —O—CO—O—, —CO—NH—, —NH—CO—, or —C≡C—, and an arbitrary hydrogen atom in the alkyl group may be substituted with a fluorine atom, W¹ represents a group having 6 to 30 carbon atoms having at least one aromatic group, but the group may be unsubstituted or substituted with one or more L's, W² represents a hydrogen atom or a linear or branched alkyl group having 1 to 20 carbon atoms in which one —CH₂— or two or more —CH₂— not adjacent to each other each independently may be substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, and an arbitrary hydrogen atom in the alkyl group may be substituted with a fluorine atom, or W² may represent the same as W¹, or W¹ and W² together may form a ring structure),

an arbitrary hydrogen atom in the alkyl group may be substituted with a fluorine atom, k represents an integer of 0 to 8, m1 and m2 each independently represent an integer of 0 to 5, with the proviso that the total number of m1 and m2 is an integer of 1 to 5, and

L represents a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or an alkyl group having 1 to 20 carbon atoms, but the alkyl group may be linear or branched, an arbitrary hydrogen atom may be substituted with a fluorine atom, one —CH₂— or two or more —CH₂— not adjacent to each other in the alkyl group each independently may be substituted with a group selected from —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, but in the case where a plurality of L's are present in the compound, they may be the same as or different from each other.

In General Formula (3-2), P¹¹ preferably represents a group selected from the following Formula (P-1) to Formula (P-20).

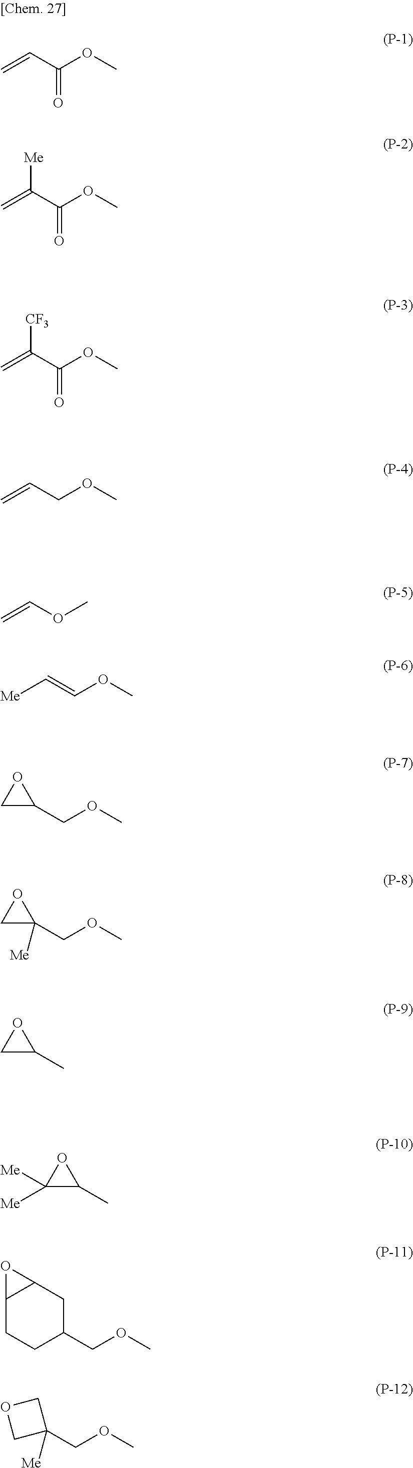

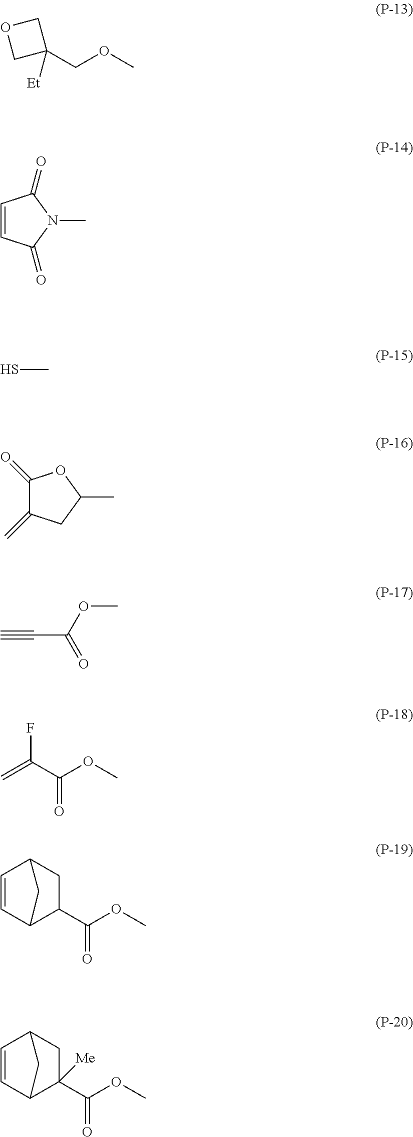

In addition, in General Formula (3-2), k represents 1, and S¹¹ preferably represents an alkylene group having 1 to 20 carbon atoms in which one —CH₂— or two or more —CH₂— not adjacent to each other each independently may be substituted with —O—, —COO—, —OCO—, —OCO—O—, —CO—NH—, —NH—CO—, —CH═CH—, or —C≡C—.

The total number of π electrons included in W¹ and W² is preferably 6 to 24.

The aromatic group included in W¹ preferably represents groups represented by the following Formula (W-1) to Formula (W-19).

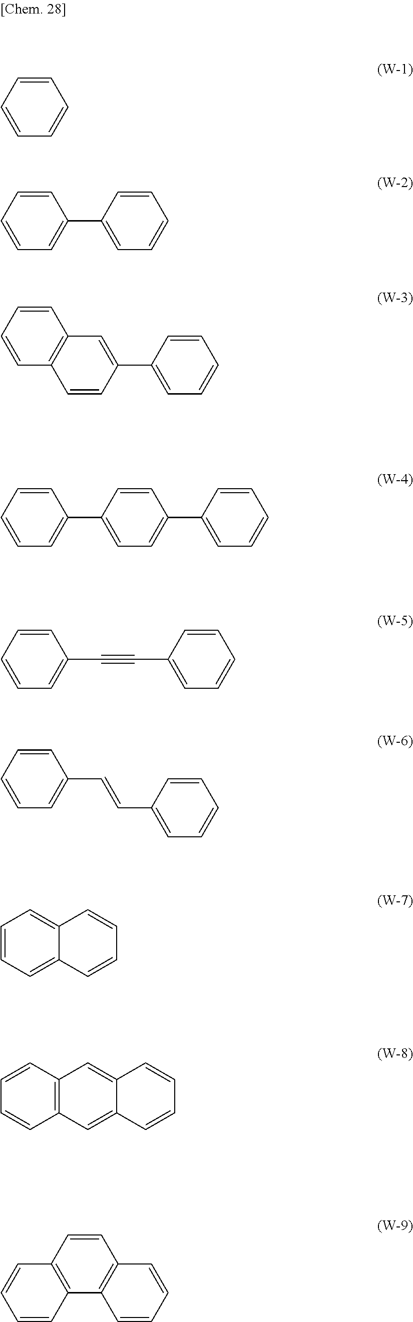

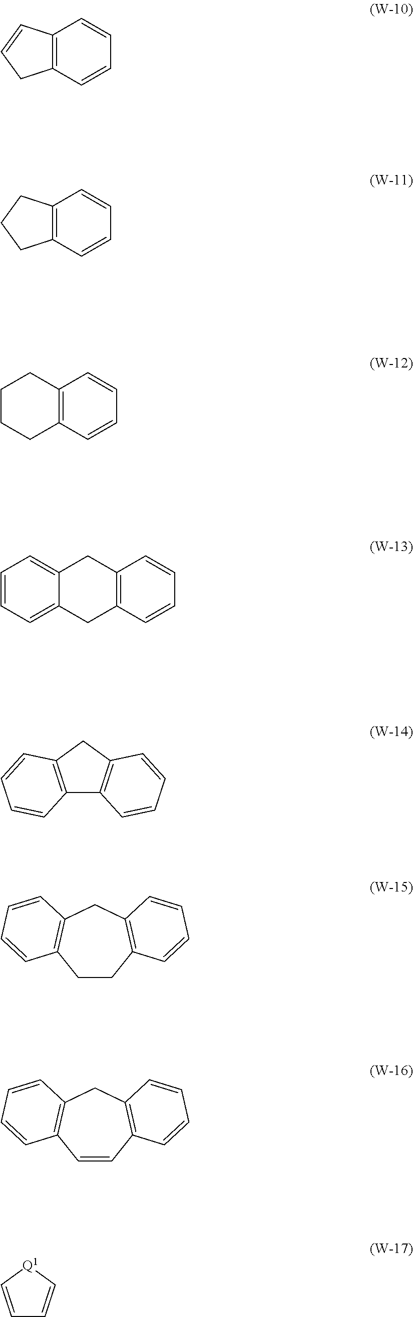

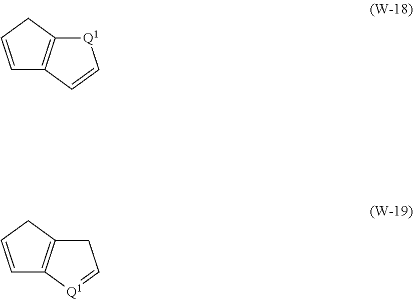

In the formulas, these groups may have a valence bond on an arbitrary position, and Q¹ represents —O—, —S—, —NR³— (where R³ represents a hydrogen atom or an alkyl group having 1 to 8 carbon atoms), or —CO—. —CH═ in these aromatic groups each independently may be substituted with —N═, —CH₂— each independently may be substituted with —O—, —S—, —NR⁴— (where R⁴ represents a hydrogen atom or an alkyl group having 1 to 8 carbon atoms), or —CO—, without forming a —O—O— bonding. Also, these aromatic groups may be unsubstituted or substituted with one or more L's, and may form a group in which two or more aromatic groups selected from these groups are linked by a single bond.

Exemplary compounds represented by General Formula (3-2) are shown below, but the exemplary compounds are not limited to these.

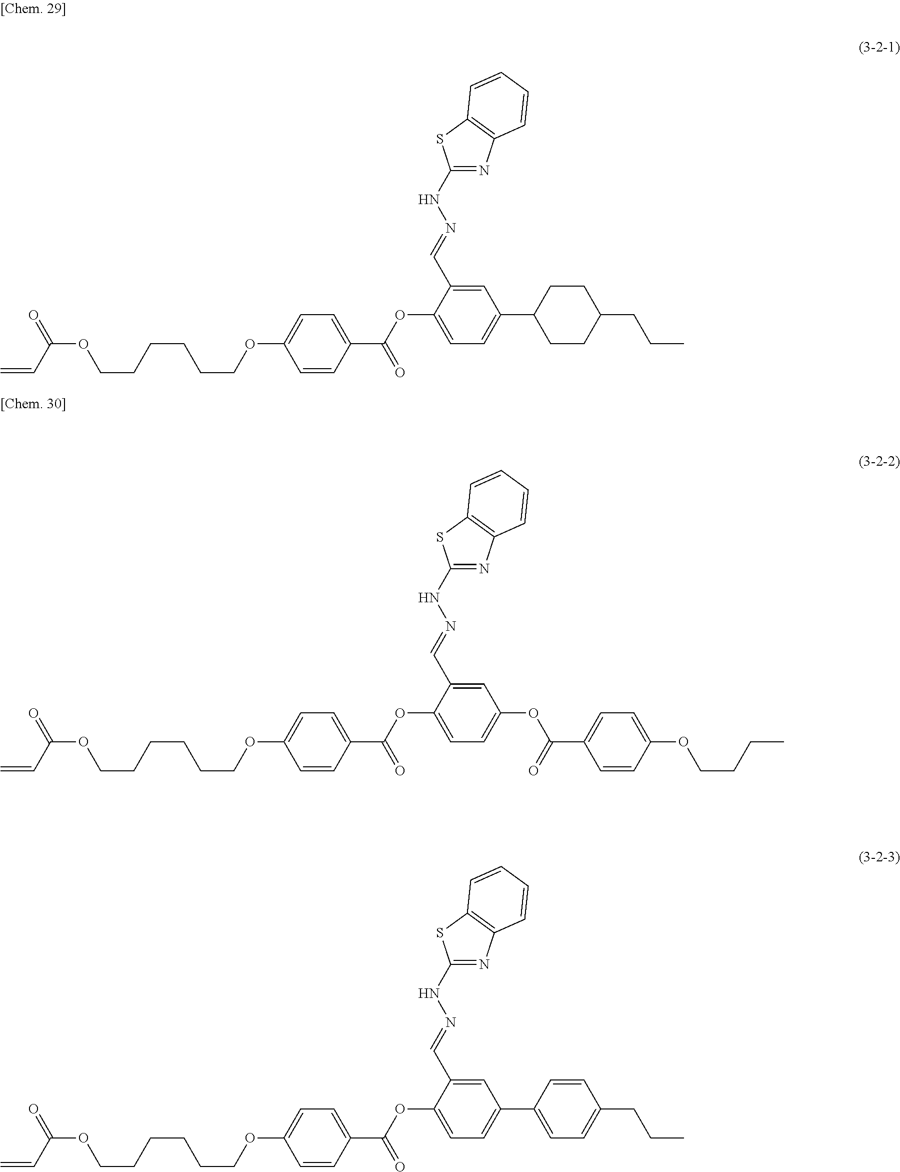

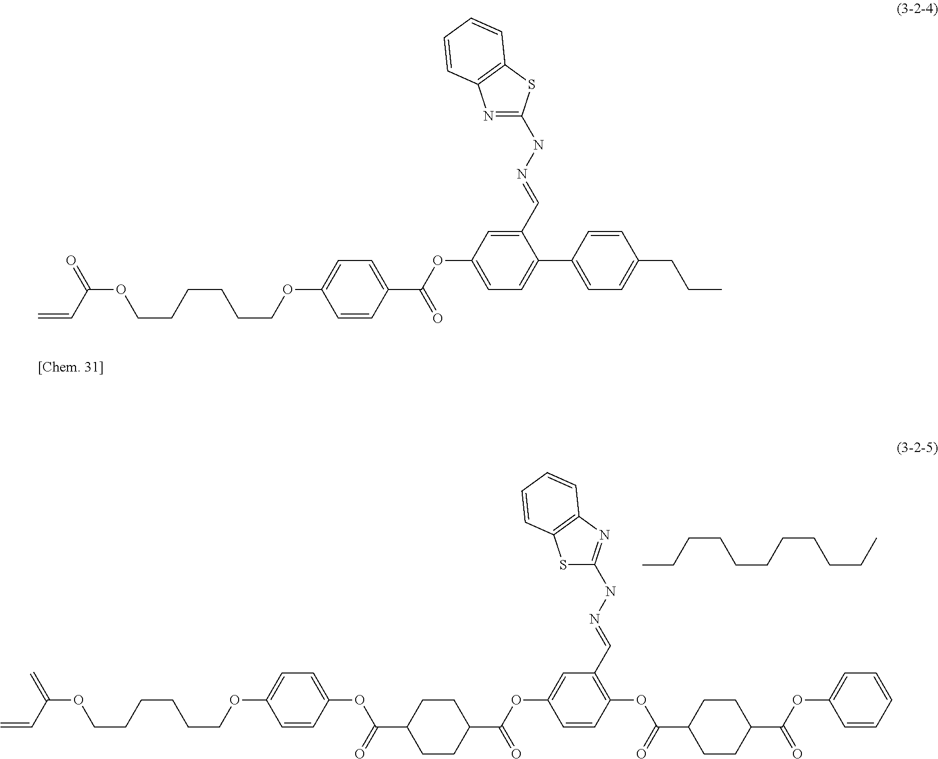

In addition, in the same manner, a compound represented by General Formula (3-3) is exemplified.

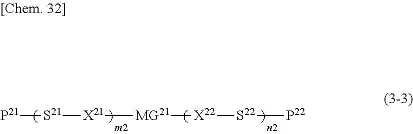

In the formula, P²¹ and P²² each independently represent a polymerizable group,

S²¹ and S²² each independently represent a spacer group or a single bond, but in the case where a plurality of S²¹'s and S²²'s are present, each of them may be the same as or different from each other, X²¹ and X²² each independently represent —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, but in the case where a plurality of X²¹'s and X²²'s are present, each of them may be the same as or different from each other (however, —O—O— is not included in each P—(S—X)— bonding),

MG²¹ represents a mesogenic group, and

m2 and n2 each independently represent an integer of 0 to 5.

The mesogenic group MG²¹ is preferably a group represented by Formula (8-a).

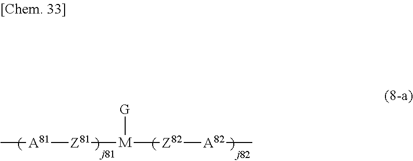

In the formula, A⁸² and A⁸² each independently represent a 1,4-phenylene group, a 1,4-cyclohexylene group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, but these groups may be unsubstituted or substituted with one or more L's, in the case where a plurality of A⁸¹'s and/or A⁸²'s are present, each of them may be the same as or different from each other,

Z⁸¹ and Z⁸² each independently represent —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, but in the case where a plurality of Z⁸¹'s and/or Z⁸²'s are present, each of them may be the same as or different from each other, and

M represents groups selected from the following Formula (M-1) to Formula (M-8).

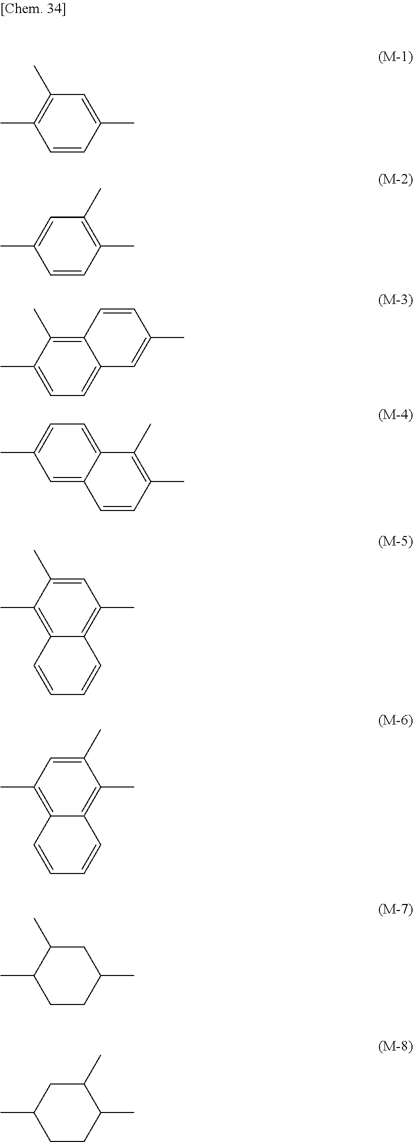

These groups may be unsubstituted or substituted with one or more L's,

G represents a group selected from the following Formula (G-1) or Formula (G-2):

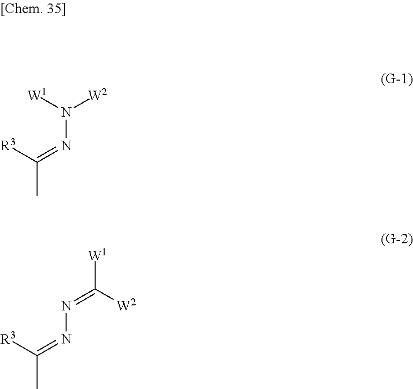

(In the formulas, R³ represents a hydrogen atom or an alkyl group having 1 to 20 carbon atoms, the alkyl group may be linear or branched, an arbitrary hydrogen atom in the alkyl group may be substituted with a fluorine atom, one —CH₂— or two or more —CH₂— not adjacent to each other in the alkyl group each independently may be substituted with —O—, —S—, —CO—, —COO—, —OCO—, —CO—S—, —S—CO—, —O—CO—O—, —CO—NH—, —NH—CO—, or —C≡C—, W¹ represents a group having 2 to 30 carbon atoms having at least one aromatic group, but the group may be unsubstituted or substituted with one or more L's, W² represents a hydrogen atom or an alkyl group having 1 to 20 carbon atoms, but the alkyl group may be linear or branched, an arbitrary hydrogen atom in the alkyl group may be substituted with a fluorine atom, one —CH₂— or two or more —CH₂— not adjacent to each other in the alkyl group each independently may be substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, or W² and W¹ may represent the same, or W¹ and W² may be linked to each other to form the same ring structure),

L represents a fluorine atom, a chlorine atom, a bromine atom, an iodine atom, a pentafluorosulfuranyl group, a nitro group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or an alkyl group having 1 to 20 carbon atoms, but the alkyl group may be linear or branched, an arbitrary hydrogen atom may be substituted with a fluorine atom, one —CH₂— or two or more —CH₂— not adjacent to each other in the alkyl group each independently may be substituted with a group selected from —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, in the case where a plurality of L's are present in the compound, they may be the same as or different from each other, and

j81 and j82 each independently represent an integer of 0 to 5, with the proviso that the total number of j81 and j82 is an integer of 1 to 5.

### General Formulas (P-1) to (P-20):

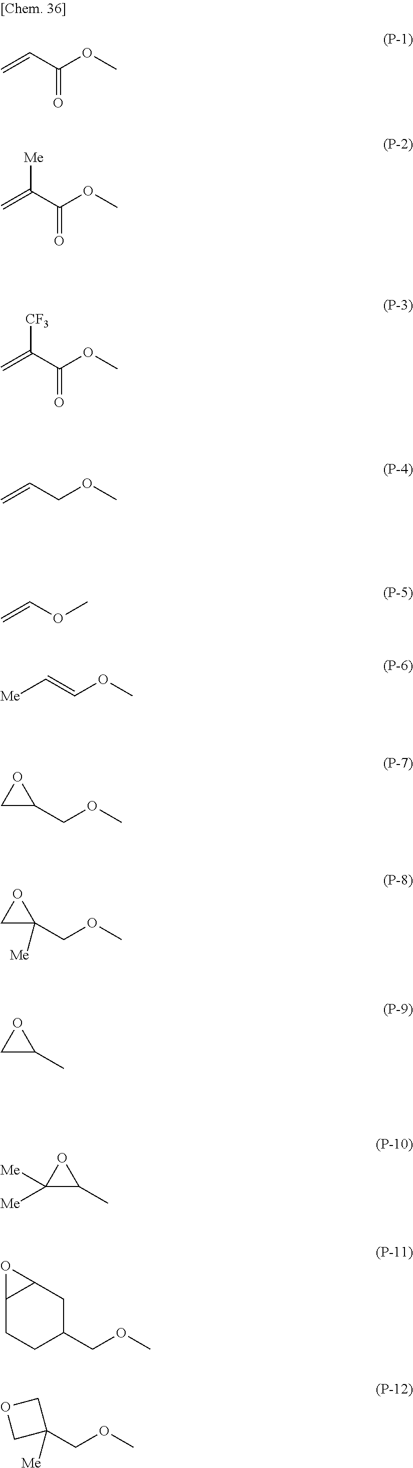

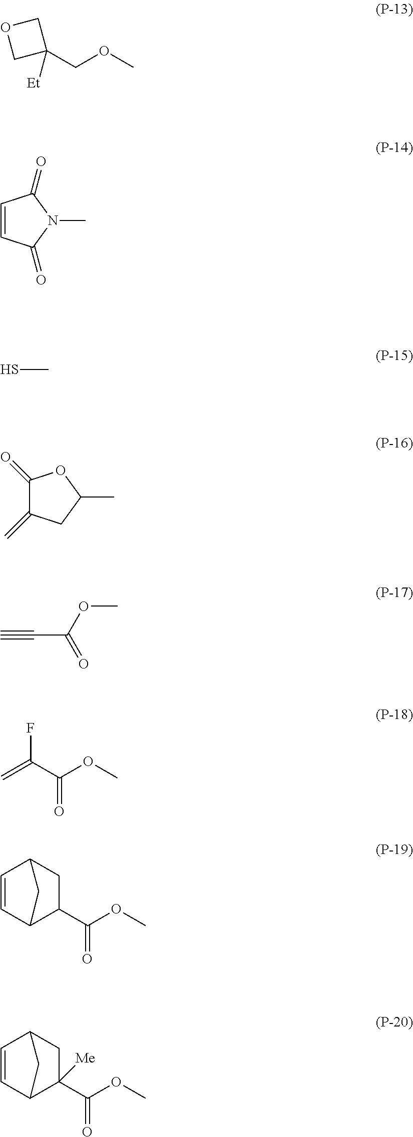

The polymerizable groups P²¹ and P²² each independently represent a group selected from the above General Formulas (P-1) to (P-20).

Exemplary compounds represented by General Formula (3-3) are shown below, but the exemplary compounds are not limited to these.

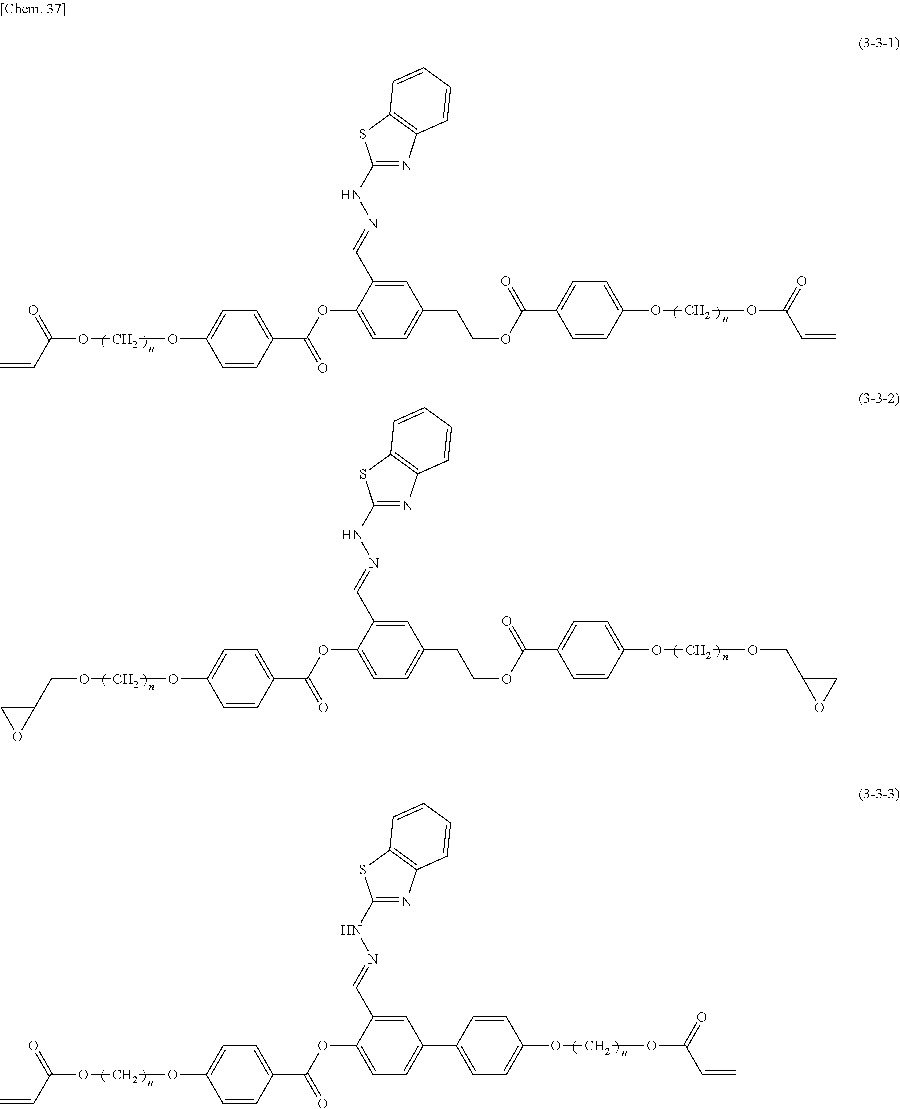

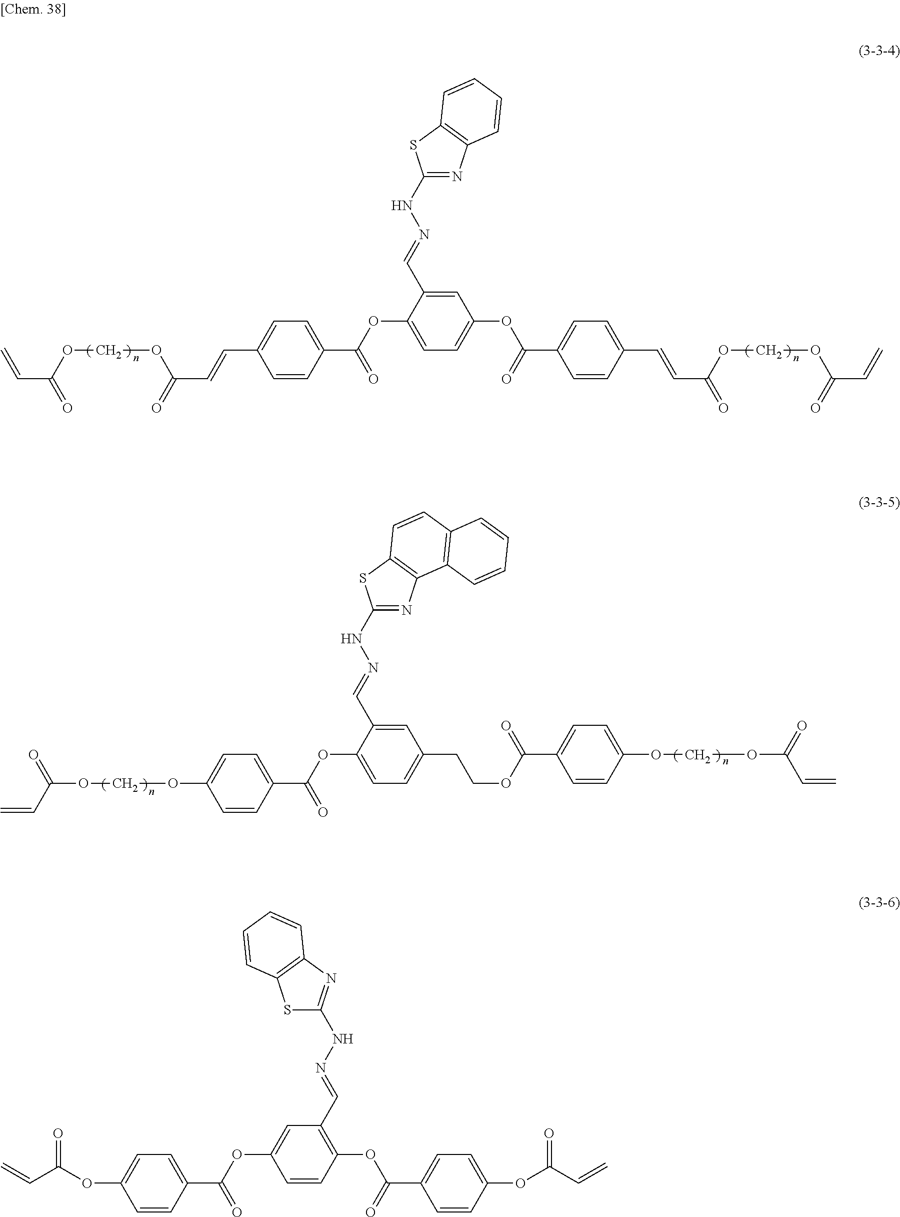

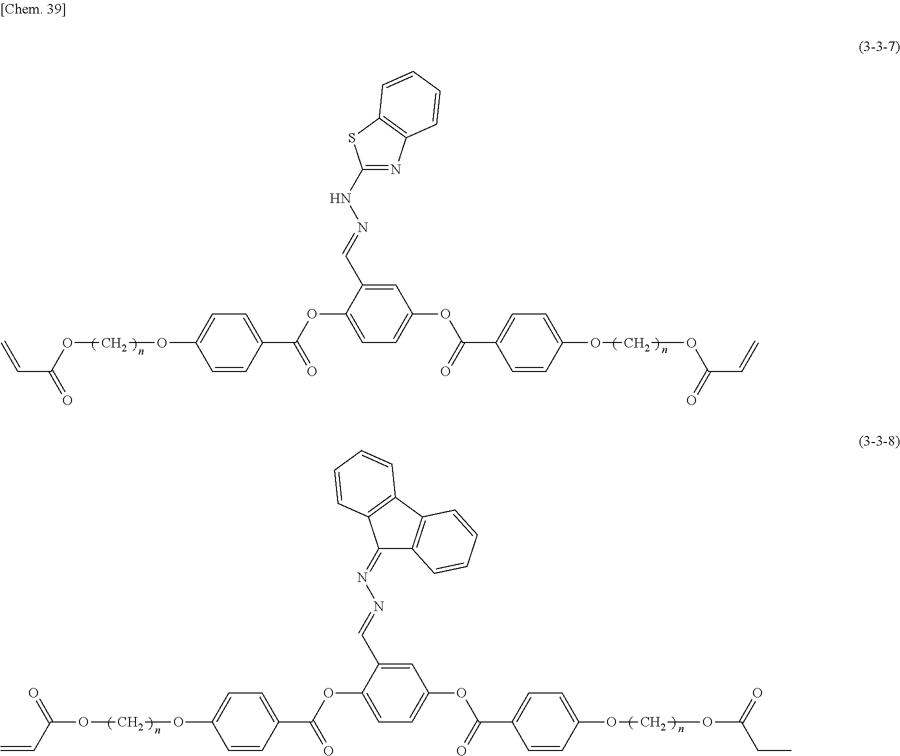

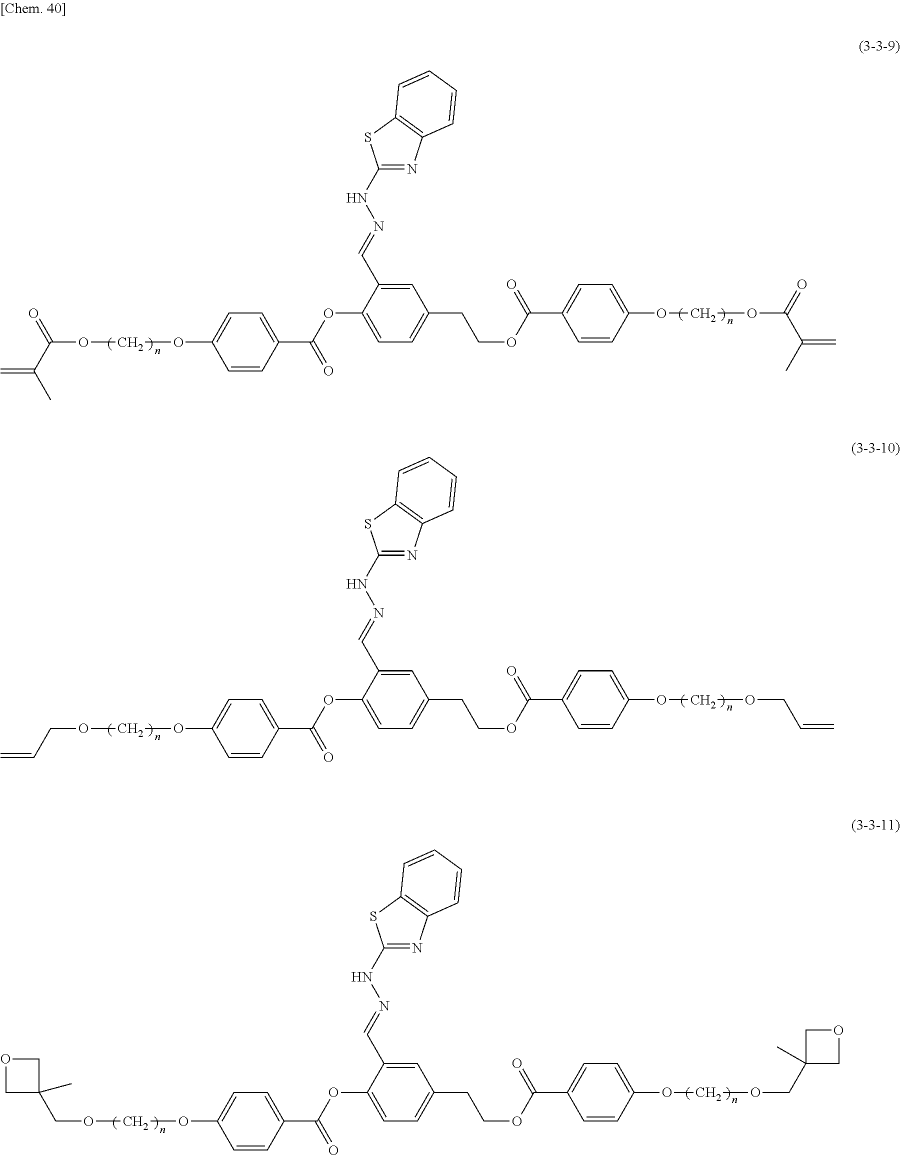

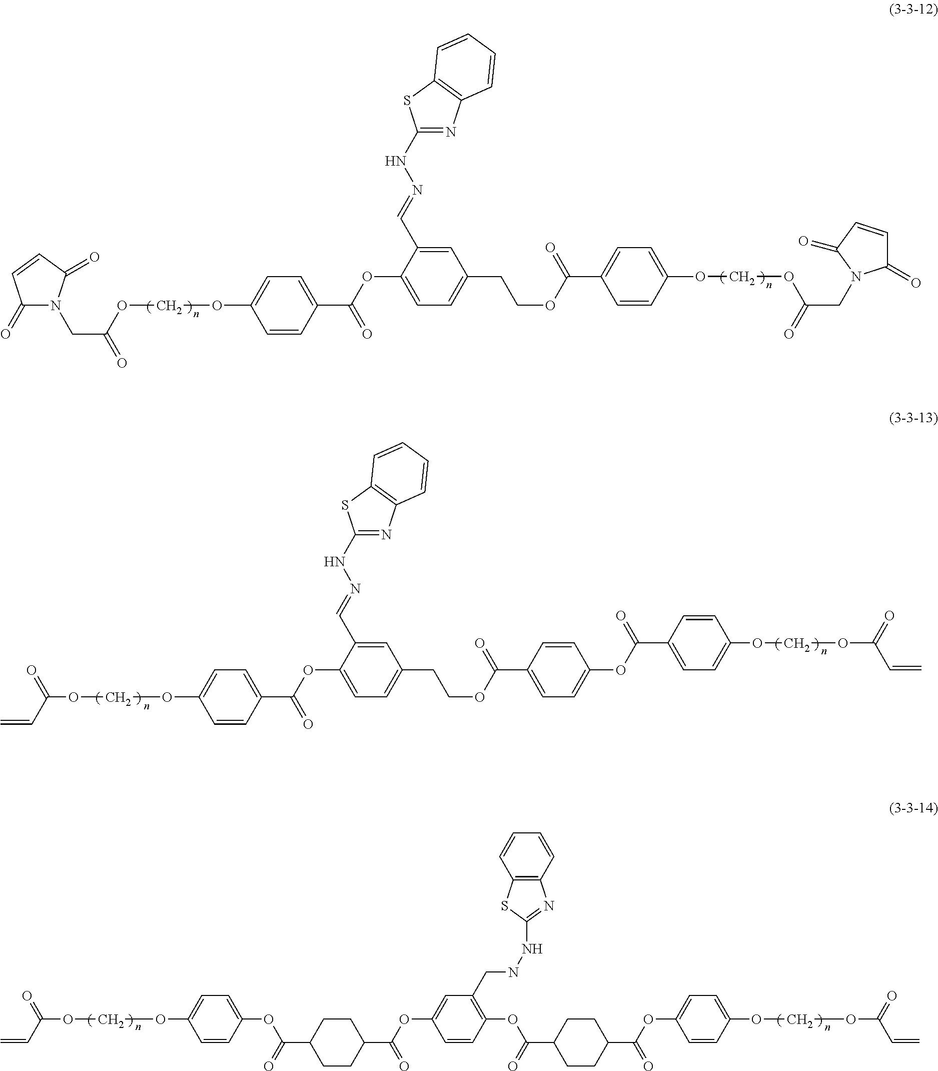

These liquid crystal compounds may be used alone or two or more thereof may be used in combination. In addition, monofunctional compounds represented by General Formula (1-1) and General Formula (1-2) and having one polymerizable functional group in a molecule, a bifunctional compound represented by General Formula (2-1) and having two polymerizable functional groups in a molecule, polyfunctional compounds represented by General Formula (4-1) to General Formula (4-7) shown below and having three or more polymerizable functional groups in a molecule can be used in combination.

As the liquid crystal compound having two polymerizable functional groups, those having three polymerizable functional groups are also preferred. Examples thereof include those represented by any one of General Formulas (4-1) to (4-18), but are not limited to those represented by any one of the following general formulas.

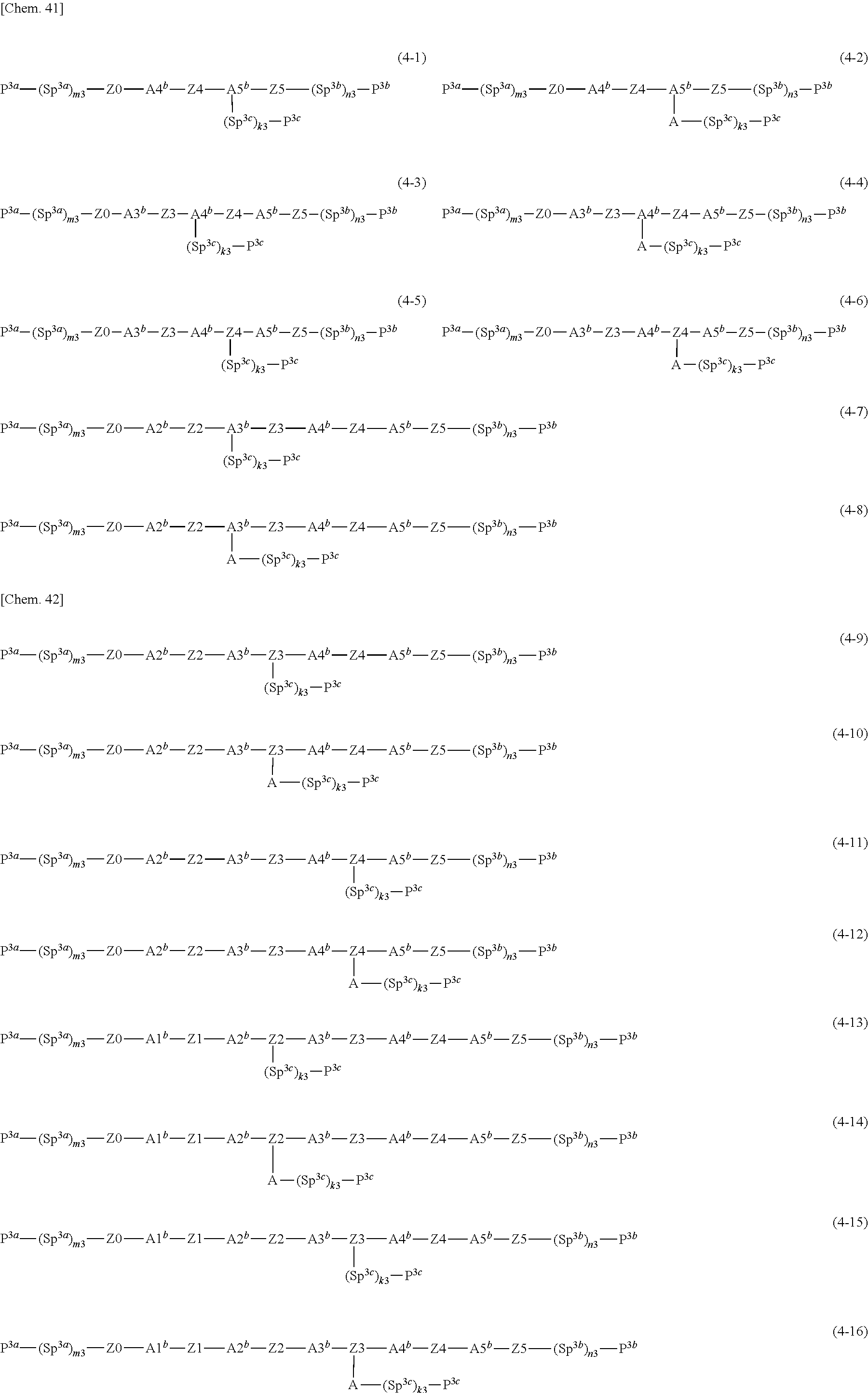

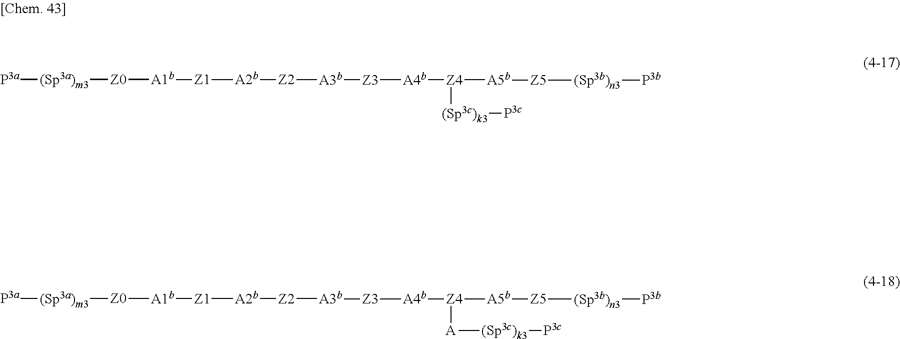

In the formulas, A1^{b}, A2^{b}, A3^{b}, A4^{b}, and A5^{b} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and

A1^{b}, A2^{b}, A3^{b}, A4^{b}, and A5^{b} may have, as substituents, one or more F, Cl, CF₃, OCF₃, and CN groups, an alkyl group, an alkoxy group, an alkanoyl group, or an alkanoyloxy group having 1 to 8 carbon atoms, an alkenyl group, an alkenyloxy group, an alkenoyl group, or an alkenoyloxy group having 2 to 8 carbon atoms.

In addition, Z0, Z1, Z2, Z3, Z4, and Z5 each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms which may have a halogen atom, or a single bond, and P^{3a}, P^{3b}, and P^{3c} each independently represent a polymerizable functional group, and Sp^{3a}, Sp^{3b}, and Sp^{3c} each independently represent an alkylene group having 0 to 18 carbon atoms (the alkylene group may be substituted by one or more of a halogen atom or CN, one of the CH₂ groups or two or more of the CH₂ groups which are not adjacent to each other present in the group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and A represents —O—, —COO—, —OCO—, —OCH₂—, —CH₂O—, —CH₂CH₂OCO—, —COOCH₂CH₂—, —OCOCH₂CH₂—, or a single bond. m3, n3, and k3 each independently represent 0 or 1.

Specific examples of the polymerizable liquid crystal compound having three polymerizable functional groups include compounds of Formulas (4-19) to (4-27), but the compound is not limited to the following compounds.

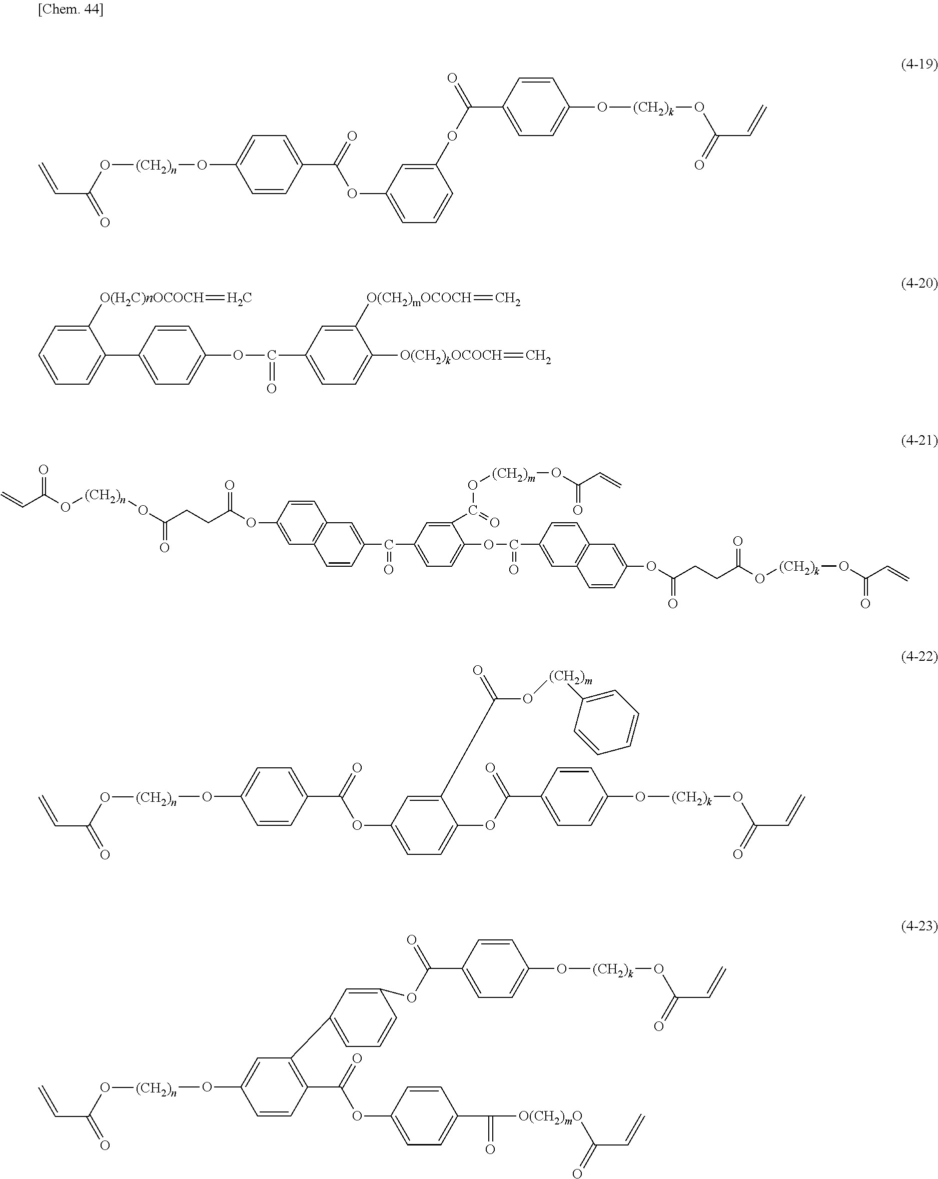

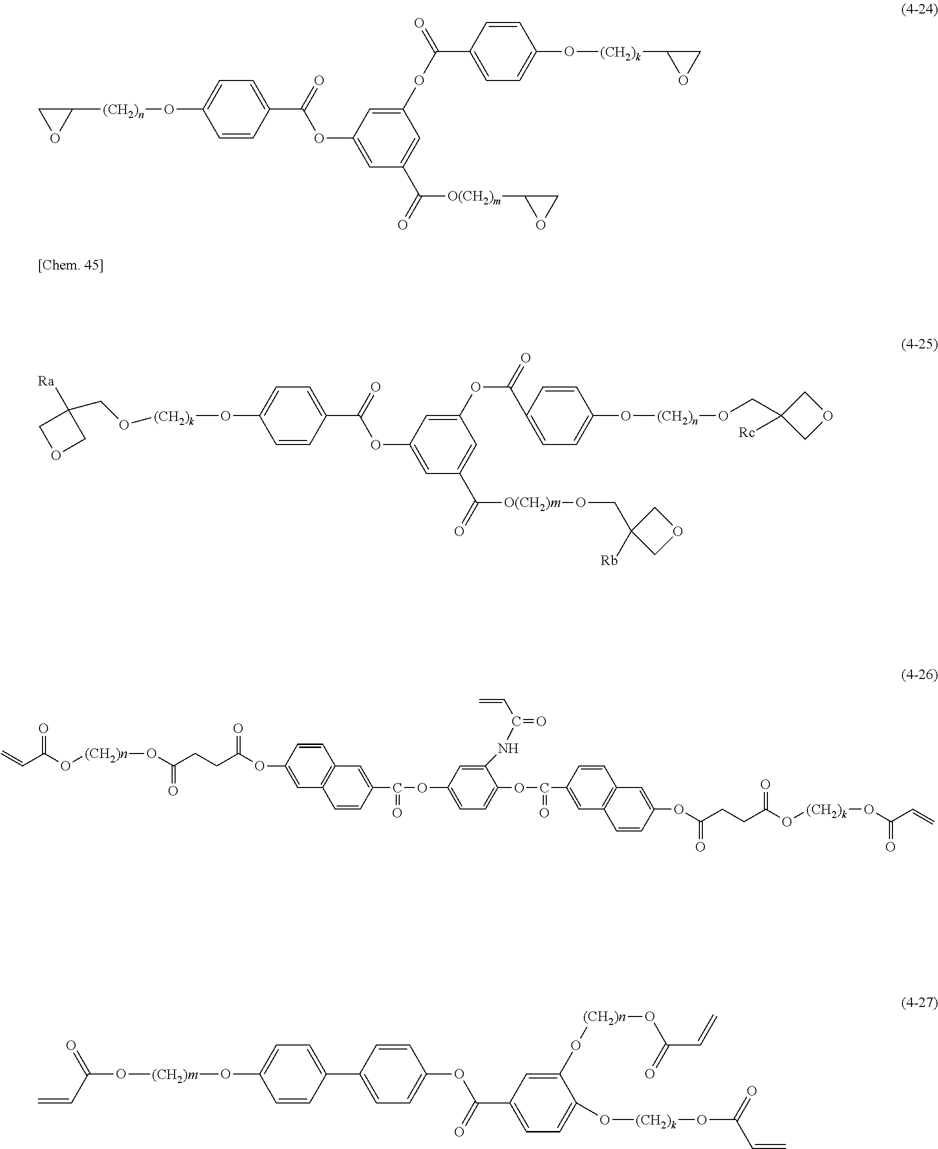

In the formulas, j, k, m and n each independently represent an integer of 0 to 18, but if oxygen atoms are directly bonded to each other in a case where j, k, m or n represents 0, one of the oxygen atoms is removed. Ra to Rc each independently represent a hydrogen atom, a halogen atom, an alkyl group having 1 to 6 carbon atoms, an alkoxy group having 1 to 6 carbon atoms, or a cyano group, and in a case where these groups are an alkyl group having 1 to 6 carbon atoms, or an alkoxy group having 1 to 6 carbon atoms, all of the groups may be unsubstituted, or may be substituted by one or more of halogen atoms.

One or more liquid crystal compounds having three polymerizable functional groups may be used, but one to four liquid crystal compounds may be preferably used, and one to three liquid crystal compounds may be more preferably used.

The content of the liquid crystal compound having three polymerizable functional groups is preferably 0% to 80% by mass, more preferably 0% to 70% by mass, and particularly preferably 0% to 60% by mass in the polymerizable liquid crystal composition. In a case of emphasizing rigidity of the optical anisotropic body, the lower limit value is preferably set to be 10% by mass or higher, more preferably 20% by mass or higher, and particularly preferably 30% by mass or higher, and, on the other hand, in a case of emphasizing low curing shrinkage, the upper limit value is preferably set to be 80% by mass or lower, more preferably 70% by mass or lower, and particularly preferably 60% by mass or lower.

The polymerizable liquid crystal composition of the present invention may contain a liquid crystal compound having one polymerizable functional group.

Specifically, the liquid crystal compound having one polymerizable functional group is preferably a compound represented by the following Formula (5).

[Chem. 46]

P⁴-(Sp⁴)ₘ₄-MG2-R⁴ (5)

In the formula, P⁴ represents a polymerizable functional group, Sp⁴ represents an alkylene group having to 18 carbon atoms (the alkylene group may be substituted by one or more halogen atoms or CN, one of the CH₂ groups or two or more of the CH₂ groups which are not adjacent to each other present in the alkylene group may be independently substituted by —O—, —S—, —NH—, —N(CH₃)—, —CO—, —COO—, —OCO—, —OCOO—, —SCO—, —COS—, or —CC— as long as an oxygen atom is not directly bonded to another oxygen atom), m4 represents 0 or 1, MG2 represents a mesogenic group or a mesogenic supporting group, R⁴ represents a hydrogen atom, a halogen atom, a cyano group, or an alkyl group having 1 to 18 carbon atoms, the alkyl group may be substituted by one or more of a halogen atom or CN, and one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom.

P⁴ preferably represents a substituent selected from polymerizable groups represented by the following Formulas (P-1) to (P-20).

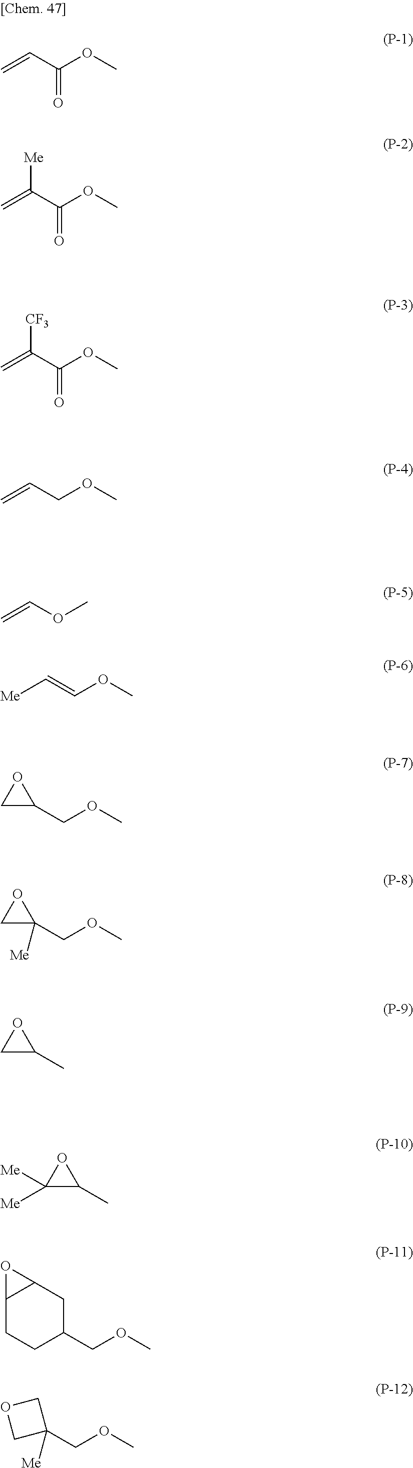

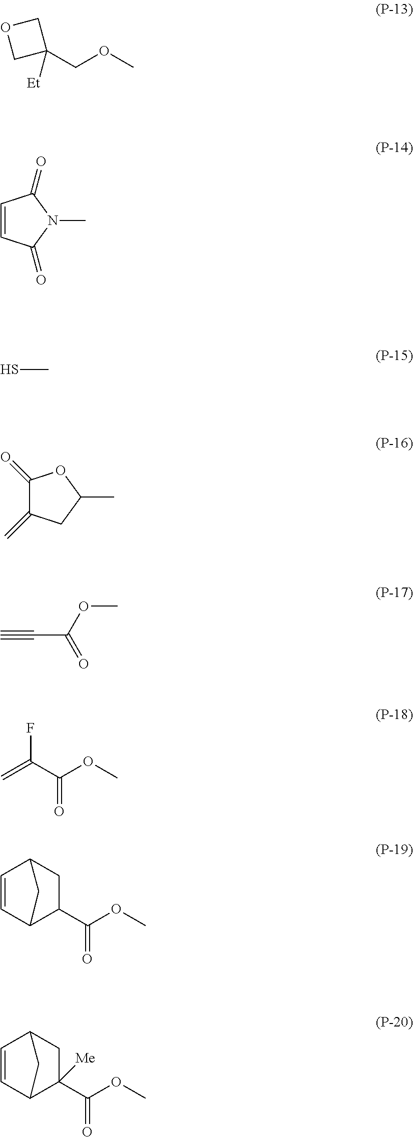

Among these polymerizable functional groups, Formula (P-1), Formula (P-2), (P-7), (P-12), or (P-13) is preferable, and Formula (P-1), Formula (P-2), (P-7), or (P-12) is more preferable, from the viewpoint of enhancing polymerizable properties and storage stability.

As the mesogenic group or the mesogenic supporting group represented by MG2, groups represented by Formula (5-b) are exemplified.

[Chem. 48]

—Z0^{c}-(A1^{c}-Z1^{c})_{pc}-(A2^{c}-Z2^{c})_{qc}-(A3^{c}-Z3^{c})_{rc}-A4^{c}-Z4^{c}-A5^{c}-Z5^{c}- (5-b)

In Formula (4-b), A1^{c}, A2^{c}, A3^{c}, A4^{c} and A5^{c} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and may have, as substituents, one or more F, Cl, CF₃, OCF₃, and CN groups, an alkyl group having 1 to 8 carbon atoms, an alkoxy group having 1 to 8 carbon atoms, an alkanoyl group having 1 to 8 carbon atoms, an alkanoyloxy group having 1 to 8 carbon atoms, an alkoxycarbonyl group having 1 to 8 carbon atoms, an alkenyl group having 2 to 8 carbon atoms, Z0^{c}, Z1^{c}, Z2^{c}, Z3^{c}, Z4^{c} and Z5^{c} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, and pc, qc and rc each independently represent 0 or 1, and satisfy 0≦pc+qc+rc≦3.

As an example of Formula (5), Formulas (5-1) to (5-4) may be exemplified, but Formula (5) is not limited to the following Formulas.

[Chem. 49]

P^{4a}-(Sp^{4a})ₘ₄-Z0^{c}-A4^{c}-Z4^{c}-A5^{c}-Z5^{c}-(Sp^{4b})ₙ₄-R⁴ (5-1)

P^{4a}-(Sp^{4a})ₘ₄-Z0^{c}-A2^{c}-Z2^{c}-A3^{c}-Z3^{c}-A4^{c}-Z4^{c}-A5^{c}-Z5^{c}-(Sp^{4b})ₙ₄-R⁴ (5-2)

P^{4a}-(Sp^{4a})ₘ₄-Z0^{c}-A1^{c}-Z1^{c}-A2^{c}-Z2^{c}-A3^{c}-Z3^{c}-A4^{c}-Z4^{c}-A5^{c}-Z5^{c}-(Sp^{4b})ₙ₄-R⁴ (5-4)

In the formulas, A1^{c}, A2^{c}, A3^{c}, A4^{c}, and A5^{c} represent the same meaning as A1^{c}, A2^{c}, A3^{c}, A4^{c}, and A5^{c} in Formula (4-b). In addition, Z0^{c}, Z1^{c}, Z2^{c}, Z3^{c}, Z4^{c}, and Z5^{c} represent the same meaning as Z0^{c}, Z1^{c}, Z2^{c}, Z3^{c}, Z4^{c}, and Z5^{c} in Formula (4-b). Further, R⁴ represents the same meaning as R⁴ in Formula (4).

P^{4a} each independently represents a polymerizable functional group, Sp^{4a} and Sp^{4b} each independently represent an alkylene group having 0 to 18 carbon atoms (the alkylene group may be substituted by one or more of a halogen atom or CN, one of the CH₂ groups or two or more of the CH₂ groups which are not adjacent to each other present in the group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom), and m4 and n4 each independently represent 0 or 1.

As the compound represented by Formula (5), compounds represented by the following Formulas (5-5) to (5-43) are exemplified, but the compound is not limited thereto.

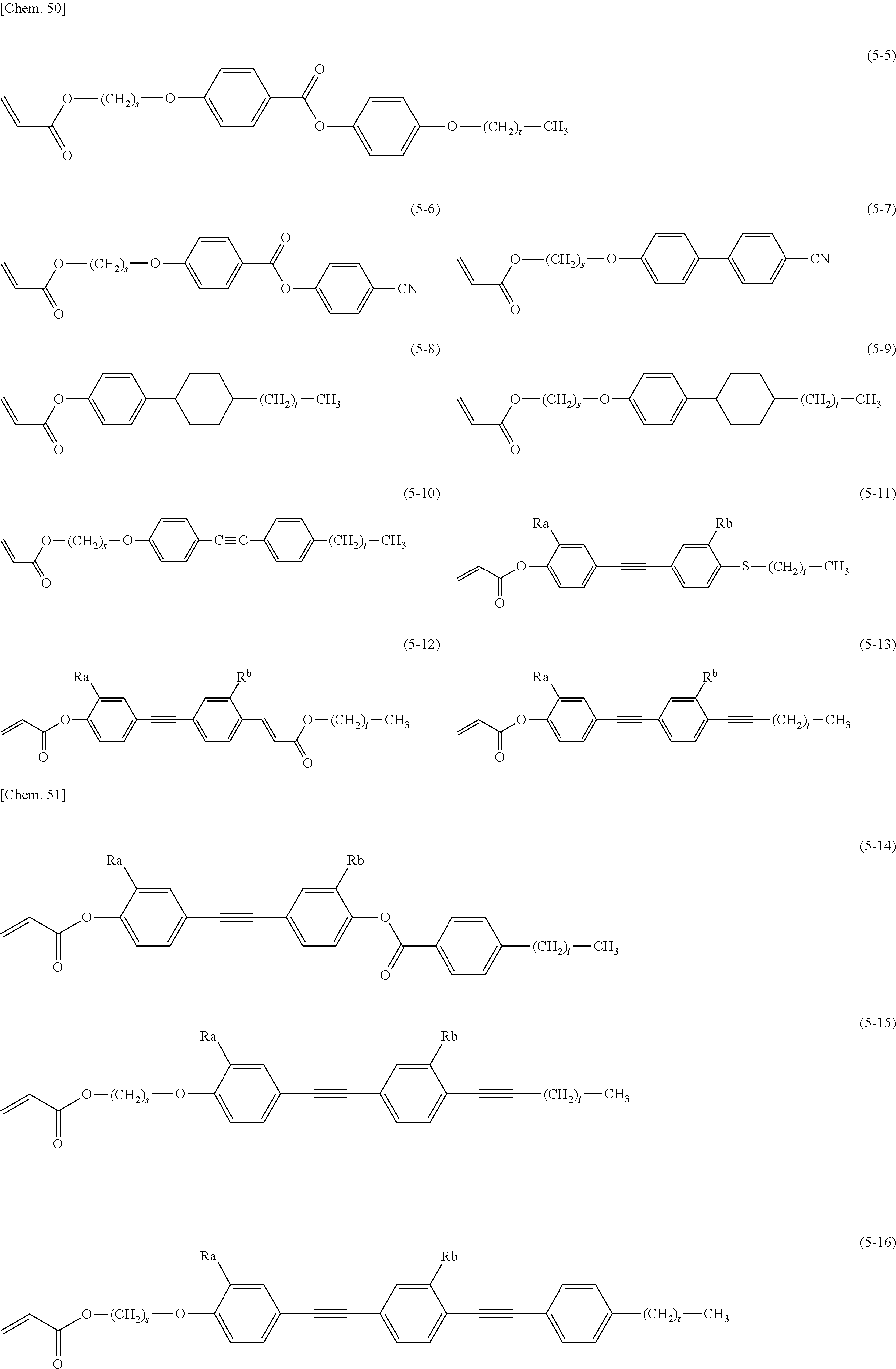

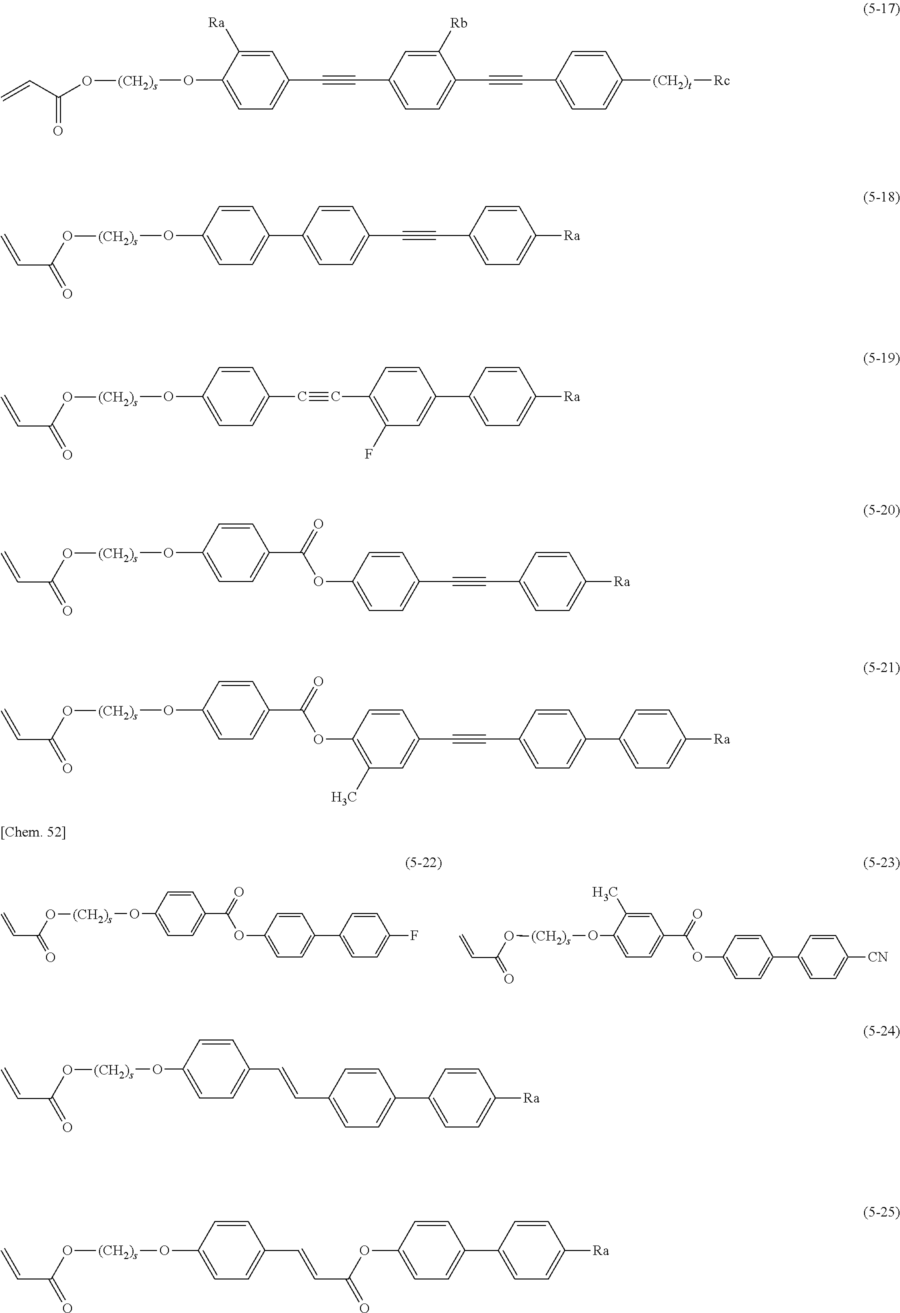

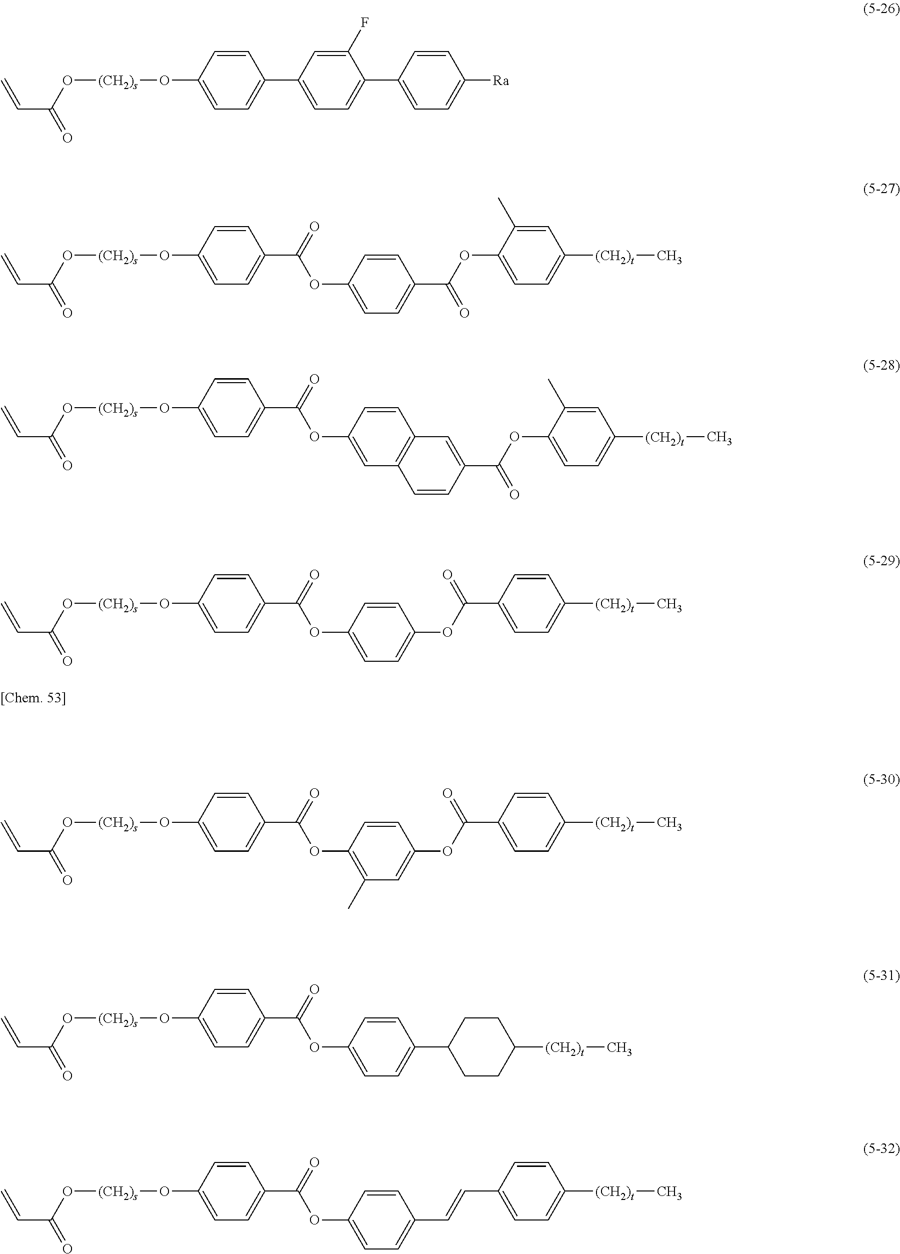

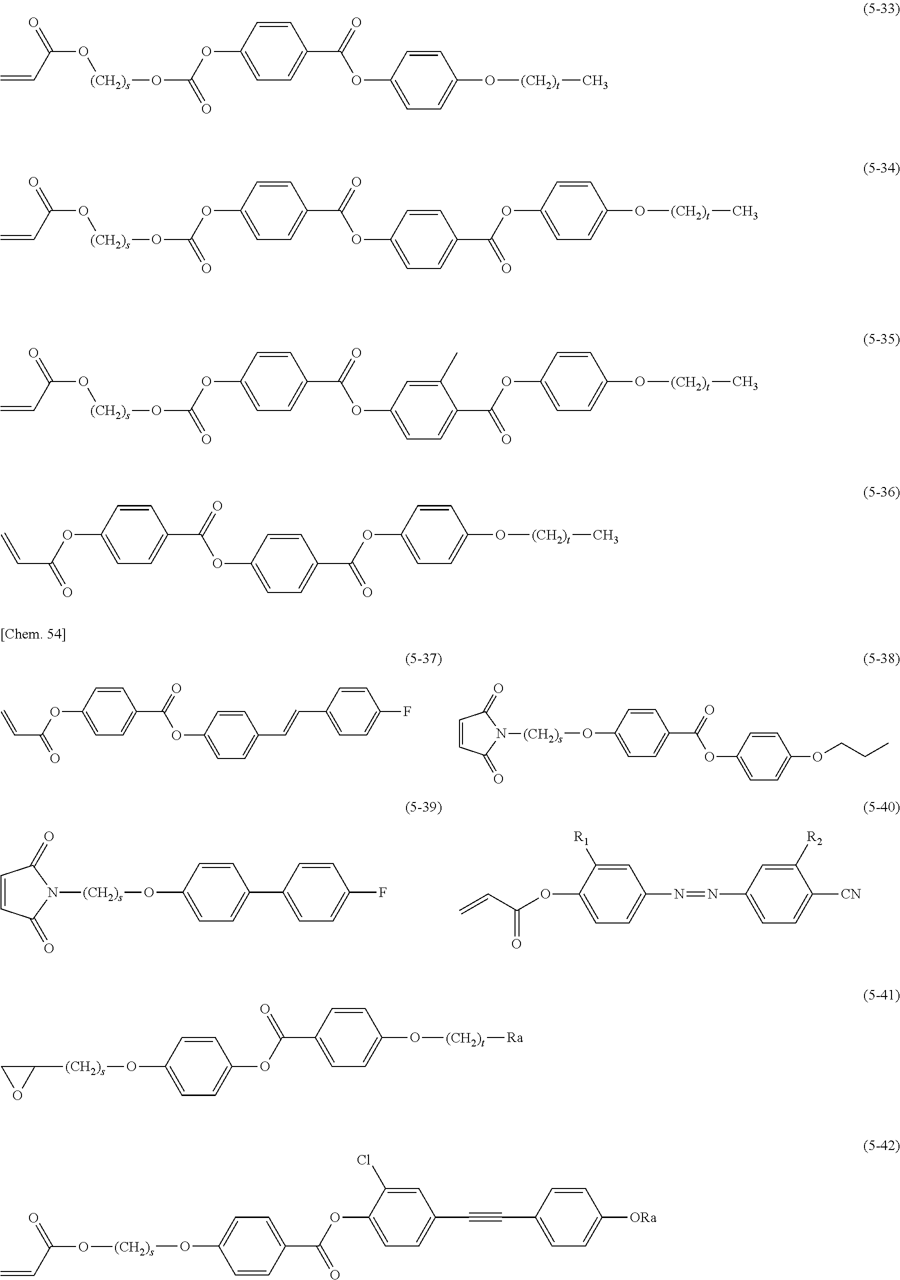

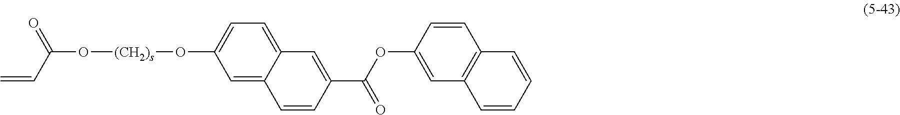

In the formulas, s and t represent an integer of 0 to 18, but if oxygen atoms are directly bonded to each other in a case where s or t represents 0, one of the oxygen atoms is removed. Ra, Rb, and Rc each independently represent a hydrogen atom, an alkyl group having 1 to 6 carbon atoms, an alkoxy group having 1 to 6 carbon atoms, a carboxyl group, or a cyano group, and in a case where these groups are an alkyl group having 1 to 6 carbon atoms, or an alkoxy group having 1 to 6 carbon atoms, all of the groups may be unsubstituted, or may be substituted by one or more of halogen atoms.

One or more liquid crystal compounds having one polymerizable functional group may be used, but one to five liquid crystal compounds may be preferably used, and one to four liquid crystal compounds may be more preferably used. The content of the liquid crystal compound having one polymerizable functional group is preferably 0% to 80% by mass, more preferably 10% to 80% by mass, and particularly preferably 20% to 80% by mass in the polymerizable liquid crystal composition. In a case of emphasizing alignment properties of the optical anisotropic body, the lower limit value is preferably set to be 10% by mass or higher and more preferably 20% by mass or higher, and, in a case of emphasizing rigidity, the upper limit value is preferably set to be 80% by mass or lower and more preferably 70% by mass or lower.

In addition, compounds containing a mesogenic group which does not have a polymerizable group may be added to the liquid crystal composition of the present invention, and compounds that are used in general liquid crystal device, for example, Super•Twisted•Nnematic (STN) liquid crystal, Twisted•Nematic (TN) liquid crystal, Thin Film Transistor (TFT) liquid crystal, and the like may be exemplified.

Specifically, the compound containing a mesogenic group which does not have a polymerizable functional group is preferably a compound represented by the following Formula (6).

[Chem. 55]

R⁵¹-MG3-R⁵¹ (6)

As the mesogenic group or the mesogenic supporting group represented by MG3, compounds represented by Formula (6-b) may be exemplified.

[Chem. 56]

—Z0^{d}-(A1^{d}-Z1^{d})ₙₑ-A2^{d}-Z2^{d}-A3^{d}-Z3^{d}- (6-b)

In the formula, A1^{d}, A2^{d}, and A3^{d} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group, 1,2,3, 4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, and may have, as substituent, one or more F, Cl, CF₃, OCF₃, and CN groups, an alkyl group having 1 to 8 carbon atoms, an alkoxy group, an alkanoyl group, an alkanoyloxy group, an alkenyl group having 2 to 8 carbon atoms, an alkenyloxy group, an alkenoyl group, or an alkenoyloxy group, Z0^{d}, Z1^{d}, Z2^{d} and Z3^{d} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, —OCF₂—, —CF₂O—, —CF═CF—, an alkylene group having 2 to 10 carbon atoms which may have a halogen atom, or a single bond, n^{e} represents 0, 1 or 2, and R⁵¹ and R⁵² each independently represent a hydrogen atom, a halogen atom, a cyano group or an alkyl group having 1 to 18 carbon atoms, but the alkyl group may be substituted by one or more of a halogen atom or a CN group, one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom.

Specifically, the compounds are shown below, but the compounds are not limited thereto.

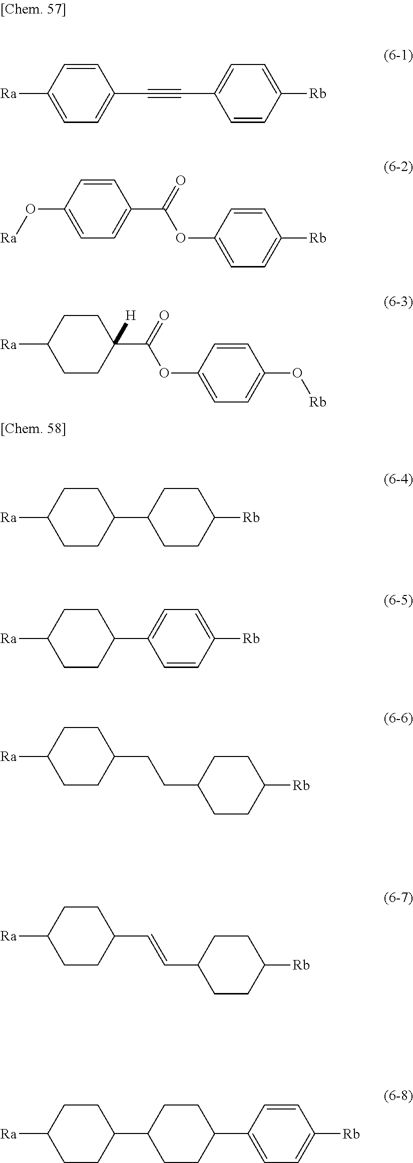

Rₐ and R_{b} each independently represent a hydrogen atom, an alkyl group having 1 to 6 carbon atoms, an alkoxy group having 1 to 6 carbon atoms, an alkenyl group having 1 to 6 carbon atoms, or a cyano group. The alkyl group having 1 to 6 carbon atoms or an alkoxy group having 1 to 6 carbon atoms may be unsubstituted or may be substituted by one or more of a halogen atom.

The total content of the compound having a mesogenic group is preferably 5.0% by mass or higher, preferably 10.0% by mass or higher, and preferably 15.0% by mass or higher, and also, preferably 99.9% by mass or lower, and preferably 95.0% by mass or lower, based on the total amount of the polymerizable composition.

(Other Components)

(Chiral compound)

The polymerizable liquid crystal composition of the present invention may be blended with a chiral compound for the purpose of obtaining a chiral nematic phase. Among the chiral compounds, compounds having a polymerizable functional group in the molecule are particularly preferable. Further, the chiral compounds of the present invention may be liquid crystalline, and may be non-liquid crystalline.

As the chiral compound used in the present invention, the compound having one or more polymerizable functional groups is preferable. Examples of such compounds include polymerizable chiral compounds containing chiral sugars such as isosorbide, isomannite, and glucoside, and a rigid site such as 1,4-phenylene group and 1,4-cyclohexylene group, and having a polymerizable functional group such as a vinyl group, an acryloyl group, a (meth)acryloyl group, or a maleimide group as described in JP-A-11-193287, JP-A-2001-158788, JP-T-2006-52669, JP-A-2007-269639, JPA-2007-269640, JP-A-2009-84178, and the like, polymerizable chiral compounds consisting of terpenoid derivatives as described in JP-A-8-239666, polymerizable chiral compounds consisting of a spacer having a mesogenic group and a chiral site as described in NATURE VOL 35 pp. 467 to 469 (issued at Nov. 30, 1995), NATURE VOL 392 pp. 476 to 479 (issued at Apr. 2, 1998), and the like, or polymerizable chiral compounds containing a binaphthyl group as described in JP-T-2004-504285 and JPA-2007-248945. Among the compounds, chiral compounds having large helical twisting power (HTP) are preferable for the polymerizable liquid crystal composition of the present invention.

The amount of the chiral compounds to be blended is required to be appropriately adjusted by the helical inducting power of the compound, but the amount is preferably 0% to 25% by mass, more preferably 0% to 20% by mass, and particularly preferably 0% to 15% by mass in the polymerizable liquid crystal composition.

As an example of Formula of chiral compounds, Formulas (7-1) to (7-4) may be exemplified, but the Formula is not limited to the following Formulas.

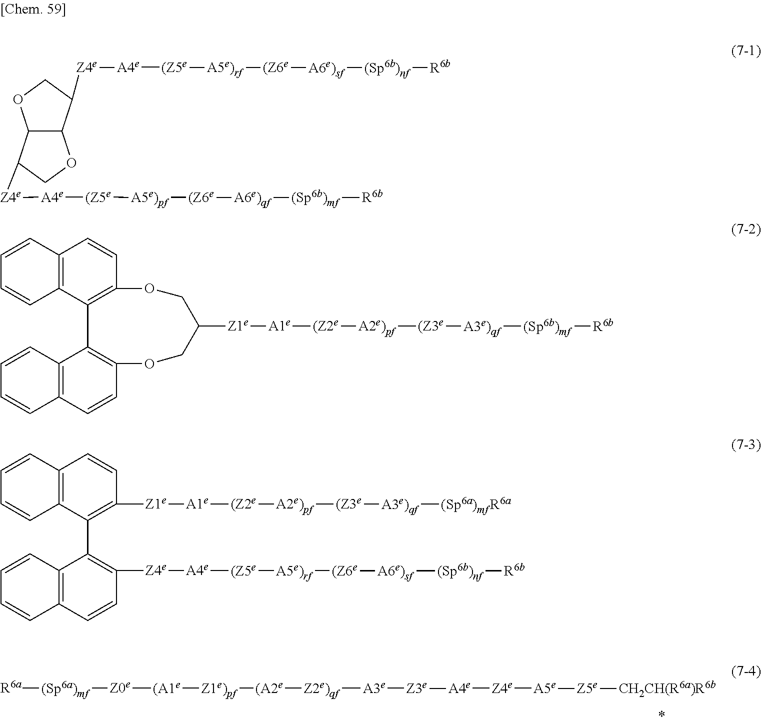

In the formulas, Sp^{6a} represents an alkylene group having 0 to 18 carbon atoms, and the alkylene group may be substituted by one or more halogen atoms, CN groups, or an alkyl group having 1 to 8 carbon atoms and having a polymerizable functional group, one of the CH₂ groups present in the group or two or more of the CH₂ groups which are not adjacent to each other may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom. A1^{e}, A2^{e}, A3^{e}, A4^{e}, and A5^{e} each independently represent 1,4-phenylene group, 1,4-cyclohexylene group, 1,4-cyclohexenyl group, tetrahydropyran-2,5-diyl group, 1,3-dioxane-2,5-diyl group, tetrahydrothiopyran-2,5-diyl group, 1,4-bicyclo(2,2,2)octylene group, decahydronaphthalene-2,6-diyl group, pyridine-2,5-diyl group, pyrimidine-2,5-diyl group, pyrazine-2,5-diyl group, thiophene-2,5-diyl group-, 1,2,3,4-tetrahydronaphthalene-2,6-diyl group, 2,6-naphthylene group, phenanthrene-2,7-diyl group, 9,10-dihydrophenanthrene-2,7-diyl group, 1,2,3,4,4a,9,10a-octahydrophenanthrene-2,7-diyl group, 1,4-naphthylene group, benzo[1,2-b:4,5-b′]dithiophene-2,6-diyl group, benzo[1,2-b:4,5-b′]diselenophene-2,6-diyl group, [1]benzothieno[3,2-b]thiophene-2,7-diyl group, [1]benzoselenopheno[3,2-b]selenophene-2,7-diyl group, or fluorene-2,7-diyl group, pf, qf, rf and sf each independently represent 0 or 1, and satisfy 0≦pf+qf+rf+sf≦3, Z1^{e}, Z2^{e}, Z3^{e}, Z4^{e}, Z5^{e} and Z6^{e} each independently represent —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms which may have a halogen atom, or a single bond, mf and of represent 0 or 1, and

R^{6a} and R^{6b} represent a hydrogen atom, a halogen atom, a cyano group or an alkyl group having 1 to 18 carbon atoms, but the alkyl group may be substituted by one or more of a halogen atom or CN, one of the CH₂ groups or two or more of the CH₂ groups which are not adjacent to each other present in the alkyl group may be independently substituted by —O—, —S—, —NH—, —N(CH₃)—, —CO—, —COO—, —OCO—, —OCOO—, —SCO—, —COS—, or —C≡C— as long as an oxygen atom is not directly bonded to another oxygen atom, or R^{6a} and R^{6b} are represented by Formula (7-a) below.

[Chem. 60]

—P^{6a} (7-a)

P^{6a} preferably represents substituents selected from polymerizable groups represented by the following Formulas (P-1) to (P-20).

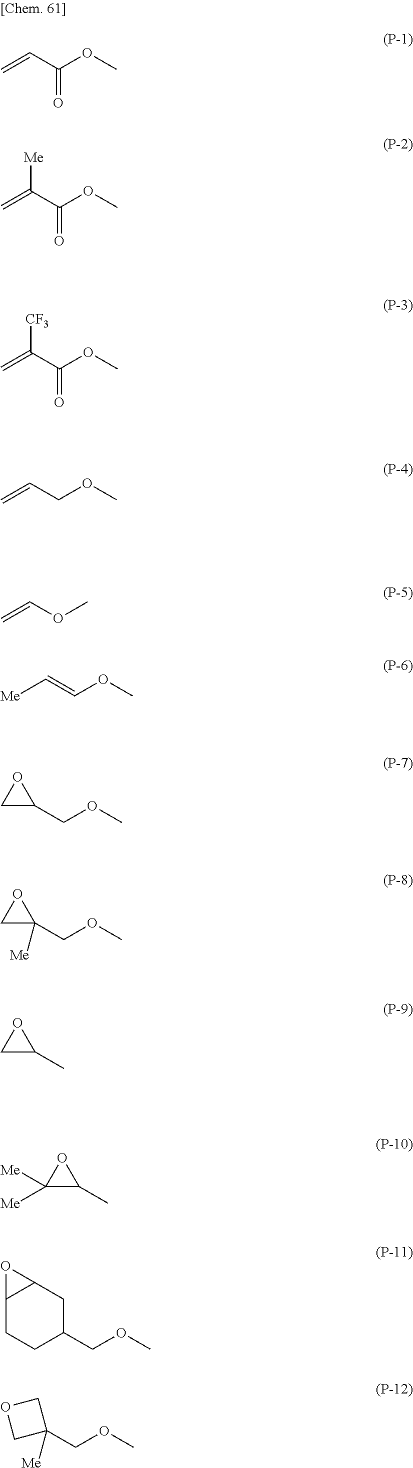

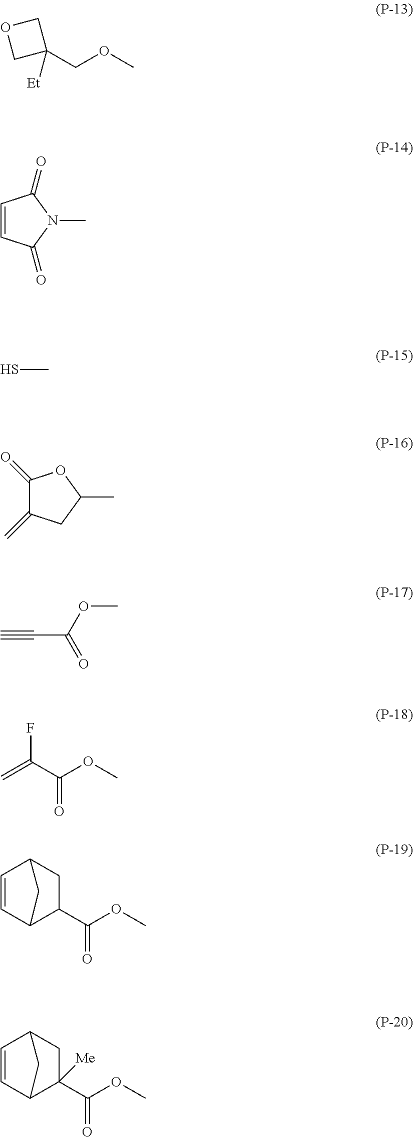

Among these polymerizable functional groups, Formula (P-1), Formula (P-2), Formula (P-7), Formula (P-12), or Formula (P-13) is preferable, and Formula (P-1), Formula (P-2), Formula (P-7), or Formula (P-12) is more preferable, from the viewpoint of enhancing polymerizable properties and storage stability.

Specific examples of the chiral compound may include compounds (7-5) to (7-32), but the compound is not limited to the following compounds.

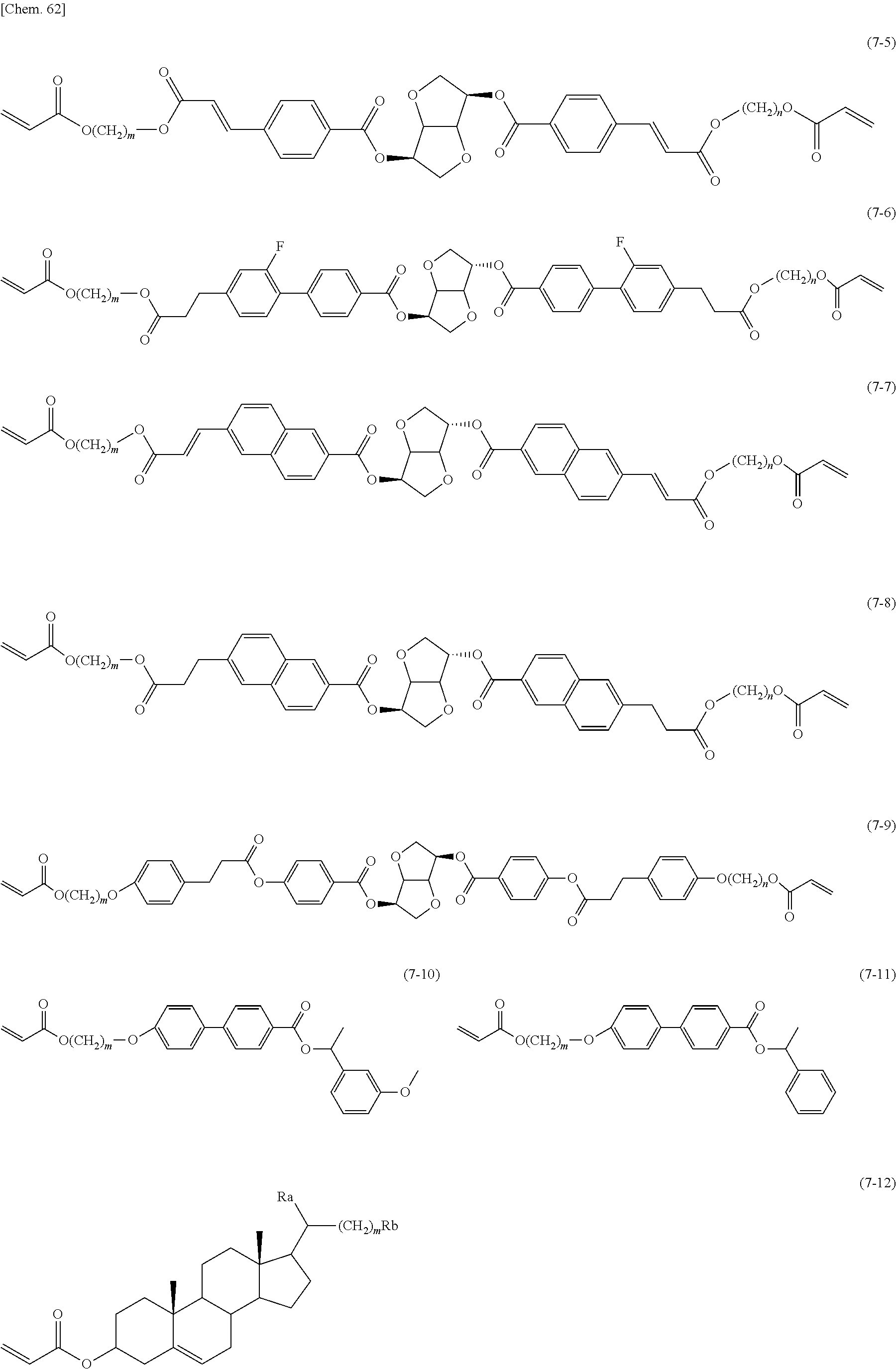

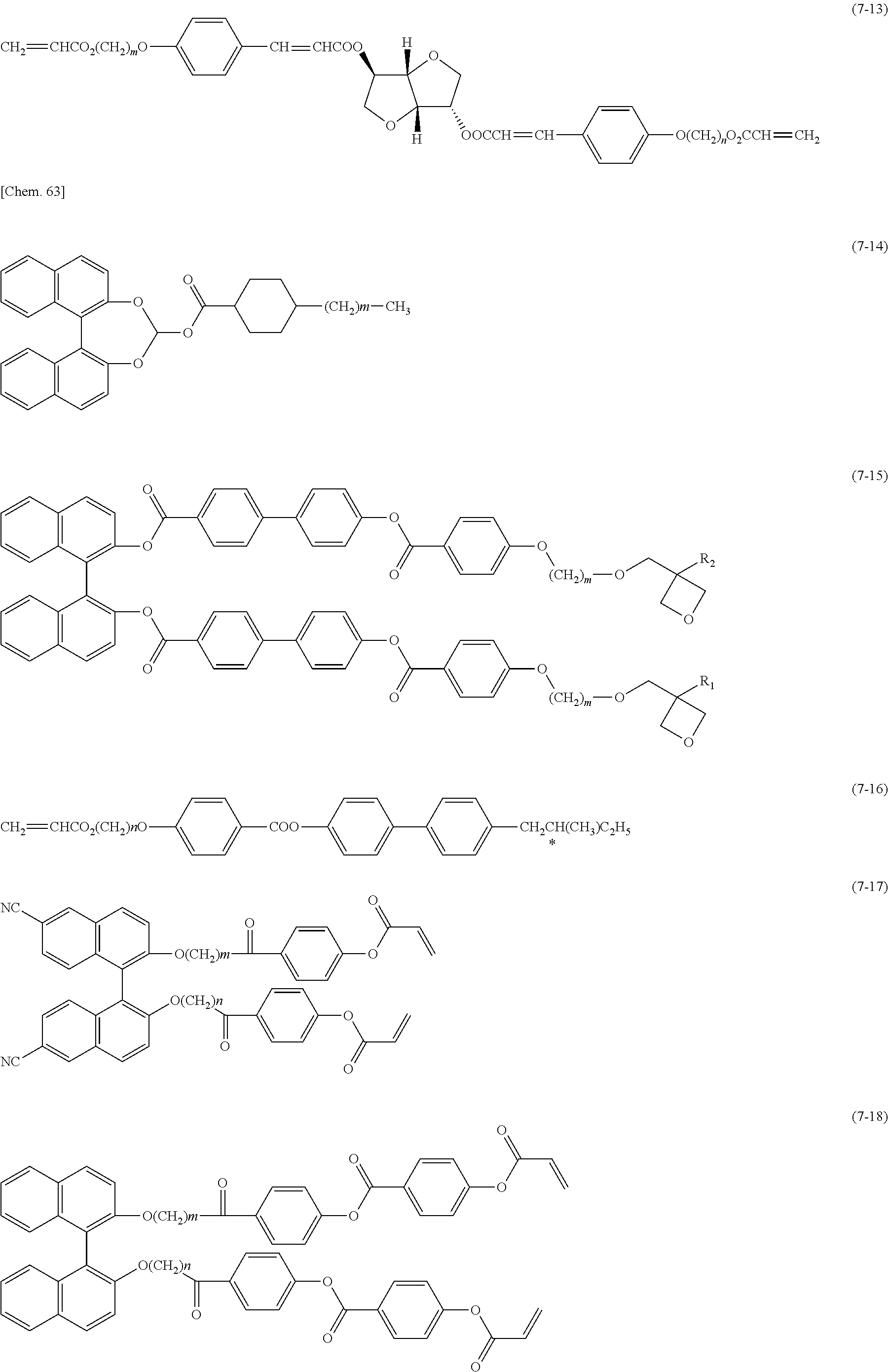

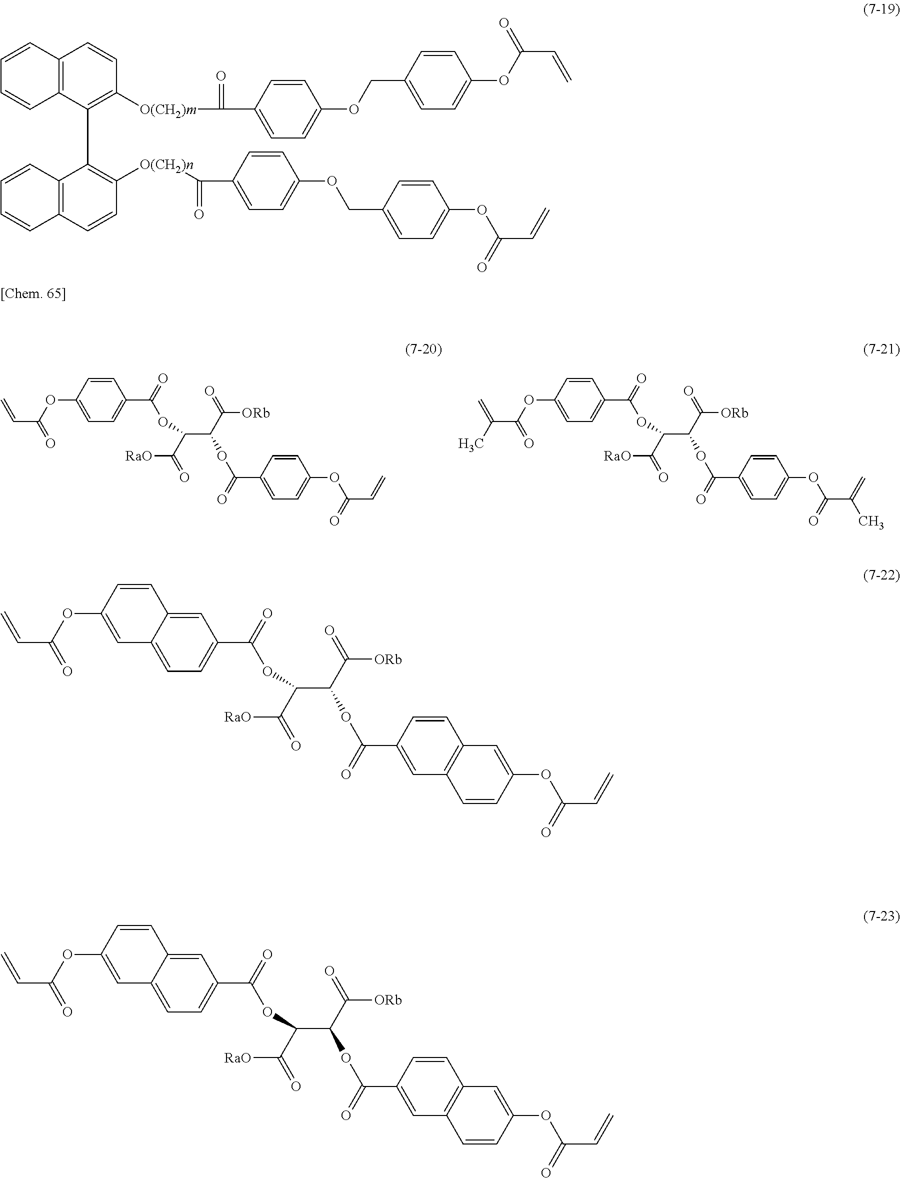

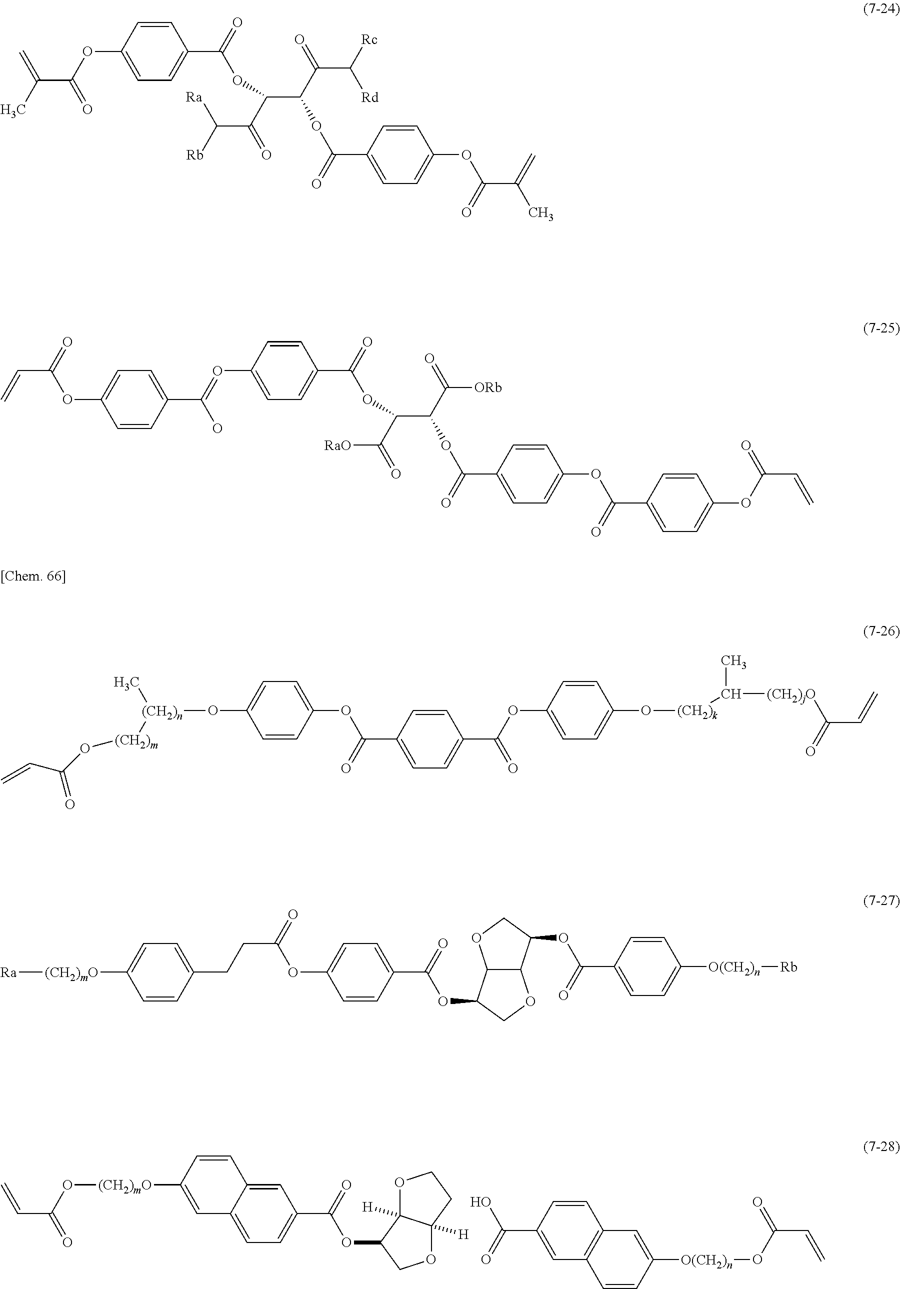

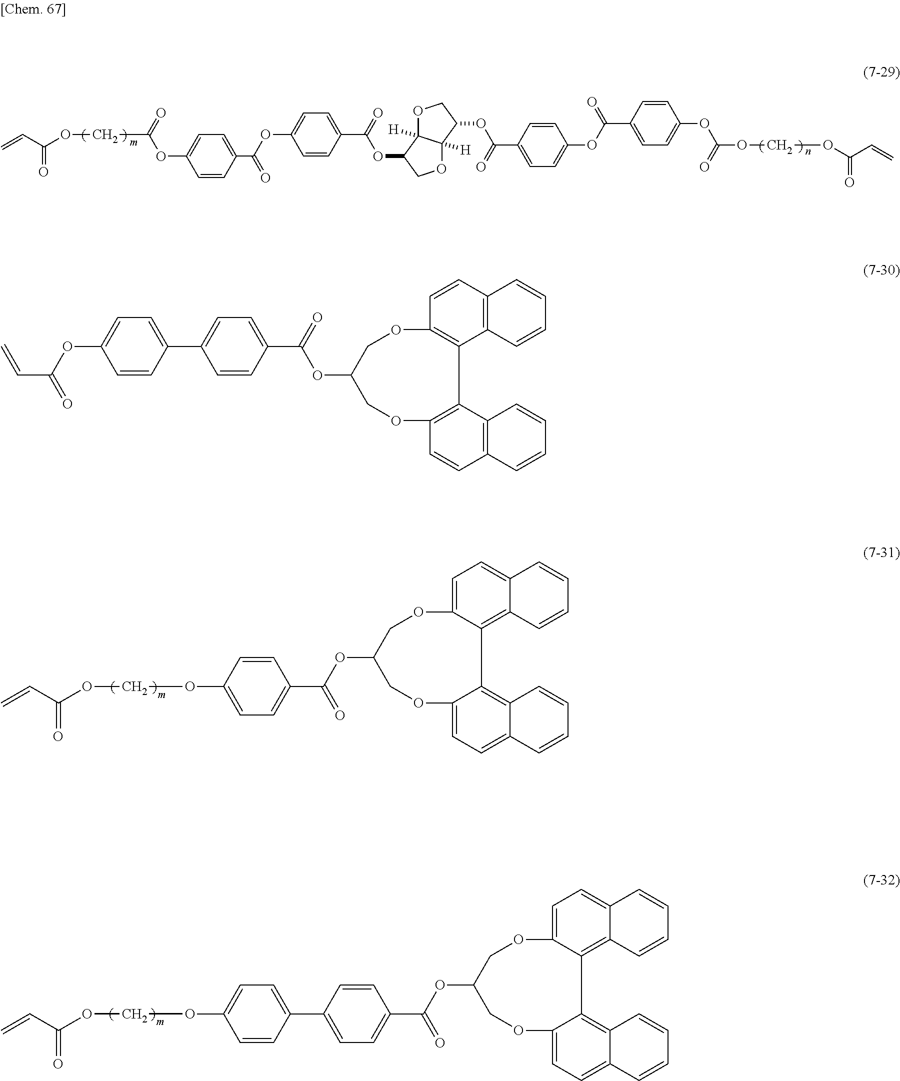

In the formulas, m, n, k, and j each independently represent an integer of 1 to 18, and Rₐ to R_{d} each independently represent a hydrogen atom, an alkyl group having 1 to 6 carbon atoms, an alkoxy group having 1 to 6 carbon atoms, a carboxyl group, or a cyano group. In a case where these groups are an alkyl group having 1 to 6 carbon atoms, or an alkoxy group having 1 to 6 carbon atoms, all of the groups may be unsubstituted, or may be substituted by one or more of halogen atoms.

(Organic Solvents)

Organic solvents may be added to the composition of the present invention. The organic solvent used is not particularly limited, but the organic solvent by which the polymerizable compound exhibits good solubility is preferable, and the organic solvent which can be dried at 100° C. or lower is preferable. Examples of such solvents include aromatic hydrocarbons such as toluene, xylene, cumene, and mesitylene, ester solvents such as methyl acetate, ethyl acetate, propyl acetate, and butyl acetate, ketone solvents such as methyl ethyl ketone, methyl isobutyl ketone, cyclohexanone, and cyclopentanone, ether solvents such as tetrahydrofuran, 1,2-dimethoxyethane, and anisole, amide solvents such as N,N-dimethylformamide, and N-methyl-2-pyrrolidone, propylene glycol monomethyl ether acetate, diethylene glycol monomethyl ether acetate, y-butyrolactone and chlorobenzene, and the like. These solvents may be used alone, or may be used in a combination of two or more thereof, but it is preferable to use any one or more of ketone solvents, ether solvents, ester solvents and aromatic hydrocarbon solvents from the viewpoint of solution stability.

When the composition used in the present invention is used as a solution of an organic solvent, the composition may be applied to the substrate, the ratio of the organic solvent used is not specifically limited as long as the organic solvent does not significantly impair the state of applied, but the total amount of the organic solvent contained in the composition solution is preferably 1% to 60% by mass, more preferably 3% to 55% by mass, and particularly preferably 5% to 50% by mass.

When dissolving the composition in an organic solvent, it is preferable to perform heating and stirring in order to uniformly dissolve the composition. The heating temperature during heating and stirring may be adjusted as appropriate in consideration of the solubility of the composition in an organic solvent to be used, but the temperature is preferably from 15° C. to 110° C., more preferably from 15° C. to 105° C., even more preferably from 15° C. to 100° C., and particularly preferably from 20° C. to 90° C. from the viewpoint of productivity.

In addition, when adding a solvent, it is preferable to perform stirring and mixing by a dispersion stirrer. Specifically, as the dispersion stirrer, dispersers having DISPAR, a propeller, a stirring blade like a turbine blade, or the like, a paint shaker, a planetary stirrer, a shaking apparatus, a shaker, a rotary evaporator, or the like may be used. Other ultrasonic irradiation apparatuses may be used.

The stirring rotational speed during adding the solvent is preferably appropriately adjusted by the stirrer used, but the stirring rotational speed is set to be preferably 10 rpm to 1,000 rpm, more preferably 50 rpm to 800 rpm, and particularly preferably 150 rpm to 600 rpm to form a uniform polymerizable composition solution.

(Polymerization Inhibitors)

It is preferable to add a polymerization inhibitor in the polymerizable composition of the present invention. Examples of the polymerization inhibitors include phenolic compounds, quinone compounds, amine compounds, thioether compounds, nitroso compounds, and the like.

Examples of phenolic compounds include p-methoxyphenol, cresol, t-butylcatechol, 3,5-di-t-butyl-4-hydroxytoluene, 2,2′-methylenebis(4-methyl-6-t-butylphenol), 2,2′-methylenebis(4-ethyl-6-t-butylphenol), 4,4′-thiobis(3-methyl-6-t-butylphenol), 4-methoxy-1-naphthol, 4,4′-dialkoxy-2,2′-bi-1-naphthol, and the like.

Examples of quinone compounds include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, diphenoquinone, and the like.

Examples of the amine compounds include p-phenylenediamine, 4-aminodiphenylamine, N,N′-diphenyl-p-phenylenediamine, N-i-propyl-N′-phenyl-p-phenylenediamine, N-(1,3-dimethylbutyl)-N′-phenyl-p-phenylenediamine, N,N′-di-2-naphthyl-p-phenylenediamine, diphenylamine, N-phenyl-β-naphthylamine, 4,4′-dicumyl-diphenylamine, 4,4′-dioctyl-diphenylamine, and the like.

Examples of the thioether compounds include phenothiazine, distearyl thiodipropionate, and the like.

Examples of the nitroso-based compounds include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, or the like, N,N-dimethylp-nitrosoaniline, p-nitrosodiphenylamine, p-nitronedimethylamine, p-nitrone-N,N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4,6-tri-tert-butylnitronebenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, sodium 1-nitroso-2-naphthol-3,6-sulfonate, sodium 2-nitroso-1-naphthol-4-sulfonate, 2-nitroso-5-methylaminophenol hydrochloride, 2-nitroso-5-methylaminophenol hydrochloride, and the like.

The amount of the polymerization inhibitor added is preferably 0.01% to 1.0% by mass and more preferably 0.05% to 0.5% by mass based on the polymerizable composition.

(Antioxidants)

Antioxidants or the like may be added to enhance the stability of the polymerizable composition of the present invention. Examples of such compounds include hydroquinone derivatives, nitrosamine-based polymerization inhibitors, hindered phenol-based antioxidants, or the like, and more specific examples thereof include tert-butylhydroquinone, methylhydroquinone, “Q-1300”, and “Q-1301” manufactured by Wako Pure Chemical Industries, Ltd., pentaerythritol tetrakis[3-(3,5-di-tert-butyl-4-hydroxyphenyl)propionate “IRGANOX1010”, thiodiethylenebis[3-(3,5-di-tert-butyl-4-hydroxyphenyl)propionate “IRGANOX1035”, octadecyl-3-(3,5-di-tert-butyl-4-hydroxyphenyl)propionate “IRGANOX1076”, “IRGANOX1098”, “IRGANOX1135”, “IRGANOX1330”, 4,6-bis(octylthiomethyl)-o-cresol “IRGANOX1520L”, “IRGANOX1425”, “IRGANOX1726”, “IRGANOX245”, “IRGANOX259”, “IRGANOX3114”, “IRGANOX3790”, “IRGANOX5057”, and “IRGANOX565” (manufactured by BASF SE), ADK STAB AO-20, AO-30, AO-40, AO-50, AO-60, and AO-80 manufactured by ADEKA CORPORATION, SUMILIZER BHT, SUMILIZER BBM-S, and SUMILIZER GA-80 manufactured by Sumitomo Chemical Co., Ltd., and the like.

The amount of the antioxidant added is preferably 0.01% to 2.0% by mass and more preferably 0.05% to 1.0% by mass based on the polymerizable composition.

(Photopolymerization Initiator)

The polymerizable composition of the present invention preferably contains a photopolymerization initiator. At least one or more photopolymerization initiators are preferably contained. Specific examples thereof include 1-hydroxycyclohexylphenylketone “IRGACURE184”, 2-hydroxy-2-methyl-1-phenyl-propan-1-one “DAROCUR1173”, 1-(4-isopropylphenyl)-2-hydroxy-2-methylpropan-1-one “DAROCUR1116”, 2-methyl-1-[(methylthio)phenyl]-2-morpholinopropan-1 “IRGACURE907”, 2-hydroxy-1-{4-[4-(2-hydroxy-2-methyl-propionyl)-benzyl)phenyl]-2-methyl-propan-1-one “IRGACURE127”, 2,2-dimethoxy-1,2-diphenylethane-1-one “IRGACURE651”, 2-benzyl-2-dimethylamino-1-(4-morpholinophenyl)-butanone “IRGACURE369”), 2-dimethylamino-2-(4-methylbenzyl)-1-(4-morpholino-phenyl)butan-1-one “IRGACURE379”, 2,2-dimethoxy-1,2-diphenylethane-1-one, bis(2,4,6-trimethylbenzoyl)-diphenylphosphine oxide “LUCIRIN TPO”, 2,4,6-trimethylbenzoyl-phenyl-phosphine oxide “IRGACURE819”, 1-[4-(2-hydroxyethoxy)-phenyl]-2-hydroxy-2-methyl-1-propan-1-one “IRGACURE2959”, a mixture of bis(2,6-dimethoxybenzoyl)-2,4,4-trimethylpentylphosphine oxide, and 1-hydroxycyclohexylphenylketone (1:3) “IRGACURE1800”, iodonium{4-(2-methylpropyl)phenyl}(hexafluorophosphate) “IRGACURE250”, a mixture of oxyphenylacetic acid, 2-[2-oxo-2-phenylacetoxy ethoxy]ethylester and oxyphenylacetic acid, 2-(2-hydroxyethoxy)ethylester “IRGACURE754”, bis(eta 5-2,4-cyclopentadiene-1-yl)-bis(2,6-difluoro-3-(1H-pyrrol-1-yl)-phenyl) titanium “IRGACURE784”, (1,2-dioxo-2-methoxyethyl)benzene “DAROCUR MBF”, 1,2-octanedione, 1-[4-(phenylthio)-, 2-(O-benzoyloxime)] “IRGACURE OXE01”, 1-[9-ethyl-6-(2-methylbenzoyl)-9H-carbazol-3-yl]-, 1-(0-acetyl oxime) “IRGACURE OXE02” (manufactured by BASFSE), a mixture of 2,4-diethylthioxanthone (“KAYACURE DETX” manufactured by NIPPON KAYAKU Co., Ltd.) and p-dimethylaminobenzoic acid ethyl (“KAYACURE EPA” manufactured by NIPPON KAYAKU Co., Ltd.), para dimethylbenzoic acid isoamyl ester (“KAYACURE DMBI” manufactured by NIPPON KAYAKU Co., Ltd.), a mixture of isopropylthioxanthone (“QUANTACURE ITX” manufactured by Ward Blenkinsop and Co Ltd.) and p-dimethylamino benzoic acid ethyl, “ESACURE ONE”, “ESACURE KIP150”, “ESACURE KIP160”, “ESACURE 1001M”, “ESACURE A198”, “ESACURE KIP IT”, “ESACURE KT046”, and “ESACURE TZT”, (manufactured by Lamberti S.p.A.), “SPEEDCURE BMS”, “SPEEDCURE PBZ”, “SPEEDCURE BEM”, “SPEEDCURE MBP”, “SPEEDCURE MBB”, “SPEEDCURE ITX”, “SPEEDCURE DETX”, and “SPEEDCURE EBD” manufactured by Lambson Limited, “benzophenone”, and “TAZ-A” manufactured by Japan Siber Hegner Co., Ltd. (currently DKSH Japan K.K.), “ADEKA OPTOMER SP-152”, “ADEKA OPTOMER SP-170”, “ADEKA OPTOMER N-1414”, “ADEKA OPTOMER N-1606”, “ADEKA OPTOMER N-1717”, and “ADEKA OPTOMER N-1919” manufactured by ADEKA CORPORATION, and the like. Moreover, as the cationic photoinitiator, a photoacid generator may be used. Examples of the photoacid generator include diazodisulfone-based compounds, triphenylsulfonium-based compounds, phenylsulfone-based compounds, sulfonyl pyridine-based compound, triazine-based compounds and diphenyl iodonium compounds, and the like.

The amount of the photopolymerization initiator used is preferably 0.1% to 10% by mass and particularly preferably 0.5% to 5% by mass based on the polymerizable composition. These initiators may be used alone, or may be used as a mixture of two or more thereof. Further, a sensitizer, and the like may also be added.

(Thermal Polymerization Initiator)

A thermal polymerization initiator may be used together with a photopolymerization initiator in the polymerizable composition of the present invention. As the thermal polymerization initiator used during the thermal polymerization, the known conventional initiators may be used, but specific examples thereof include alkyl peroxide compounds such as “PERHEXYL D”, and “PERHEXYL I” manufactured by Nippon Oil & Fats Co., Ltd. (currently NOF CORPORATION), organic peroxides such as methyl acetoacetate peroxide, cumene hydroperoxide, benzoyl peroxide, bis(4-t-butylcyclohexyl) peroxydicarbonate, t-butyl peroxy benzoate, methyl ethyl ketone peroxide, 1,1-bis(t-hexylperoxy) 3,3,5-trimethylcyclohexane, p-penta hydroperoxide, t-butyl hydroperoxide, dicumyl peroxide, isobutyl peroxide, di(3-methyl-3-methoxy-butyl) peroxydicarbonate, and 1,1-bis (t-butylperoxy) cyclohexane, azonitrile compounds such as 2,2′-azobisisobutyronitrile, and 2,2′-azobis(2,4-dimethyl valeronitrile), azoamidine compounds such as 2,2′-azobis (2-methyl-N-phenylpropione-amidine) dihydrochloride, azoamide compounds such as 2,2′azobis {2-methyl-N-[1,1-bis (hydroxymethyl)-2-hydroxyethyl] propionamide}, alkylazo compounds such as 2,2′azobis (2,4,4-trimethyl pentane), 1,1′azobis (cyclohexane-1-carbonitrile) of “V-40” manufactured by Wako Pure Chemical Industries, Ltd., and 2,2′-azobis [N-(2-propenyl)-2-methyl propioneamide] of “VF-096” manufactured by Wako Pure Chemical Industries, Ltd., and the like. The content of the thermal polymerization initiator is preferably 0.1% to 10% by mass, and particularly preferably 1% to 6% by mass. These initiators may be used alone, or may be used as a mixture of two or more thereof.

(Surfactant)

The polymerizable composition of the present invention may contain at least one or more surfactants in order to reduce the thickness irregularity in a case of being an optical anisotropic body. Examples of the surfactant that may be contained include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkyl ethylene oxide derivatives, polyethylene glycol derivatives, alkyl ammonium salts, fluoroalkyl ammonium salts, and the like, in particular fluorine-containing surfactants are preferred.

Specific examples thereof include “MEGAFAC F-114”, “MEGAFAC F-251”, “MEGAFAC F-281”, “MEGAFAC F-410”, “MEGAFACF-430”, “MEGAFAC F-444”, “MEGAFAC F-472SF”, “MEGAFAC F-477”, “MEGAFAC F-510”, “MEGAFAC F-511”, “MEGAFAC F-552”, “MEGAFAC F-553”, “MEGAFAC F-554”, “MEGAFAC F-555”, “MEGAFAC F-556”, “MEGAFAC F-557”, “MEGAFAC F-558”, “MEGAFAC F-559”, “MEGAFAC F-560”, “MEGAFAC F-561”, “MEGAFAC F-562”, “MEGAFAC F-563”, “MEGAFAC F-565”, “MEGAFAC F-567”, “MEGAFAC F-568”, “MEGAFAC F-569”, “MEGAFAC F-570”, “MEGAFAC F-571”, “MEGAFAC R-40”, “MEGAFAC R-41”, “MEGAFAC R-43”, “MEGAFAC R-94”, “MEGAFAC RS-72-K”, “MEGAFAC RS-75”, “MEGAFAC RS-76-E”, “MEGAFAC RS-76-NS”, “MEGAFAC RS-90”, “MEGAFAC EXP. TF-1367”, “MEGAFAC EXP. TF 1437”, “MEGAFAC EXP. TF 1537”, “MEGAFAC EXP. TF-2066” (manufactured by DIC Corporation), “FTERGENT 100”, “FTERGENT 100C”, “FTERGENT 110”, “FTERGENT 150”, “FTERGENT 150CH”, “FTERGENT 100A-K”, “FTERGENT 300”, “FTERGENT 310”, “FTERGENT 320”, “FTERGENT 400SW”, “FTERGENT 251”, “FTERGENT 215M”, “FTERGENT 212M”, “FTERGENT 215M”, “FTERGENT 250”, “FTERGENT 222F”, “FTERGENT 212D”, “FTX-218”, “FTERGENT 209F”, “FTERGENT 245F”, “FTERGENT 208G”, “FTERGENT 240G”, “FTERGENT 212P”, “FTERGENT 220P”, “FTERGENT 228P”, “DFX-18”, “FTERGENT 601AD”, “FTERGENT 602A”, “FTERGENT 650A”, “FTERGENT 750FM”, “FTX-730FM”, “FTERGENT 730FL”, “FTERGENT 710FS”, “FTERGENT 710FM”, “FTERGENT 710FL”, “FTERGENT 750LL”, “FTX-730LS”, “FTERGENT 730LM” (manufactured by NEOS COMPANY LIMITED), “BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK-UV 3500”, “BYK-UV 3510”, “BYK-UV 3570”, and “BYK-Silclean 3700” (manufactured by BYK Additives & Instruments), “TEGO Rad 2100”, “TEGO Rad 2011”, “TEGO Rad 2200N”, “TEGO Rad 2250”, “TEGO Rad 2300”, “TEGO Rad 2500”, “TEGO Rad 2600”, “TEGO Rad 2650”, “TEGO Rad 2700”, “TEGO Flow 300”, “TEGO Flow 370”, “TEGO Flow 425”, “TEGO Flow ATF 2”, “TEGO Flow ZFS 460”, “TEGO Glide 100”, “TEGO Glide 110”, “TEGO Glide 130”, “TEGO Glide 410”, “TEGO Glide 411”, “TEGO Glide 415”, “TEGO Glide 432”, “TEGO Glide 440”, “TEGO Glide 450”, “TEGO Glide 482”, “TEGO Glide A115”, “TEGO Glide B1484”, “TEGO Glide ZG400”, “TEGO Twin 4000”, “TEGO Twin 4100”, “TEGO Twin 4200”, “TEGO Wet 240”, “TEGO Wet 250”, “TEGO Wet 260”, “TEGO Wet 265”, “TEGO Wet 270”, “TEGO Wet 280”, “TEGO Wet 500”, “TEGO Wet 505”, “TEGO Wet 510”, “TEGO Wet 520”, and “TEGO Wet KL245” (manufactured by EVONIK INDUSTRIES AG), “FC-4430”, “FC-4432” (manufactured by 3M Japan KK), “UNIDYNE NS” (manufactured by DAIKIN INDUSTRIES, Ltd.), “SURFLON S-241”, “SURFLON S-242”, “SURFLON S-243”, “SURFLON S-420”, “SURFLON S-611”, “SURFLON S-651”, “SURFLON S-386” (manufactured by AGC SEIMI CHEMICAL CO., LTD.), “DISPARLON OX-880EF”, “DISPARLON OX-881”, “DISPARLON OX-883”, “DISPARLON OX-77EF”, “DISPARLON OX-710”, “DISPARLON 1922”, “DISPARLON 1927”, “DISPARLON 1958”, “DISPARLON P-410EF”, “DISPARLON P-420”, “DISPARLON P-425”, “DISPARLON PD-7”, “DISPARLON 1970”, “DISPARLON 230”, “DISPARLON LF-1980”, “DISPARLON LF-1982”, “DISPARLON LF-1983”, “DISPARLON LF-1084”, “DISPARLON LF-1985”, “DISPARLON LHP-90”, “DISPARLON LHP-91”, “DISPARLON LHP-95”, “DISPARLON LHP-96”, “DISPARLON OX-715”, “DISPARLON 1930N”, “DISPARLON 1931”, “DISPARLON 1933”, “DISPARLON 1934”, “DISPARLON 1711EF”, “DISPARLON 1751N”, “DISPARLON 1761”, “DISPARLON LS-009”, “DISPARLON LS-001”, and “DISPARLON LS-050” (manufactured by Kusumoto Chemicals, Ltd.), “PF-151N”, “PF-636”, “PF-6320”, “PF-656”, “PF-6520”, “PF-652-NF”, and “PF-3320” (manufactured by OMNOVA SOLUTIONS), “POLYFLOW No. 7”, “POLYFLOW No. 50E”, “POLYFLOW No. 50EHF”, “POLYFLOW No. 54N”, “POLYFLOW No. 75”, “POLYFLOW No. 77”, “POLYFLOW No. 85”, “POLYFLOW No 85HF”, “POLYFLOW No 90”, “POLYFLOW No 90D-50”, “POLYFLOW No 95”, “POLYFLOW No 99C”, “POLYFLOW KL-400K”, “POLYFLOW KL-400HF”, “POLYFLOW KL-401”, “POLYFLOW KL-402”, “POLYFLOW KL-403”, “POLYFLOW KL-404”, POLYFLOW KL-100″, “POLYFLOW LE-604”, “POLYFLOW KL-700”, “FLOWLEN AC-300”, “FLOWLEN AC-303”, “FLOWLEN AC-324”, “FLOWLEN AC-326F”, “FLOWLEN AC-530”, “FLOWLEN AC-903”, “FLOWLEN AC-903HF”, “FLOWLEN AC-1160”, “FLOWLEN AC-1190”, “FLOWLEN AC-2000”, “FLOWLEN AC-2300C”, “FLOWLEN AO-82”, “FLOWLEN AO-98”, and “FLOWLEN AO-108” (manufactured by KYOEISHA CHEMICAL Co., LTD.), “L-7001”, “L-7002”, “8032 ADDITIVE”, “57 ADDTIVE”, “L-7064”, “FZ-2110”, “FZ-2105”, “67 ADDTIVE”, and “8616 ADDTIVE” (manufactured by Dow Corning Toray Co., Ltd.), and the like.

The amount of the surfactant added is preferably 0.01% to 2% by mass, and more preferably 0.05% to 0.5% by mass based on the polymerizable liquid crystal composition.

Further, in a case where the polymerizable liquid crystal composition of the present invention is an optical anisotropic body, the tilt angle of the air interface may be reduced efficiently by using the surfactant.

The polymerizable liquid crystal composition of the present invention has the effect of effectively reducing the tilt angle of the air interface in a case where the composition is an optical anisotropic body, and at least one compound having a repeating unit represented by the following Formula (8) and having a weight average molecular weight of 100 or more may be used, in addition to the above surfactants.

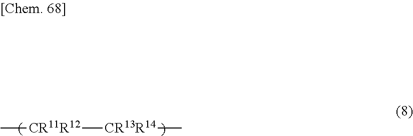

In the formula, and each R¹¹, R¹², R¹³, and R¹⁴ each independently represent a hydrogen atom, a halogen atom or a hydrocarbon group having 1 to 20 carbon atoms, and the hydrogen atom in the hydrocarbon group may be substituted by one or more halogen atoms.

Examples of the preferred compounds represented by Formula (8) include polyethylene, polypropylene, polyisobutylene, paraffin, liquid paraffin, chlorinated polypropylene, chlorinated paraffin, liquid chlorinated paraffin, and the like.

The compound represented by Formula (8) may be preferably added in the step of preparing a polymerizable solution by mixing the polymerizable compound with an organic solvent and heating and stirring the solution, but, after that step, may be added in the step of mixing the photopolymerization initiator in the polymerizable solution, or may be added in both steps.

The amount of the compound represented by Formula (8) added is preferably 0.01% to 1% by mass, and more preferably 0.05% to 0.5% by mass based on the polymerizable liquid crystal composition solution.

In a case where the polymerizable liquid crystal composition solution of the present invention is an optical anisotropic body, it is preferable to add a chain transfer agent to the composition in order to further improve the adhesiveness to a substrate. As the chain transfer agent, thiol compounds are preferable, monothiol, dithiol, trithiol, and tetrathiol compounds are more preferable, and trithiol compounds are even more preferable. Specifically, the compounds represented by the following Formulas (8-1) to (8-12) are preferable.

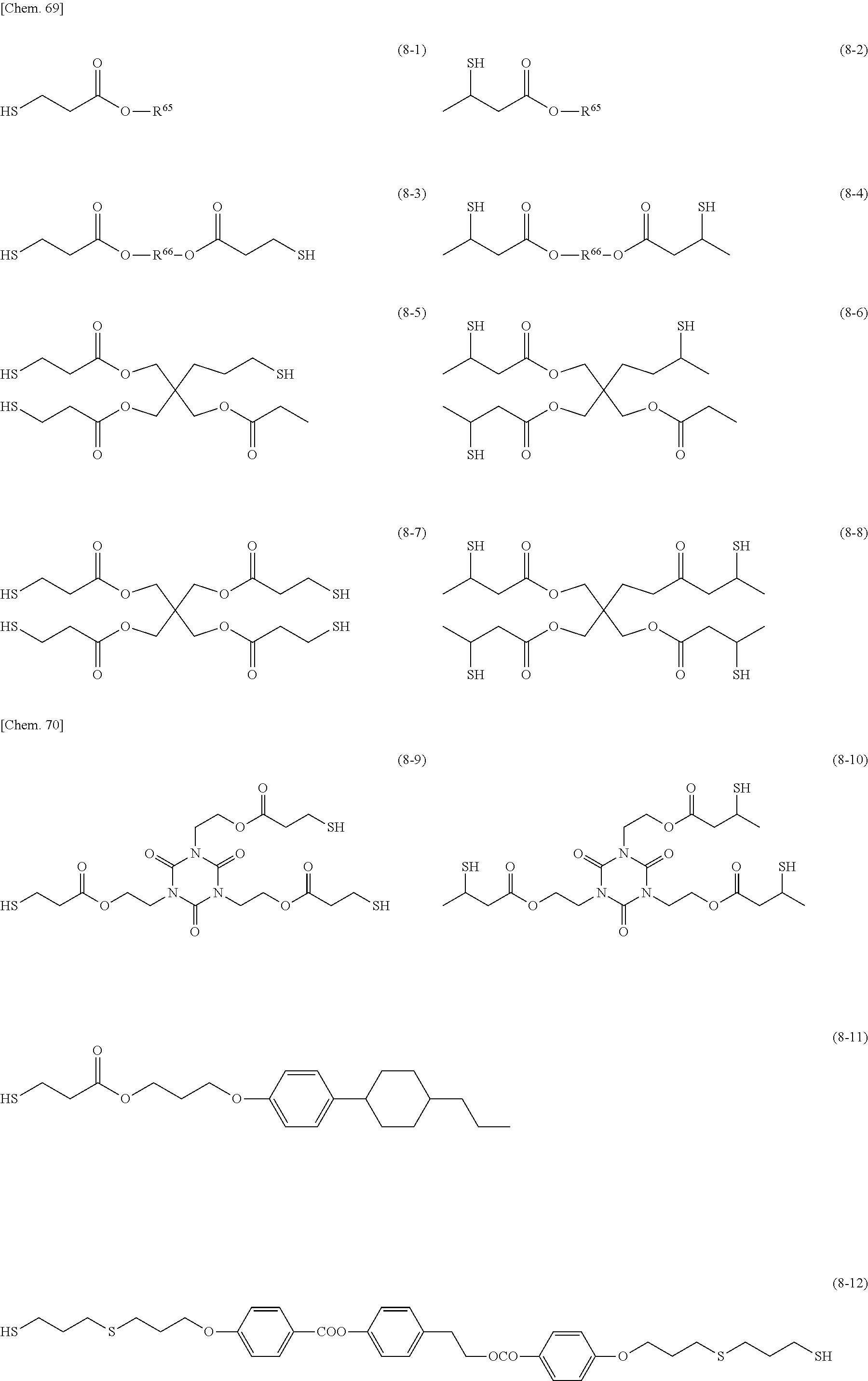

In the formulas, R⁶⁵ represents an alkyl group having to 18 carbon atoms, the alkyl group may be a linear chain or a branched chain, one or more methylene groups in the alkyl group may be substituted with an oxygen atom, a sulfur atom, —CO—, —OCO—, —COO—, or —CH═CH— as long as an oxygen atom is not linked directly to another oxygen atom or a sulfur atom; and a sulfur atom is not linked directly to an oxygen atom or another sulfur atom, and R⁶⁶ represents an alkylene group having 2 to 18 carbon atoms, one or more methylene groups in the alkylene group may be substituted with an oxygen atom, a sulfur atom, —CO—, OCO—, —COO—, or —CH═CH— as long as an oxygen atom is not linked directly to another oxygen atom or a sulfur atom; and a sulfur atom is not linked directly to an oxygen atom or another sulfur atom.

The chain transfer agent may be preferably added in the step of preparing a polymerizable solution by mixing the polymerizable liquid crystal compound with an organic solvent and heating and stirring the solution, but, after that step, may be added in the step of mixing the polymerization initiator in the polymerizable solution, or may be added in both steps.

The amount of the chain transfer agent added is preferably 0.5% to 10% by mass, and more preferably 1.0% to 5.0% by mass based on the polymerizable liquid crystal composition.

Liquid crystal compounds that are not polymerizable or polymerizable compounds that are not liquid crystalline may be added, if necessary, to further adjust physical properties. The polymerizable compounds that are not liquid crystalline may be preferably added in the step of preparing a polymerizable solution by mixing the polymerizable compound with an organic solvent and heating and stirring the solution, but liquid crystal compounds that are not polymerizable, after that step, may be added in the step of mixing the polymerization initiator in the polymerizable solution, or may be added in both steps. The amount of these compounds added is preferably 20% by mass or lower, more preferably 10% by mass or lower, and even more preferably 5% by mass or lower based on the polymerizable liquid crystal composition.

Other additives, for example, thixo agent, ultraviolet ray absorbents, infrared ray absorbents, antioxidants, surface treatment agents may be added to the extent of not significantly reducing the alignment capability of the liquid crystal according to the purpose in polymerizable mixture, or polymerizable composition of the present invention.

(Method of Manufacturing Polymerizable Composition)

In order to obtain a polymerizable composition satisfying Expression (1), for example, a method of appropriately adjusting the purification degree of one or more compounds having mesogenic groups to be contained in the polymerizable composition and finally obtaining a polymerizable composition that satisfies Expression (1) is exemplified. The purification degree of one or more compounds having mesogenic groups may be adjusted, if necessary, by performing purification in the synthesis steps of compounds having mesogenic groups. The purification may be carried out as appropriate in each step of the synthesis, and as a purification method, chromatography, recrystallization, distillation, sublimation, reprecipitation, adsorption, liquid separation processing, and the like are exemplified. In a case of using a purifying agent, as the purifying agent, silica gel, alumina, activated carbon, activated white clay, celite, zeolite, mesoporous silica, carbon nanotube, carbon nanohorn, Bincho charcoal, charcoal, graphene, ion-exchanged resins, acidic white clay, silicon dioxide, diatomaceous earth, perlite, cellulose, organic polymers, porous gel, and the like are exemplified.

Further, in a case where the polymerizable composition contains a compound having two or more mesogenic groups, or in a case where the polymerizable composition includes a compound having one mesogenic group, but in a case where the composition includes compounds in which the yellowness indexes of the compounds differ, the values of yellowness index (YI) and refractive index anisotropy (Δn) of each of the compounds themselves are not particularly limited. In a case of a composition, a material in which all the compounds having mesogenic groups in the composition are combined is preferable as long as it satisfies the above Expression (1).

(Production Method of Optical Anisotropic Body)

(Optical Anisotropic Body)

The optical anisotropic body produced by using the polymerizable liquid crystal composition of the present invention is obtained by laminating a substrate, if necessary, an alignment film, and a polymer of the polymerizable liquid crystal composition sequentially.

The substrates used for the optical anisotropic body of the present invention are substrates that are normally used in a liquid crystal device, a display, an optical component or an optical film, and are not particularly limited as long as the material thereof has heat resistance which is capable of withstanding heating during drying after applying the polymerizable composition of the present invention. Examples of such substrates include organic materials such as glass substrates, metal substrates, ceramics substrates or plastic substrates. Especially, in a case where the substrate is an organic material, cellulose derivatives, polyolefins, polyesters, polyolefins, polycarbonates, polyacrylates, polyarylates, polyether sulfones, polyimides, polyphenylene sulfides, polyphenylene ethers, nylon, polystyrenes, or the like are exemplified. Among them, plastic substrates such as polyesters, polystyrenes, polyolefins, cellulose derivatives, polyarylates, and polycarbonates are preferable.

The surface treatment of these substrates may be performed in order to improve coating properties and adhesiveness of the polymerizable composition of the present invention. As the surface treatment, ozone treatment, plasma treatment, corona treatment, silane coupling treatment, and the like are exemplified. Further, an organic thin film, an inorganic oxide thin film, a metal thin film, or the like is provided on the surface of a substrate by a method such as vapor deposition in order to adjust the transmittance and reflectance of light, or substrates may be pickup lens, rod lens, optical disks, a retardation film, a light diffusing film, a color filter, or the like in order to give the optical added value. Among them, pickup lens, a retardation film, a light diffusion film, and a color filter are preferable of which the higher added value becomes higher.

Further, the normal alignment treatment may be performed or the alignment film may be formed on the substrate so as to align the polymerizable composition when applying and drying the polymerizable composition of the present invention. As the alignment treatment, stretching treatment, rubbing treatment, polarization ultraviolet visible light irradiation treatment, and ion beam processing, and the like are exemplified. In a case of using an alignment film, the conventionally known alignment film may be used. Examples of such an alignment film include compounds such as polyimides, polysiloxanes, polyamides, polyvinyl alcohol, polycarbonates, polystyrenes, polyphenylene ethers, polyarylates, polyethylene terephthalates, polyether sulfones, epoxy resins, epoxy acrylate resins, acrylic resins, coumarin compounds, chalcone compounds, cinnamate compounds, fulgide compounds, anthraquinone compounds, azo compounds and arylethene compounds. For the compounds that are subjected to the alignment treatment by rubbing, the crystallization of the material may preferably be promoted by putting a heating step of the compounds during the alignment treatment or after the alignment treatment. It is preferable to use photoalignment materials for the compounds subjected to an alignment treatment other than rubbing.

(Applying)

As the method of obtaining an optical anisotropic body of the present invention, known conventional methods such as an applicator method, a bar coating method, a spin coating method, a roll coating method, a direct gravure coating method, a reverse gravure coating method, a flexo coating method, an inkjet method, a die coating method, a cap coating method, a dip coating method, a slit coating method, and the like may be performed. The polymerizable composition may be dried after applying.

(Polymerization Step)

The polymerization operation of the polymerizable liquid crystal composition of the present invention is generally carried out by irradiation with light such as ultraviolet rays or heating in a state where the liquid crystal compound of the polymerizable liquid crystal composition is horizontally aligned, vertically aligned, hybrid aligned, or cholesteric aligned (planar aligned) to the substrate. In a case where the polymerization is carried out by light irradiation, specifically to irradiate with an ultraviolet light having a wavelength of 390 nm or less is preferable and to irradiate with an ultraviolet light having a wavelength of 250 to 370 nm is most preferable. However, in a case where the polymerizable composition is decomposed by the ultraviolet light of 390 nm or less, it may be preferable to carry out polymerization treatment with ultraviolet light of 390 nm or more. It is preferable that this light is a diffused light and is an unpolarized light.

(Polymerization Method)

As a method of polymerizing a polymerizable liquid crystal composition of the present invention, a method of irradiating with an active energy ray, a thermal polymerization, or the like are exemplified, but the method of irradiating with the active energy ray is preferable since the reaction proceeds at room temperature without heating, and among them, the method of irradiating with light such as ultraviolet rays is preferable since the operation is simple. The temperature during irradiation is a temperature at which the polymerizable liquid crystal composition of the present invention may maintain liquid crystal phases and is preferably 30° C. or lower, if possible, in order to avoid the induction of the thermal polymerization of the polymerizable liquid crystal composition. In addition, during a temperature elevating step, the liquid crystal composition usually shows liquid crystal phase within a range from an N-I transition temperature to C (solid phase)—N (nematic) transition temperature (hereinafter, abbreviated as C—N transition temperature.). On the other hand, the liquid crystal composition is in a thermodynamically non-equilibrium state, and thus the liquid crystal state may be maintained without solidification even at C—N transition temperature or less during a temperature lowering step. This state is referred to as a supercooled state. In the present invention, a liquid crystal composition that is in the supercooled state also maintains the liquid crystal phase. Specifically, to irradiate with the ultraviolet light having a wavelength of 390 nm or less is preferable, and to irradiate with light having a wavelength of 250 to 370 nm is most preferable. However, in a case where the polymerizable composition is decomposed with the ultraviolet light of 390 nm or less, it may be preferable to carry out polymerization treatment with ultraviolet light of 390 nm or more. It is preferable that this light is a diffused light and is an unpolarized light. The intensity of the ultraviolet ray irradiation is preferably in a range of 0.05 kW/m² to 10 kW/m². In particular, a range of 0.2 kW/m² to 2 kW/m² is preferable. In a case where the intensity of the ultraviolet ray is less than 0.05 kW/m², it takes a lot of time to complete the polymerization. On the other hand, if the intensity is greater than 2 kW/m², the liquid crystal molecules of the polymerizable liquid crystal composition tend to be photo-decomposed, and a lot of polymerization heat is generated, the temperature during polymerization increases, and the order parameter of the polymerizable liquid crystal changes, and thus there is a possibility that the deviation of the retardation of the film occurs after polymerization.

An optical anisotropic body having a plurality of regions having different alignment directions may be obtained by changing the alignment state of the unpolymerized part by applying the electric field, the magnetic field, the temperature, or the like and then polymerizing the unpolymerized part after only a specific part using mask is polymerized by the ultraviolet ray irradiation.

Further, an optical anisotropic body having a plurality of regions having different alignment directions may be obtained by regulating the alignment of the polymerizable liquid crystal composition of the unpolymerized state by previously applying the electric field, the magnetic field, the temperature, or the like to the composition and then polymerizing the unpolymerized part by irradiation with light from the mask while maintaining the state, when polymerizing only a specific part using mask by the ultraviolet ray irradiation.

The optical anisotropic body obtained by polymerizing the polymerizable liquid crystal composition of the present invention may be used alone as an optical anisotropic body which is peeled off from the substrate and may also be used as an optical anisotropic body as it is which is not peeled off from the substrate. In particular, since other members are hardly contaminated, it is useful in a case where the optical anisotropic body is used as a substrate to be layered or is used to be bonded to another substrate.

(Applications)

The polymer obtained by polymerizing the polymerizable liquid crystal composition of the application of the present invention in a state of being in a horizontal alignment, a vertical alignment, a hybrid alignment, or a cholesteric alignment, may be used as an optical compensation film, a retardation film, a film with expanded viewing angle, a film with enhanced luminance, a reflective film, a polarizing film, and an optical information recording material as an optical anisotropic body having alignment properties. Further, the polymer may be used as an adhesive having heat dissipation properties, a sealant, a heat dissipation sheet, and inks for security printing.

### EXAMPLES

Hereinafter, the present invention will be described by Synthesis Examples, Examples, and Comparative Examples, but the present invention is not limited thereto as well. Further, “parts” and “%” are based on mass, unless otherwise specified. As the raw compounds of the compound having a mesogenic group, compounds represented by the following Formulas (A1) to (A13), Formulas (B1) to (B10), and Formulas (C1) to (C6) were used.

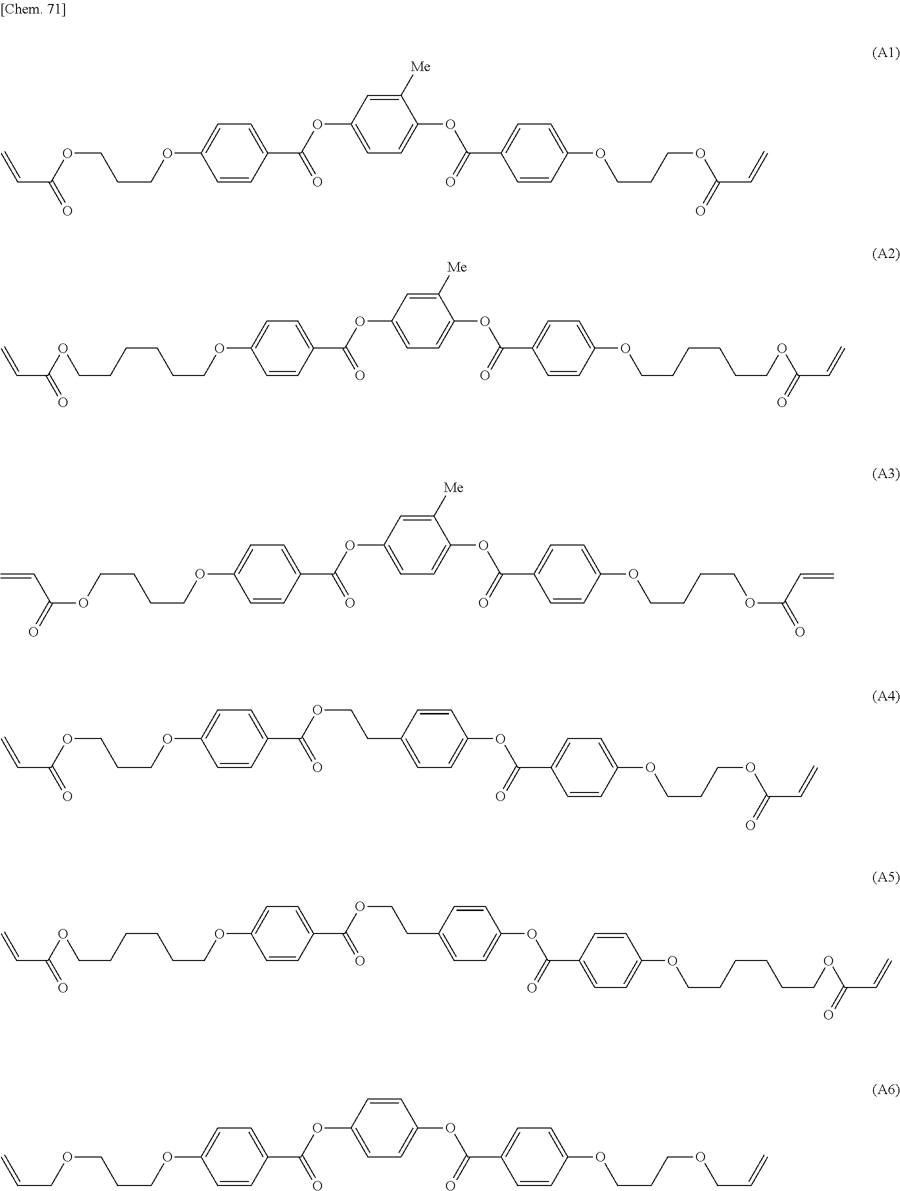

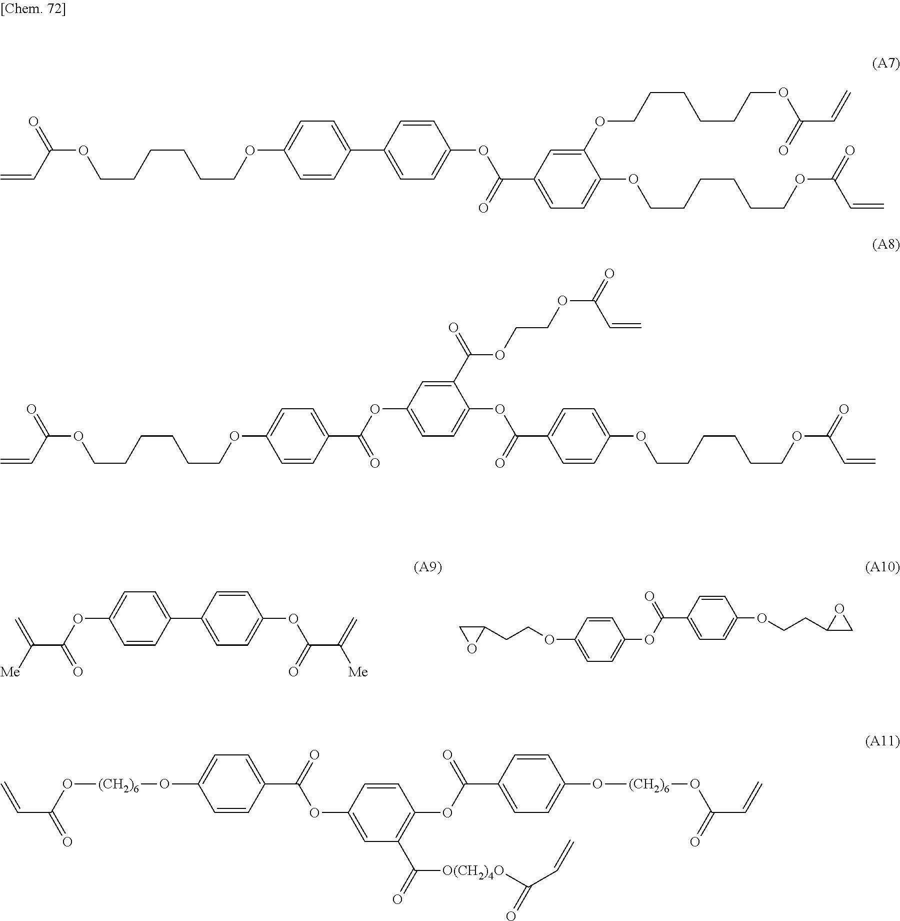

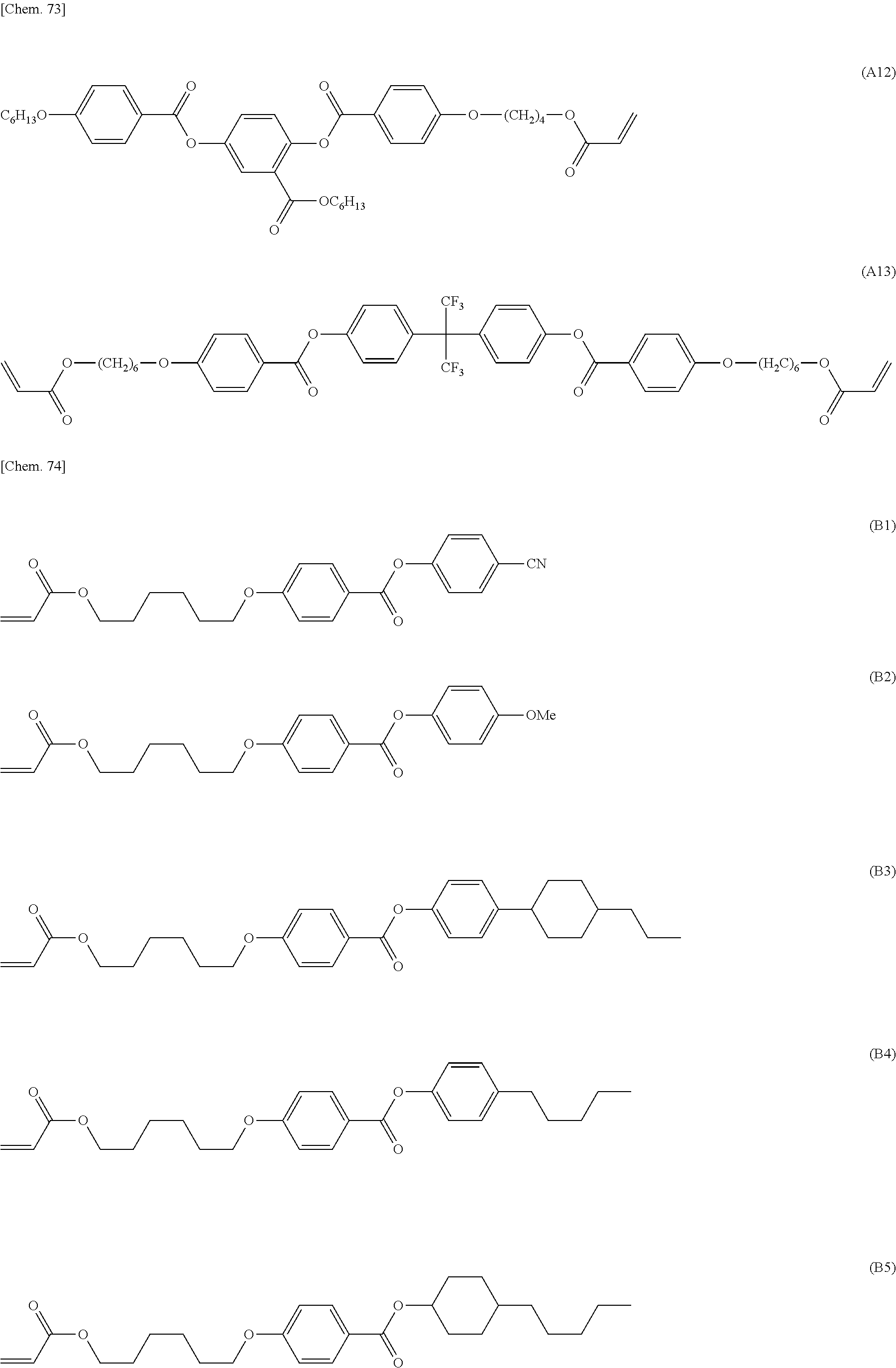

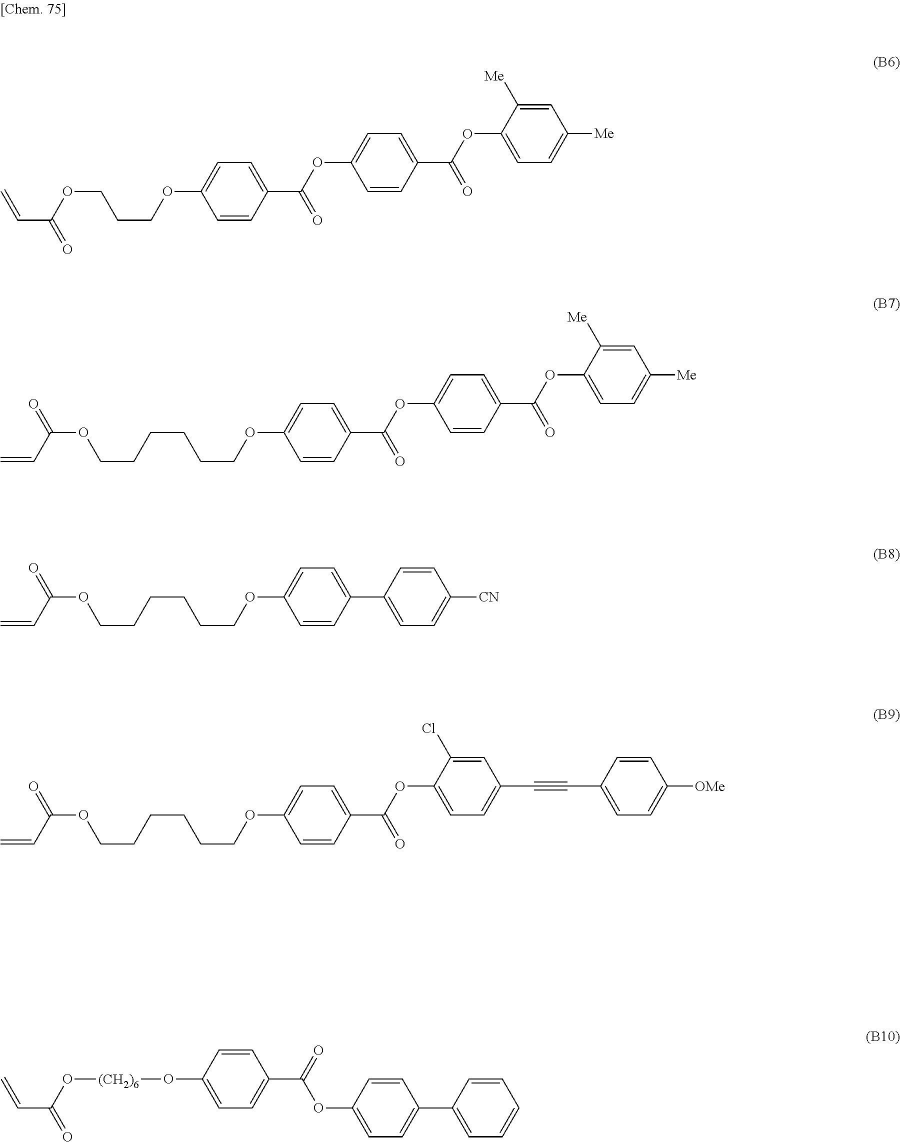

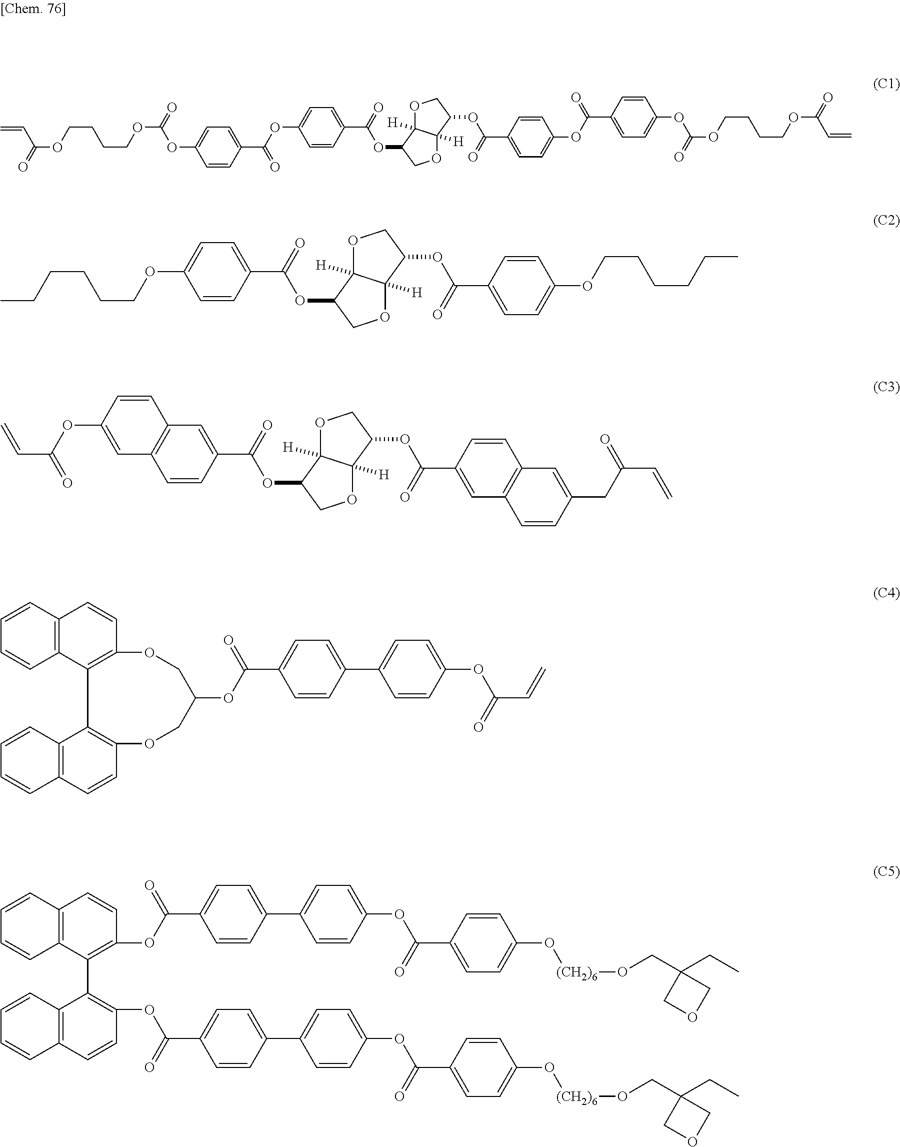

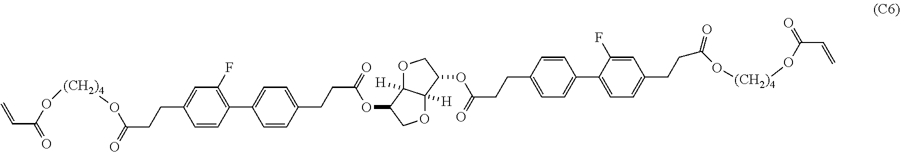

Propylene glycol 1-monomethyl ether 2-acetate (D1)

p-methoxyphenol (E1)

IRGACURE 907 (G1)

IRGACURE 651 (G2)

IRGACURE 251 (G3)

ANTHRACURE UVS-1331 (G4) Polypropylene (weight average molecular weight (MW): 1275) (H1)

<Measurement of YI/αn>

The yellowness indexes of the compounds represented by Formulas (A1) to (A11), and Formulas (B1) to (B11) were measured as follows. Further, for each compound represented by Formulas (A1) to (A4), Formula (A8), Formula (A10), and Formulas (B1) to (B5), compounds that have different purification degrees were prepared and YI/Δn was measured on each of the compounds that have different purification degree.

A compound which is a measurement object was dissolved in a solvent so as to be 20% solution. Here, tetrahydrofuran solution was used as a solvent. The yellowness index was calculated using a spectrophotometer by putting the solution in a transparent cell having an optical path length of 1 cm.

In addition, the compound which is a measurement object was added to the host liquid crystal to prepare a liquid crystal composition. A glass cell was generated by using glass substrates in which a polyimide alignment film is attached, by combining the two glass substrates such that the substrates are parallel to the rubbing directions of the polyimide alignment films were parallel to each other. The film was obtained by being peeled off from the glass cell after injecting the liquid crystal composition to the glass cell and curing by irradiation with ultraviolet rays (illuminance of 800 mJ/cm²). Then, the refractive index anisotropy (Δn) was calculated by measuring the ne and no of the film using Abbe's refractometer and extrapolating the measured values.

The value of YI/Δn was calculated by dividing the obtained yellowness index of each compound represented by the Formula (A1) to Formula (A13), and Formula (B1) to Formula (B10) by the value of Δn of each compound.

### Examples 1 to 30 and Comparative Examples 1 to 30

### Preparation of Liquid Crystal Composition of Example 1

As the compound having a mesogenic group in the polymerizable liquid crystal composition, a material (M1) containing a proportion of 34% of the compound represented by Formula (A1), 10% of the compound represented by Formula (A2), 28% of the compound represented by Formula (B1), and 28% of the compound represented by Formula (B2) was prepared. The value of YI/Δn of each compound is shown in Table 1. The yellowness index of the material, that is, the material (M1) in which all the compounds having mesogenic groups in the polymerizable liquid crystal composition are combined was 2.24, and YI/Δn was 15.7. In addition, the yellowness index of the material (M1) was measured by dissolving the material (M1) in tetrahydrofuran solution so as to be 20% solution in the same manner as in the measurement method of the above compounds. Further, the refractive index anisotropy of the material (M1) was measured by adding the material M1 to the host liquid crystal to prepare a liquid crystal composition in the same manner as in the measurement method of the above compounds. The YI/Δn of the material (M1) was calculated by dividing the value obtained through measuring by the refractive index anisotropy (Δn) of the material (M1).

100 parts of the material (M1), 300 parts of propylene glycol 1-monomethyl ether 2-acetate (PGEMA) (D1) as an organic solvent, 0.1 parts of p-methoxyphenol (E1), parts of IRGACURE 907 (G1), and 0.2 parts of polypropylene (weight average molecular weight (MW): 1275) (H1) were stirred for 1 hour under a condition that the stirring speed is 500 rpm and the solution temperature is 60° C. by using a stirring apparatus having a stirring propeller to obtain a liquid crystal composition of Example 1.

<Preparation of Liquid Crystal Composition of Examples 2 to 21 and Comparative Examples 1 to 21>

Material (M2) to Material (M60) containing the compounds represented by Formula (A1) to Formula (A13) and Formulas (B1) to (B10) in proportions shown in Table 1 to Table 16 were prepared in the same manner as in the preparation of the liquid crystal composition of Example 1. In addition, the value of YI and the value of YI/Δn of the material (M2) to Material (M60) were measured in the same manner as for the material (M1).

The liquid crystal compositions of Examples 2 to 11 and 14 to 17 and Comparative Examples 1 to 11 and 14 to 17 were obtained in the same manner as in the preparation of the liquid crystal composition of Example 1 except for respectively using the materials (M2) to (M11), (M14) to (M17), (M31) to (M41), and (M44) to (M47) instead of the material (M1) in the liquid crystal composition of Example 1.

In addition, the liquid crystal compositions of Examples 13 and 22 to 28 and Comparative Examples 13 and to 28 were obtained in the same manner as in the preparation of the liquid crystal composition of Example 1 except for respectively using the materials (M13), (M22) to (M28), (M43), and (M52) to (M58) instead of the material (M1) in the liquid crystal composition of Example 1, and further using 0.1 parts of (H1).

Further, the liquid crystal compositions of Example 12 and Comparative Example 12 were obtained in the same manner as in the preparation of the liquid crystal composition of Example 1 except for respectively using the materials (M12) and (M42) instead of the material (M1) in the liquid crystal composition of Example 1, and further adding 11.0 parts of the material (C6).

Further, the liquid crystal composition of Example 18 was obtained in the same manner as in the preparation of the liquid crystal composition of Example 1 except for using the material (M18) instead of the material (M1) in the liquid crystal composition of Example 1, using 2 parts of IRGACURE 651 (G2), 2 parts of IRGACURE 251 (G3), and 1 part of ANTHRACURE UVS-1331 (G4) instead of 5 parts of IRGACURE 907 (G1), and further adding 11.0 parts of the material (C5).

Further, the liquid crystal composition of Comparative Example 18 was obtained in the same manner as in the preparation of the liquid crystal composition of Example 1 except for using the material (M48) instead of the material (M1) in the liquid crystal composition of Example 1, using 0.3 parts of (H1), and further adding 11.0 parts of the material (C5).

Further, the liquid crystal compositions of Example 19 and Comparative Example 19 were obtained in the same manner as in the preparation of the liquid crystal composition of Example 1 except for respectively using the material (M19) and the material (M49) instead of the material (M1) in the liquid crystal composition of Example 1, and further adding 12.0 parts of the material (C1).

Further, the liquid crystal compositions of Example 20 and Comparative Example 20 were obtained in the same manner as in the preparation of the liquid crystal composition of Example 1 except for respectively using the material (M20) and the material (M50) instead of the material (M1) in the liquid crystal composition of Example 1, and further adding 8.0 parts of the material (C2).

Further, the liquid crystal compositions of Example 21 and Comparative Example 21 were obtained in the same manner as in the preparation of the liquid crystal composition of Example 1 except for respectively using the material (M21) and the material (M51) instead of the material (M1) in the liquid crystal composition of Example 1, and further adding 8.0 parts of the material (C3).

Further, the liquid crystal compositions of Example 29 and Comparative Example 29 were obtained in the same manner as in the preparation of the liquid crystal composition of Example 1 except for respectively using the material (M29) and the material (M59) instead of the material (M1) in the liquid crystal composition of Example 1, using 0.1 parts of (H1), and further adding 5.0 parts of the material (C4).

Further, the liquid crystal compositions of Example 30 and Comparative Example 30 were obtained in the same manner as in the preparation of the liquid crystal composition of Example 1 except for respectively using the material (M30) and the material (M60) instead of the material (M1) in the liquid crystal composition of Example 1, using 0.1 parts of (H1), and further adding 8.0 parts of the material (C3).

Hereinafter, the composition and the value of YI/Δn of the material M1 are shown.

TABLE 1

| | Material (M1) | | | Material (M2) | | | Material (M3) | | | Material (M4) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 34.0% | 0.80 | 4.6 | 34.0% | 15.20 | 86.9 | | | | | | |
| A2 | 10.0% | 6.20 | 38.8 | 10.0% | 6.20 | 38.8 | 32.0% | 6.20 | 38.8 | 32.0% | 6.20 | 38.8 |
| B1 | 28.0% | 0.40 | 3.1 | 28.0% | 0.40 | 3.1 | 28.0% | 0.40 | 3.1 | 28.0% | 0.40 | 3.1 |
| B2 | 28.0% | 4.40 | 40.0 | 28.0% | 4.40 | 40.0 | 12.0% | 4.40 | 40.0 | 12.0% | 27.80 | 252.7 |
| B3 | | | | | | | 28.0% | 5.50 | 39.3 | 28.0% | 5.50 | 39.3 |
| Material | 100.0% | 2.24 | 15.7 | 100.0% | 7.13 | 50 | 100.0% | 4.16 | 29.7 | 100.0% | 6.97 | 49.8 |
| (M) | | | | | | | | | | | | |

TABLE 2

| | Material (M5) | | | Material (M6) | | | Material (M7) | | | Material (M8) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 40.0% | 0.80 | 4.6 | 40.0% | 6.95 | 39.7 | 11.0% | 0.80 | 4.6 | 19.0% | 0.80 | 4.6 |
| A2 | 10.0% | 6.20 | 38.8 | 10.0% | 21.50 | 134.4 | 19.0% | 6.20 | 38.8 | 21.0% | 6.20 | 38.8 |
| B1 | 25.0% | 0.40 | 3.1 | 25.0% | 5.00 | 38.5 | 26.0% | 0.40 | 3.1 | 20.0% | 0.40 | 3.1 |
| B2 | 25.0% | 4.40 | 40.0 | 25.0% | 4.40 | 40.0 | 27.0% | 4.40 | 40.0 | | | |
| B3 | | | | | | | | | | 30.0% | 5.50 | 39.3 |
| B4 | | | | | | | 8.5% | 4.00 | 33.3 | | | |
| B5 | | | | | | | 8.5% | 2.00 | 18.2 | | | |
| B8 | | | | | | | | | | 10.0% | 4.50 | 22.6 |
| Material | 100.0% | 2.14 | 14.7 | 100.0% | 7.28 | 49.9 | 100.0% | 3.07 | 23.1 | 100.0% | 3.63 | 23.5 |
| (M) | | | | | | | | | | | | |

TABLE 3

| | Material (M9) | | | Material (M10) | | | Material (M11) | | | Material (M12) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 19.0% | 0.80 | 4.6 | 10.0% | 0.80 | 4.6 | 35.0% | 0.80 | 4.6 | 56.0% | 0.80 | 4.6 |
| A2 | 21.0% | 6.20 | 38.8 | | | | | | | | | |
| A3 | | | | 40.0% | 0.60 | 3.5 | 35.0% | 0.60 | 3.5 | | | |
| A4 | | | | 25.0% | 0.20 | 1.1 | | | | 22.0% | 0.20 | 1.1 |
| A5 | | | | 25.0% | 0.20 | 1.3 | | | | 22.0% | 0.20 | 1.3 |
| A6 | | | | | | | | | | | | |
| B1 | 20.0% | 0.40 | 3.1 | | | | | | | | | |
| B3 | 30.0% | 19.10 | 136.4 | | | | | | | | | |
| B6 | | | | | | | 12.5% | 0.60 | 3.3 | | | |
| B7 | | | | | | | 12.5% | 0.50 | 2.7 | | | |
| B8 | 10.0% | 4.50 | 22.6 | | | | 5.0% | 4.50 | 22.6 | | | |
| Material | 100.0% | 7.71 | 49.8 | 100.0% | 0.42 | 2.5 | 100.0% | 0.85 | 4.8 | 100.0% | 0.54 | 3.1 |
| (M) | | | | | | | | | | | | |

TABLE 4

| | Material (M13) | | | Material (M14) | | | Material (M15) | | | Material (M16) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | | | | | | | 34.0% | 0.80 | 4.6 | | | |
| A3 | | | | 60.0% | 0.20 | 0.2 | 10.0% | 0.60 | 3.5 | 50.0% | 0.60 | 3.5 |
| A4 | 43.0% | 0.20 | 1.1 | | | | | | | 10.0% | 0.20 | 1.1 |
| A5 | 43.0% | 0.20 | 1.3 | | | | | | | 10.0% | 0.20 | 1.3 |
| A6 | | | | | | | | | | 10.0% | 2.50 | 13.2 |
| A7 | | | | | | | | | | | | |
| A8 | | | | | | | | | | 20.0% | 5.60 | 40.0 |
| A9 | | | | | | | 28.0% | 0.40 | 3.3 | | | |
| A11 | | | | 20.0% | 4.00 | 30.8 | | | | | | |
| B1 | | | | 20.0% | 0.40 | 3.1 | | | | | | |
| B2 | | | | | | | 28.0% | 4.40 | 40.0 | | | |
| B8 | 14.0% | 4.50 | 22.6 | | | | | | | | | |
| Material | 100.0% | 0.80 | 4.7 | 100.0% | 1.24 | 8.1 | 100.0% | 1.68 | 11.9 | 100.0% | 1.71 | 10.3 |
| (M) | | | | | | | | | | | | |

TABLE 5

| | Material (M17) | | | Material (M18) | | | Material (M19) | | | Material (M20) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | | | | 22.0% | 0.80 | 4.6 | 55.0% | 0.80 | 4.6 | 56.0% | 0.80 | 4.6 |
| A2 | | | | | | | 12.0% | 6.20 | 38.8 | | | |
| A3 | | | | | | | | | | 12.0% | 0.60 | 3.5 |
| A4 | | | | | | | | | | | | |
| A5 | | | | | | | | | | | | |
| A7 | | | | | | | | | | | | |
| A9 | 30.0% | 0.40 | 3.3 | | | | 8.0% | 0.40 | 3.3 | 8.0% | 0.40 | 3.3 |
| A10 | | | | 67.0% | 0.20 | 1.0 | | | | | | |
| B1 | | | | 11.0% | 0.40 | 3.1 | 14.0% | 0.40 | 3.1 | 24.0% | 0.40 | 3.1 |
| B2 | | | | | | | 11.0% | 4.40 | 40.0 | | | |
| B4 | 35.0% | 4.00 | 33.3 | | | | | | | | | |
| B5 | 35.0% | 2.00 | 18.2 | | | | | | | | | |
| Material | 100.0% | 2.22 | 19.1 | 100.0% | 0.35 | 1.8 | 100.0% | 1.76 | 11.3 | 100.0% | 0.65 | 4.1 |
| (M) | | | | | | | | | | | | |

TABLE 6

| | Material (M21) | | | Material (M22) | | | Material (M23) | | |
|---|---|---|---|---|---|---|---|---|---|
| Compound | Composition | YI | YI/Δn | Composition | YI | YI/Δn | Composition | YI | YI/Δn |
| A1 | 42.0% | 0.80 | 4.6 | 40.0% | 0.80 | 4.6 | 40.0% | 0.15 | 0.9 |
| A3 | 33.0% | 0.60 | 3.5 | | | | | | |
| B1 | | | | 20.0% | 0.40 | 3.1 | 10.0% | 0.60 | 4.6 |
| B3 | | | | 40.0% | 5.50 | 39.3 | 50.0% | 0.10 | 0.7 |
| B7 | 25.0% | 0.50 | 2.7 | | | | | | |
| Material | 100.0% | 0.66 | 3.7 | 100.0% | 2.60 | 1.7 | 100.0% | 0.17 | 1.1 |
| (M) | | | | | | | | | |

TABLE 7

| | Material (M24) | | | Material (M25) | | | Material (M26) | | |
|---|---|---|---|---|---|---|---|---|---|
| Compound | Composition | YI | YI/Δn | Composition | YI | YI/Δn | Composition | YI | YI/Δn |
| A1 | 60.0% | 0.15 | 0.9 | | | | | | |
| A2 | | | | | | | 30.0% | 6.20 | 38.8 |
| A4 | | | | 50.0% | 0.20 | 1.1 | | | |
| A5 | | | | 50.0% | 0.20 | 1.3 | | | |
| A10 | | | | | | | | | |
| A12 | | | | | | | 45.0% | 5.40 | 41.5 |
| A13 | | | | | | | 25.0% | 0.60 | 3.0 |
| B1 | 30.0% | 0.12 | 0.9 | | | | | | |
| B3 | 10.0% | 5.50 | 39.3 | | | | | | |
| Material | 100.0% | 0.68 | 4.3 | 100.0% | 0.20 | 1.2 | 100.0% | 4.44 | 28.4 |
| (M) | | | | | | | | | |

TABLE 8

| | Material (M27) | | | Material (M28) | | | Material (M29) | | | Material (M30) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 15.0% | 0.80 | 4.6 | 15.0% | 0.80 | 4.6 | 21.0% | 0.80 | 4.6 | | | |
| A2 | 29.7% | 6.20 | 38.8 | 29.7% | 6.20 | 38.8 | 5.0% | 6.20 | 38.8 | 42.0% | 6.20 | 38.8 |
| A4 | | | | | | | | | | 33.0% | 0.20 | 1.1 |
| A11 | 0.3% | 0.20 | 1.5 | 0.3% | 0.20 | 1.5 | | | | | | |
| B1 | 20.0% | 0.40 | 3.1 | 20.0% | 0.40 | 3.1 | | | | | | |
| B2 | 10.0% | 4.40 | 40.0 | 10.0% | 37.00 | 336.4 | | | | | | |
| B3 | 25.0% | 5.50 | 39.3 | 25.0% | 5.50 | 39.3 | | | | | | |
| B10 | | | | | | | | | | 25.0% | 0.60 | 3.3 |
| B11 | | | | | | | 74.0% | 6.50 | 24.6 | | | |
| Material | 100.0% | 3.86 | 26.4 | 100.0% | 7.12 | 48.7 | 100.0% | 5.29 | 22.0 | 100.0% | 2.82 | 22.6 |
| (M) | | | | | | | | | | | | |

TABLE 9

| | Material (M31) | | | Material (M32) | | | Material (M33) | | | Material (M34) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 34.0% | 15.30 | 87.4 | 34.0% | 15.30 | 87.4 | | | | | | |
| A2 | 10.0% | 6.20 | 38.8 | 10.0% | 6.20 | 38.8 | 32.0% | 15.80 | 98.8 | 32.0% | 15.80 | 98.8 |
| B1 | 28.0% | 0.40 | 3.1 | 28.0% | 2.50 | 19.2 | 28.0% | 0.40 | 3.1 | 28.0% | 5.50 | 42.3 |
| B2 | 28.0% | 4.40 | 40.0 | 28.0% | 4.40 | 40.0 | 12.0% | 4.40 | 40.0 | 12.0% | 4.40 | 40.0 |
| B3 | | | | | | | 28.0% | 5.50 | 39.3 | 28.0% | 5.50 | 39.3 |
| Material | 100.0% | 7.17 | 50.2 | 100.0% | 7.75 | 54.3 | 100.0% | 7.24 | 51.7 | 100.0% | 8.66 | 61.9 |
| (M) | | | | | | | | | | | | |

TABLE 10

| | Material (M35) | | | Material (M36) | | | Material (M37) | | | Material (M38) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 40.0% | 13.80 | 78.9 | 40.0% | 13.80 | 78.9 | 11.0% | 34.10 | 194.9 | 19.0% | 0.80 | 4.6 |
| A2 | 10.0% | 6.20 | 38.8 | 10.0% | 6.20 | 38.8 | 19.0% | 6.20 | 38.8 | 21.0% | 6.20 | 38.8 |
| B1 | 25.0% | 0.40 | 3.1 | 25.0% | 15.00 | 115.4 | 26.0% | 0.40 | 3.1 | 20.0% | 0.40 | 3.1 |
| B2 | 25.0% | 4.40 | 40.0 | 25.0% | 4.40 | 40.0 | 27.0% | 4.40 | 40.0 | | | |
| B3 | | | | | | | | | | 30.0% | 20.00 | 142.9 |
| B4 | | | | | | | 8.5% | 4.00 | 33.3 | | | |
| B5 | | | | | | | 8.5% | 2.00 | 18.2 | | | |
| B8 | | | | | | | | | | 10.0% | 4.50 | 22.6 |
| Material | 100.0% | 7.34 | 50.3 | 100.0% | 10.99 | 75.3 | 100.0% | 6.73 | 50.7 | 100.0% | 7.98 | 51.6 |
| (M) | | | | | | | | | | | | |

TABLE 11

| | Material (M39) | | | Material (M40) | | | Material (M41) | | | Material (M42) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 19.0% | 0.80 | 4.6 | 10.0% | 0.80 | 4.6 | 35.0% | 24.70 | 141.1 | 56.0% | 24.70 | 141.1 |
| A2 | 21.0% | 6.20 | 38.8 | | | | | | | | | |
| A3 | | | | 40.0% | 21.50 | 126.5 | 35.0% | 0.60 | 3.5 | | | |
| A4 | | | | 25.0% | 0.20 | 1.1 | | | | 22.0% | 0.20 | 1.1 |
| A5 | | | | 25.0% | 0.20 | 1.3 | | | | 22.0% | 0.20 | 1.3 |
| A6 | | | | | | | | | | | | |
| B1 | 20.0% | 20.50 | 157.7 | | | | | | | | | |
| B3 | 30.0% | 20.00 | 142.9 | | | | | | | | | |
| B6 | | | | | | | 15.0% | 0.60 | 3.3 | | | |
| B7 | | | | | | | 15.0% | 0.50 | 2.7 | | | |
| B8 | 10.0% | 4.50 | 22.6 | | | | | | | | | |
| Material | 100.0% | 12.00 | 77.6 | 100.0% | 8.78 | 51.9 | 100.0% | 9.02 | 51.2 | 100.0% | 13.92 | 81.1 |
| (M) | | | | | | | | | | | | |

TABLE 12

| | Material (M43) | | | Material (M44) | | | Material (M45) | | | Material (M46) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | | | | | | | 34.0% | 12.10 | 69.1 | | | |
| A3 | | | | 60.0% | 20.00 | 117.6 | 10.0% | 6.75 | 39.7 | 50.0% | 15.00 | 88.2 |
| A4 | 43.0% | 18.70 | 106.9 | | | | | | | 10.0% | 0.20 | 1.1 |
| A5 | 43.0% | 0.20 | 1.3 | | | | | | | 10.0% | 0.20 | 1.3 |
| A6 | | | | | | | | | | 10.0% | 2.50 | 13.2 |
| A7 | | | | | | | | | | | | |
| A8 | | | | | | | | | | 20.0% | 5.60 | 40.0 |
| A9 | | | | | | | 28.0% | 4.75 | 39.6 | | | |
| A11 | | | | 20.0% | 4.00 | 30.8 | | | | | | |
| B1 | | | | 20.0% | 0.40 | 3.1 | | | | | | |
| B2 | | | | | | | 28.0% | 4.38 | 39.8 | | | |
| B8 | 14.0% | 4.50 | 22.6 | | | | | | | | | |
| Material | 100.0% | 8.76 | 50.9 | 100.0% | 12.88 | 83.6 | 100.0% | 7.35 | 52.1 | 100.0% | 8.91 | 53.8 |
| (M) | | | | | | | | | | | | |

TABLE 13

| | Material (M47) | | | Material (M48) | | | Material (M49) | | | Material (M50) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | | | | 22.0% | 0.15 | 0.9 | 55.0% | 7.50 | 42.9 | 56.0% | 15.00 | 85.7 |
| A2 | | | | | | | 12.0% | 6.20 | 38.8 | | | |
| A3 | | | | | | | | | | 12.0% | 0.60 | 3.5 |
| A4 | | | | | | | | | | | | |
| A5 | | | | | | | | | | | | |
| A7 | | | | | | | | | | | | |
| A9 | 30.0% | 0.40 | 3.3 | | | | 8.0% | 5.50 | 45.8 | 8.0% | 0.40 | 3.3 |
| A10 | | | | 67.0% | 0.10 | 0.5 | | | | | | |
| B1 | | | | 11.0% | 0.40 | 3.1 | 14.0% | 14.70 | 113.1 | 24.0% | 0.40 | 3.1 |
| B2 | | | | | | | 11.0% | 4.40 | 40.0 | | | |
| B4 | 35.0% | 11.50 | 95.8 | | | | | | | | | |
| B5 | 35.0% | 4.90 | 44.5 | | | | | | | | | |
| Material | 100.0% | 5.86 | 50.3 | 100.0% | 0.14 | 0.7 | 100.0% | 7.85 | 50.5 | 100.0% | 8.60 | 54.0 |
| (M) | | | | | | | | | | | | |

TABLE 14

| | Material (M51) | | | Material (M52) | | | Material (M53) | | |
|---|---|---|---|---|---|---|---|---|---|
| Compound | Composition | YI | YI/Δn | Composition | YI | YI/Δn | Composition | YI | YI/Δn |
| A1 | 42.0% | 21.00 | 120.0 | 40.0% | 0.80 | 4.6 | 40.0% | 0.15 | 0.9 |
| A3 | 33.0% | 0.60 | 3.5 | | | | | | |
| B1 | | | | 20.0% | 32.00 | 246.2 | 10.0% | 0.30 | 2.3 |
| B3 | | | | 40.0% | 5.50 | 39.3 | 50.0% | 0.10 | 0.7 |
| B7 | 25.0% | 0.50 | 2.7 | | | | | | |
| Material | 100.0% | 9.14 | 52.0 | 100.0% | 8.92 | 58.7 | 100.0% | 0.14 | 0.9 |
| (M) | | | | | | | | | |

TABLE 15

| | Material (M54) | | | Material (M55) | | | Material (M56) | | |
|---|---|---|---|---|---|---|---|---|---|
| Compound | Composition | YI | YI/Δn | Composition | YI | YI/Δn | Composition | YI | YI/Δn |
| A1 | 60.0% | 0.15 | 0.9 | | | | 30.0% | 20.00 | 114.3 |
| A4 | | | | 50.0% | 16.70 | 95.4 | | | |
| A5 | | | | 50.0% | 0.00 | 1.3 | | | |
| A10 | | | | | | | | | |
| A12 | | | | | | | 45.0% | 5.40 | 41.5 |
| A13 | | | | | | | 25.0% | 0.60 | 3.0 |
| B1 | 30.0% | 0.12 | 0.9 | | | | | | |
| B3 | 10.0% | 0.20 | 1.4 | | | | | | |
| Material | 100.0% | 0.15 | 0.9 | 100.0% | 8.45 | 50.4 | 100.0% | 9.79 | 50.3 |
| (M) | | | | | | | | | |

TABLE 16

| | Material (M57) | | | Material (M58) | | | Material (M59) | | | Material (M60) | | |
|---|---|---|---|---|---|---|---|---|---|---|---|---|
| Compound | Composition | YI | YI/Δn | Composition | YI | YI/Δn | Composition | YI | YI/Δn | Composition | YI | YI/Δn |
| A1 | 15.0% | 0.80 | 4.6 | 15.0% | 0.10 | 0.6 | 21.0% | 0.80 | 4.6 | | | |
| A2 | 29.7% | 6.20 | 38.8 | 29.7% | 0.10 | 0.6 | 5.0% | 6.20 | 38.8 | 42.0% | 0.03 | 0.2 |
| A4 | | | | | | | | | | 33.0% | 0.40 | 0.1 |
| A11 | 0.3% | 0.20 | 1.5 | 0.3% | 0.20 | 1.5 | | | | | | |
| B1 | 20.0% | 0.40 | 3.1 | 20.0% | 0.05 | 0.4 | | | | | | |
| B2 | 10.0% | 40.00 | 363.6 | 10.0% | 0.10 | 0.9 | | | | | | |
| B3 | 25.0% | 5.50 | 39.3 | 25.0% | 0.10 | 0.7 | | | | | | |
| B10 | | | | | | | | | | 25.0% | 0.03 | 0.2 |
| B11 | | | | | | | 74.0% | 17.20 | 65.2 | | | |
| Material | 100.0% | 7.42 | 50.7 | 100.0% | 0.09 | 0.6 | 100.0% | 13.21 | 55.0 | 100% | 0.09 | 0.7 |
| (M) | | | | | | | | | | | | |

### <Evaluation of Storage Stability of Liquid Crystal Composition>

The increasing rate of the polymer component and viscosity increasing rate were measured by storing the solution of the liquid crystal composition of Examples 1 to 30 and Comparative Examples 1 to 30 at 50° C. for one month in order to evaluate the storage stability. The increasing rate of the polymer component was calculated by the following expression by measuring each amount of the polymer component before and after storage, {(Amount of polymer component after storage)−(Amount of polymer component before storage)}/(Amount of polymer component before storage)}×100. The measurement of the polymer component was carried out by a GPC apparatus.

The viscosity increasing rate was calculated by the following expression by measuring each viscosity before and after storage, {(Viscosity after storage)−(Viscosity before storage)}/(Viscosity before storage)}×100. The measurement of viscosity was carried out by an E-type viscometer. These results are shown in Table 17 and Table 18.

TABLE 17

| | | | Polymer | Viscosity |
|---|---|---|---|---|
| | | Material (M) | increasing | increasing |
| | Material | YI/Δn | rate | rate |
| Example 1 | M1 | 15.7 | 1.0% | 1.0% |
| Example 2 | M2 | 50 | 5.0% | 4.0% |
| Example 3 | M3 | 29.7 | 3.0% | 2.0% |
| Example 4 | M4 | 49.8 | 4.0% | 3.0% |
| Example 5 | M5 | 14.7 | 1.0% | 1.0% |
| Example 6 | M6 | 49.9 | 4.0% | 3.0% |
| Example 7 | M7 | 23.1 | 2.0% | 1.0% |
| Example 8 | M8 | 23.5 | 2.0% | 1.0% |
| Example 9 | M9 | 49.8 | 5.0% | 4.0% |
| Example 10 | M10 | 2.5 | 3.0% | 2.0% |
| Example 11 | M11 | 4.8 | 3.0% | 2.0% |
| Example 12 | M12 | 3.1 | 3.0% | 2.0% |
| Example 13 | M13 | 4.7 | 3.0% | 2.0% |
| Example 14 | M14 | 8.1 | 3.0% | 2.0% |
| Example 15 | M15 | 11.9 | 1.0% | 1.0% |
| Example 16 | M16 | 10.3 | 1.0% | 1.0% |
| Example 17 | M17 | 19.1 | 1.0% | 1.0% |
| Example 18 | M18 | 1.8 | 3.0% | 2.0% |
| Example 19 | M19 | 11.3 | 1.0% | 1.0% |
| Example 20 | M20 | 4.1 | 3.0% | 2.0% |
| Example 21 | M21 | 3.7 | 3.0% | 2.0% |
| Example 22 | M22 | 17.1 | 1.0% | 1.0% |
| Example 23 | M23 | 1.1 | 3.0% | 2.0% |
| Example 24 | M24 | 4.3 | 3.0% | 2.0% |
| Example 25 | M25 | 1.2 | 3.0% | 2.0% |
| Example 26 | M26 | 28.4 | 3.0% | 2.0% |
| Example 27 | M27 | 26.4 | 2.0% | 1.0% |
| Example 28 | M28 | 48.7 | 4.0% | 3.0% |
| Example 29 | M29 | 22 | 3.0% | 2.0% |
| Example 30 | M30 | 22.6 | 1.0% | 1.0% |

TABLE 18

| | | | Polymer | Viscosity |
|---|---|---|---|---|
| | | Material (M) | increasing | increasing |
| | Material | YI/Δn | rate | rate |
| Comparative | M31 | 50.2 | 7.0% | 6.0% |
| Example 1 | | | | |
| Comparative | M32 | 54.3 | 9.0% | 8.0% |
| Example 2 | | | | |
| Comparative | M33 | 51.7 | 7.0% | 6.0% |
| Example 3 | | | | |
| Comparative | M34 | 61.9 | 10.0% | 9.0% |
| Example 4 | | | | |
| Comparative | M35 | 50.3 | 7.0% | 6.0% |
| Example 5 | | | | |
| Comparative | M36 | 75.3 | 13.0% | 12.0% |
| Example 6 | | | | |
| Comparative | M37 | 50.7 | 7.0% | 6.0% |
| Example 7 | | | | |
| Comparative | M38 | 51.6 | 7.0% | 6.0% |
| Example 8 | | | | |
| Comparative | M39 | 77.6 | 15.0% | 13.0% |
| Example 9 | | | | |
| Comparative | M40 | 51.9 | 7.0% | 6.0% |
| Example 10 | | | | |
| Comparative | M41 | 51.2 | 7.0% | 6.0% |
| Example 11 | | | | |
| Comparative | M42 | 81.1 | 14.0% | 12.0% |
| Example 12 | | | | |
| Comparative | M43 | 50.9 | 7.0% | 6.0% |
| Example 13 | | | | |
| Comparative | M44 | 83.6 | 15.0% | 13.0% |
| Example 14 | | | | |
| Comparative | M45 | 52.1 | 7.0% | 6.0% |
| Example 15 | | | | |
| Comparative | M46 | 53.8 | 9.0% | 8.0% |
| Example 16 | | | | |
| Comparative | M47 | 50.3 | 7.0% | 6.0% |
| Example 17 | | | | |
| Comparative | M48 | 0.7 | 7.0% | 6.0% |
| Example 18 | | | | |
| Comparative | M49 | 50.5 | 7.0% | 6.0% |
| Example 19 | | | | |
| Comparative | M50 | 54 | 9.0% | 8.0% |
| Example 20 | | | | |
| Comparative | M51 | 52 | 7.0% | 6.0% |
| Example 21 | | | | |
| Comparative | M52 | 58.7 | 10.0% | 9.0% |
| Example 22 | | | | |
| Comparative | M53 | 0.9 | 7.0% | 5.0% |
| Example 23 | | | | |
| Comparative | M54 | 0.9 | 7.0% | 5.0% |
| Example 24 | | | | |
| Comparative | M55 | 50.4 | 7.0% | 6.0% |
| Example 25 | | | | |
| Comparative | M56 | 53.3 | 7.0% | 6.0% |
| Example 26 | | | | |
| Comparative | M57 | 50.7 | 7.0% | 6.0% |
| Example 27 | | | | |
| Comparative | M58 | 0.6 | 7.0% | 5.0% |
| Example 28 | | | | |
| Comparative | M59 | 55 | 9.0% | 8.0% |
| Example 29 | | | | |
| Comparative | M60 | 0.7 | 7.0% | 5.0% |
| Example 30 | | | | |

From Table 17 and Table 18, it was found that the polymer increasing rate was small and the viscosity increasing rate was small in Examples 1 to 29 in which the value of YI/Δn of the material (M) is in the range of 1.0 to 50.0.

<Preparation of Film for Evaluating Adhesiveness>

The polymerizable liquid crystal compositions of Examples 1 to 30 and Comparative Examples 1 to 30 were applied onto the TAC film substrate with a bar coater #3 at room temperature, and dried at 80° C. for 2 minutes. Then, films of Examples 1 to 30 and Comparative Examples 1 to 30 were obtained by standing the resultant at room temperature for 2 minutes, and irradiating the resultant with UV light to set the illuminance to be 500 mJ/cm² by using a conveyor type high-pressure mercury lamp.

<Evaluation of Adhesiveness>

The Adhesiveness of the film obtained by the above was measured by putting cuts into the film in a grid pattern with a cutter to make a grid of 2 mm square using a cross-cut method which uses a cutter and is in accordance with JIS K5600-5-6.

Classification 0: There was no peeling on any grid.

Classification 1: Small peeling of a coating film was confirmed in the intersection of the cuts (less than 5%).

Classification 2: The coating film was peeled off at the intersection of the cuts along the lines of the cuts (5% or more and less than 15%).

Classification 3: The coating film was peeled partially or fully off along the lines of the cuts (15% or more and less than 35%).

Classification 4: The coating film was peeled partially or fully largely off along the lines of the cut (35% or more and less than 65%).

Classification 5: Classification 4 or more The results are shown in Table 19 and Table 20.

<Preparation of Film for Evaluating Reliability Test>

The polyimide solution for the alignment film was applied on the glass substrate having a thickness of 0.7 mm with a spin coating method at room temperature, dried at 100° C. for 10 minutes, and then baked at 200° C. for 60 minutes to obtain a coating film. The obtained coating film was subjected to rubbing treatment to obtain a substrate. The polymerizable liquid crystal compositions of Examples 1 to 30 and Comparative Examples 1 to 30 were applied onto the substrate with a spin coater at room temperature, and then dried at 80° C. for 2 minutes. Then, films of Examples 1 to 30 and Comparative Examples 1 to 30 were obtained by standing the resultant at room temperature for 2 minutes, and irradiating the resultant with UV light to set the illuminance to be 500 mJ/cm² by using a conveyor type high-pressure mercury lamp.

<Evaluation 1 of Reliability Test of Film>

In order to evaluate the occurrence easiness of discoloration due to reliability test in the film obtained by the above, the films of Examples 1 to 30, and Comparative Examples 1 to 30 were stored in a light resistance test machine (UV intensity of 500 W/m²) for one month. The degree of yellowness (ΔYI) was obtained by measuring each yellowness index (YI) of the film before storage and after storage. The yellowness index (YI) was calculated with the supplied color diagnostic program by measuring the absorption spectrum of the polymer in the spectrophotometer. Calculation Expression is as follows,

YI=100(1.28X−1.06Z)/Y

In the expression, YI represents yellowness index, and X, Y, and Z represent tristimulus values in the XYZ color system (JIS K 7373).

In addition, the degree of yellowness (ΔYI) refers to the difference between the initial yellowness index and the yellowness index after exposure (JIS K 7373).

A: Degree of yellowness (ΔYI) is less than 0.5

B: Degree of yellowness (ΔYI) is 0.5 or more and less than 1

C: Degree of yellowness (ΔYI) is 1 or more and less than 5

D: Degree of yellowness (ΔYI) is 5 or more

<Evaluation 2 of Discoloration of Film>

The films of Examples 1 to 29 and Comparative Examples 1 to 29 were stored in a dryer at 80° C. for one month. The degree of yellowness (ΔYI) was obtained by measuring each yellowness index (YI) of the film before storage and after storage in the same manner as in the method of Evaluation 1 of the discoloration of the film. The results are shown in Table 19 and Table 20.

<Evaluation of Repellence Degree at Time of Film Production>

After the solution of the liquid crystal compositions of Examples 1 to 30 and Comparative Examples 1 to 30 was stored at 50° C. for one month, the solution was applied onto TAC (triacetyl cellulose) film with a bar coater #4 at room temperature and then dried at 80° C. for 2 minutes. Then, after standing at room temperature for 2 minutes, the resultant was irradiated with UV light to set the illuminance to be 500 mJ/cm².

A: repellence was not observed at all

B: repellence was slightly observed

C: repellence was slightly a lot observed

D: repellence was so much observed

<Alignment Properties of Film>

The polyimide solution for the alignment film was applied on the glass substrate having a thickness of 0.7 mm with a spin coating method at room temperature, dried at 100° C. for 10 minutes, and then baked at 200° C. for 60 minutes to obtain a coating film. The obtained coating film was subjected to rubbing treatment to obtain a substrate. The solution of the liquid crystal compositions of Examples 1 to 29 and Comparative Examples 1 to 29 was stored at 60° C. for one month, and the solution was applied onto the substrate with a spin coater, and then dried at 80° C. for 2 minutes. Then, after standing at room temperature for 2 minutes, the resultant was irradiated with UV light to set the illuminance to be 500 mJ/cm². Further, The polyimide solution for the alignment film of Examples 8, 9, 13, 14, and 18, and Comparative Examples 8, 9, 13, 14, and 18 was applied on the glass substrate having a thickness of 0.7 mm with a spin coating method at room temperature, dried at 100° C. for 10 minutes, and then baked at 200° C. for 60 minutes to obtain a coating film, and the liquid crystal compositions of Examples 8, 9, 13, 14, and 18, and Comparative Examples 8, 9, 13, 14, and 18 were applied on the substrate with a spin coater and then dried at 80° C. for 2 minutes. Then, after standing at room temperature for 2 minutes, the resultant was irradiated with UV light to set the illuminance to be 500 mJ/cm² (without rubbing treatment of the coating film).

A: No defect was detected by visual inspection, and no defect was also detected by the polarizing microscope observation.

B: No defect was detected by visual inspection, but the non-aligned portion was detected in a part by the polarizing microscope observation.

C: Some defect was detected by visual inspection, and the non-aligned portion was detected in a part by the polarizing microscope observation.

D: Some defect was detected by visual inspection, and non-aligned portion was also entirely detected by the polarizing microscope observation.

The results are shown in Table 19 and Table 20.

TABLE 19

| | Material (M) | | | | | Alignment |
|---|---|---|---|---|---|---|
| | YI/Δn | Adhesiveness | Discoloration 1 | Discoloration 2 | Repellence | properties |
| Example 1 | 15.7 | Classification 0 | A | A | A | A |
| Example 2 | 50 | Classification 1 | B | B | B | B |
| Example 3 | 29.7 | Classification 0 | A | A | A | A |
| Example 4 | 49.8 | Classification 1 | B | B | B | A |
| Example 5 | 14.7 | Classification 0 | A | A | A | A |
| Example 6 | 49.9 | Classification 1 | B | B | B | B |
| Example 7 | 23.1 | Classification 0 | A | A | A | A |
| Example 8 | 23.5 | Classification 0 | A | A | A | A |
| Example 9 | 49.8 | Classification 1 | B | B | B | B |
| Example 10 | 2.5 | Classification 0 | A | A | A | A |
| Example 11 | 4.8 | Classification 0 | A | A | A | A |
| Example 12 | 3.1 | Classification 0 | A | A | A | A |
| Example 13 | 4.7 | Classification 0 | A | A | A | A |
| Example 14 | 8.1 | Classification 0 | A | A | A | A |
| Example 15 | 11.9 | Classification 0 | A | A | A | A |
| Example 16 | 10.3 | Classification 0 | A | A | A | A |
| Example 17 | 19.1 | Classification 0 | A | A | A | A |
| Example 18 | 1.8 | Classification 0 | A | A | A | A |
| Example 19 | 11.3 | Classification 0 | A | A | A | A |
| Example 20 | 4.1 | Classification 0 | A | A | A | A |
| Example 21 | 3.7 | Classification 0 | A | A | A | A |
| Example 22 | 17.1 | Classification 0 | A | A | A | A |
| Example 23 | 1.1 | Classification 0 | A | A | A | A |
| Example 24 | 4.3 | Classification 0 | A | A | A | A |
| Example 25 | 1.2 | Classification 0 | A | A | A | A |
| Example 26 | 28.4 | Classification 0 | A | A | A | A |
| Example 27 | 26.4 | Classification 0 | A | A | A | A |
| Example 28 | 48.7 | Classification 0 | B | B | B | A |
| Example 29 | 22 | Classification 1 | A | A | A | A |
| Example 30 | 22.6 | Classification 0 | A | A | A | A |

TABLE 20

| | Material (M) | | | | | Alignment |
|---|---|---|---|---|---|---|
| | YI/Δn | Adhesiveness | Discoloration 1 | Discoloration 2 | Repellence | properties |
| Comparative Example 1 | 50.2 | Classification 2 | C | C | C | B |
| Comparative Example 2 | 54.3 | Classification 3 | D | D | D | D |
| Comparative Example 3 | 51.7 | Classification 3 | D | D | D | C |
| Comparative Example 4 | 61.9 | Classification 4 | D | D | D | D |
| Comparative Example 5 | 50.3 | Classification 2 | C | C | C | B |
| Comparative Example 6 | 75.3 | Classification 5 | D | D | D | D |
| Comparative Example 7 | 50.7 | Classification 2 | C | C | C | B |
| Comparative Example 8 | 51.6 | Classification 3 | D | D | D | C |
| Comparative Example 9 | 77.6 | Classification 5 | D | D | D | D |
| Comparative Example 10 | 51.9 | Classification 3 | C | C | C | C |
| Comparative Example 11 | 51.2 | Classification 3 | D | D | D | C |
| Comparative Example 12 | 81.1 | Classification 4 | D | D | D | D |
| Comparative Example 13 | 50.9 | Classification 3 | C | C | C | C |
| Comparative Example 14 | 83.6 | Classification 4 | D | D | D | D |
| Comparative Example 15 | 52.1 | Classification 3 | D | D | D | D |
| Comparative Example 16 | 53.8 | Classification 3 | D | D | D | D |
| Comparative Example 17 | 50.3 | Classification 2 | C | C | C | B |
| Comparative Example 18 | 0.7 | Classification 2 | C | C | C | B |
| Comparative Example 19 | 50.5 | Classification 2 | C | C | C | B |
| Comparative Example 20 | 54 | Classification 3 | D | D | D | D |
| Comparative Example 21 | 52 | Classification 3 | D | D | D | D |
| Comparative Example 22 | 58.7 | Classification 4 | D | D | D | D |
| Comparative Example 23 | 0.9 | Classification 4 | C | C | D | C |
| Comparative Example 24 | 0.9 | Classification 4 | C | C | D | C |
| Comparative Example 25 | 50.4 | Classification 2 | C | C | C | B |
| Comparative Example 26 | 53.3 | Classification 2 | C | C | C | B |
| Comparative Example 27 | 50.7 | Classification 2 | C | C | C | B |
| Comparative Example 28 | 0.6 | Classification 4 | C | C | D | C |
| Comparative Example 29 | 55 | Classification 3 | D | D | D | D |
| Comparative Example 30 | 0.7 | Classification 4 | C | C | D | C |

As seen from Table 19 and Table 20, it was found that an optical anisotropic body was obtained in which the adhesiveness was high, the discoloration after a long-term storage was small, the repellence at the time of film production was small, and the alignment properties were excellent in Examples 1 to 30 in which the value of YI/Δn of the material (M) is in the range of 1.0 to 50.0.

1. A polymerizable composition comprising a compound which has a mesogenic group and satisfying an expression represented by Expression (1):
1.0≦YI/Δn≦50.0 Expression (1)
wherein YI represents a yellowness index of a material including only a compound having a mesogenic group in the polymerizable composition, and Δn represents a refractive index anisotropy of a material including only a compound having a mesogenic group in the polymerizable composition, with the proviso that a chiral compound having a mesogenic group is excluded in the material including only a compound having a mesogenic group.

2. The polymerizable composition according to claim 1, wherein one or more of the compound having the mesogenic group have a polymerizable group.

3. The polymerizable composition according to claim 1, wherein the total content of the compound having a mesogenic group is 5.0% by mass to 99.9% by mass based on the total amount of the polymerizable composition.

4. The polymerizable composition according to claim 1, wherein the polymerizable composition exhibits liquid crystal properties.

5. A polymer obtained by polymerizing the polymerizable composition according to claim 1.

6. An optical anisotropic body obtained by polymerizing the polymerizable composition according to claim 1.

7. A retardation film obtained by polymerizing the polymerizable composition according to claim 1.

8. A display device comprising:
the optical anisotropic body according to claim 6.

9. An optical element comprising:
the optical anisotropic body according to claim 6.

10. A light-emitting device comprising:
the optical anisotropic body according to claim 6.

11. A printed matter comprising:
the optical anisotropic body according to claim 6.

12. An optical information recording apparatus comprising:
the optical anisotropic body according to claim 6.
